(19) United States
(12) Patent Application Publication
(10) Pub. No.: US 2012/0005187 A1
(43) Pub. Date: Jan. 5, 2012

(54) Web Site Content Management Techniques

(76) Inventor: Philippe Chavanne, Tucson, AZ (US)

(21) Appl. No.: 12/829,912

(22) Filed: Jul. 2, 2010

(51) Int. Cl. G06F 17/30; G06F 15/16

(52) U.S. Cl. 707/711; 709/206; 707/E17.108

(57) ABSTRACT

Various technologies and techniques are disclosed for creating and managing web site content. A content management system includes an administration module and a page generator module. The administration module is accessible by users through a web browser to specify web site content and settings. The web site content and settings are stored in a data store separately from a published version of the web site so the web site can be regenerated and republished with additional changes at a later time. The administration module includes a skins module, a languages module, a contents module, a business pages module, and a newsletter module. A page generator module generates web pages for the web site. The web pages are generated and published to the web site whenever changes that impact the web site are made to the web site content and settings through the administration module.

### BACKGROUND

In today's world of technology, businesses are usually expected to have a web site where customers can go for more information. The task of creating and managing a web site can involve a lot of work. Several tools exist to allow web sites to be created and maintained.

For example, many of the existing tools require knowledge of HTML or other web programming technologies. Web developers who are hired by businesses to create web sites usually operate these tools. Because many businesses have been frustrated with the typical costs and delays associated with dealing with a web developer, several tools have also been introduced that allow a business owner to directly create and manage his/her own web site. While such tools tend to be very user friendly, they generally offer the business owner limited functionality.

### SUMMARY

Various technologies and techniques are disclosed for creating and managing web site content. In one implementation, a content management system is disclosed that includes an administration module and a page generator module. The administration module is accessible by users through a web browser to specify web site content and settings to be used in generating a web site for the user. The web site content and settings are stored in a data store separately from a published version of the web site so the web site can be regenerated and republished with additional changes at a later time.

In one implementation, the administration module includes a skins module, a languages module, a contents module, a business pages module, and a newsletter module. The skins module allows a look and feel to be selected for the web site. The languages module allows at least one language to be selected for the web site. The contents module allows articles to be specified that will appear on the web site. The business pages module allows content to be entered for standard business pages appearing on the web site that are common across multiple web sites. The newsletter module allows settings to be modified for an opt-in box that can be displayed on the web site.

In one implementation, a page generator module generates web pages for the web site. The web pages are generated and published to the web site whenever changes that impact the web site are made to the web site content and settings through the administration module.

In another implementation, a content management software program for generating and managing web sites is disclosed. The program enables a look and feel to be selected for a web site and at least one language to be selected for the web site. Articles can be specified that will appear on the web site, and content can be entered for standard business pages appearing on the web site that are common across multiple web sites. Settings can be modified for an opt-in box that can be displayed on the web site. Products can be managed that can be sold on the web site. Site information that is submitted to third party web sites can be managed.

In one implementation, web pages are generated for the web site in both a regular version and a mobile version. The web pages are generated and published to the web site whenever changes that impact the web site are made.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a content management system of one implementation.

FIG. 2 is a diagrammatic view of several site feature modules that are included in content management system in one implementation.

FIG. 3 is a process flow diagram for one implementation illustrating the stages involved in using an interactive quickstart menu to quickly create a new web site.

FIG. 4 is a simulated screen for one implementation that illustrates a quickstart menu that outlines the high level steps to be completed to set up a new web site.

FIG. 5 is a simulated screen for one implementation that illustrates revealing additional details about a selected step in the quickstart menu.

FIG. 6 is a simulated screen for one implementation that illustrates including training videos as part of the quickstart menu.

FIG. 7 is a simulated screen for one implementation that illustrates an exemplary navigation menu for content management system.

FIG. 8 is a process flow diagram for one implementation illustrating the stages involved in setting a site's look and feel by choosing a skin.

FIG. 9 is a simulated screen for one implementation that illustrates selecting a skin from numerous available skins

FIG. 10 is a simulated screen for one implementation that illustrates uploading a logo to be used with the selected skin.

FIG. 11 is a process flow diagram for one implementation illustrating the stages involved in assigning one or more languages for the web site.

FIG. 12 is a simulated screen for one implementation that illustrates selecting the language(s) to be used for the web site.

FIG. 13 is a simulated screen for one implementation that illustrates a navigation menu for the contents module.

FIG. 14 is a process flow diagram for one implementation illustrating the stages involved in creating and modifying articles that will be displayed on selected web pages.

FIG. 15 is a simulated screen for one implementation that illustrates creating a new article.

FIG. 16 is a simulated screen for one implementation that illustrates modifying an existing article.

FIG. 17 is a process flow diagram for one implementation illustrating the stages involved in managing the navigation menu for a web site.

FIG. 18 is a simulated screen for one implementation that illustrates creating a menu item.

FIG. 19 is a simulated screen for one implementation that illustrates managing the site menu.

FIG. 20 is a simulated screen for one implementation that illustrates creating and managing sub-pages on the site menu.

FIG. 21 is a process flow diagram for one implementation that illustrates the stages involved in modifying the home top feature of a web site.

FIG. 22 is a simulated screen for one implementation that illustrates selecting a home top feature to specify the layout of the home page.

FIG. 23 is a process flow diagram for one implementation that illustrates the stages involved in creating and managing polls for a web site.

FIG. 24 is a simulated screen for one implementation that illustrates managing polls for a web site.

FIG. 25 is a simulated screen for one implementation that illustrates creating a new poll for a web site.

FIG. 26 is a process flow diagram for one implementation that illustrates the stages involved in creating and managing surveys for a web site.

FIG. 27 is a simulated screen for one implementation that illustrates creating a survey for a web site.

FIG. 28 is a process flow diagram for one implementation that illustrates the stages involved in creating a video overlay for a web site.

FIG. 29 is a simulated screen for one implementation that illustrates a list of video overlay presentations.

FIG. 30 is a simulated screen for one implementation that illustrates creating a new video overlay presentation.

FIG. 31 is a simulated screen for one implementation that illustrates a video overlay being displayed on a live web site.

FIG. 32 is a simulated screen for one implementation that illustrates a navigation menu for the business pages module.

FIG. 33 is a simulated screen for one implementation that illustrates creating and modifying an About Us web page.

FIG. 34 is a simulated screen for one implementation that illustrates creating and modifying a Terms and Conditions web page.

FIG. 35 is a simulated screen for one implementation that illustrates creating and modifying a Privacy Policy web page.

FIG. 36 is a simulated screen for one implementation that illustrates creating and modifying a Contact Us web page.

FIG. 37 is a simulated screen for one implementation that illustrates creating and modifying a Benefits web page.

FIG. 38 is a process flow diagram for one implementation that illustrates the stages involved in adding a testimonials feature to a web site.

FIG. 39 is a simulated screen for one implementation that illustrates specifying the settings for a testimonials page to be used on a web site.

FIG. 40 is a simulated screen for one implementation that illustrates the testimonials page being added to the site navigation of the associated web site.

FIG. 41 is a simulated screen for one implementation that illustrates a testimonial submission form that is live on a web site.

FIG. 42 is a process flow diagram for one implementation that illustrates the stages involved in managing photos and photo albums for a web site.

FIG. 43 is a simulated screen for one implementation that illustrates creating and managing a photo album.

FIG. 44 is a process flow diagram for one implementation that illustrates the stages involved in managing videos that are available for use a web site.

FIG. 45 is a simulated screen for one implementation that illustrates uploading and managing videos that are available for use with a web site.

FIG. 46 is a process flow diagram for one implementation that illustrates the stages involved in interacting with third party video sites.

FIG. 47 is a simulated screen for one implementation that illustrates uploading videos to a third party video site.

FIG. 48 is a process flow diagram for one implementation that illustrates the stages involved in managing products for a web site.

FIG. 49 is a simulated screen for one implementation that illustrates viewing and managing products for a web site.

FIG. 50 is a simulated screen for one implementation that illustrates creating a new product.

FIG. 51 is a simulated screen for one implementation that illustrates setting product pricing options.

FIG. 52 is a simulated screen for one implementation that illustrates managing orders.

FIG. 53 is a process flow diagram for one implementation that illustrates the stages involved in adding a coupon generator to a web site.

FIG. 54 is a simulated screen for one implementation that illustrates managing coupons produced by a coupon generator.

FIG. 55 is a simulated screen for one implementation that illustrates modifying a selected coupon.

FIG. 56 is a simulated screen for one implementation that illustrates managing shipping options for the products.

FIG. 57 is a simulated screen for one implementation that illustrates managing tax options for the products.

FIG. 58 is a simulated screen for one implementation that illustrates setting up payment processor details to be used for collecting payments for the products.

FIG. 59 is a process flow diagram for one implementation that illustrates the stages involved in collecting and managing site information to help the web site rank higher in the search engine.

FIG. 60 is a simulated screen for one implementation that illustrates specifying certain web site details that will be submitted to and/or read by the search engines.

FIG. 61 is a process flow diagram for one implementation that illustrates the stages involved in submitting details about a web site to a search engine maps feature.

FIG. 62 is a simulated screen for one implementation that illustrates completing various details that can be submitted to a search engine maps feature.

FIG. 63 is a process flow diagram for one implementation that illustrates the stages involved in creating a search engine local business listing.

FIG. 64 is a simulated screen for one implementation that illustrates submitting details about a web site to a search engine local business listing.

FIG. 65 is a process flow diagram for one implementation that illustrates the stages involved in setting up details for interactions with third party social media sites.

FIG. 66 is a simulated screen for one implementation that illustrates specifying social media login details and other options that are used to interact with the respective social media sites.

FIG. 67 is a simulated screen for one implementation that illustrates displaying a social media interaction feature on a web site.

FIG. 68 is a simulated screen for one implementation that illustrates viewing a news feed from the social media site directly from within a web site.

FIG. 69 is a simulated screen for one implementation that illustrates customizing settings for a live chat custom message.

FIG. 70 is a simulated screen for one implementation that illustrates viewing live chat offline messages.

FIG. 71 is a simulated screen for one implementation that illustrates viewing a live chat history.

FIG. 72 is a process flow diagram for one implementation that illustrates the stages involved in customizing an opt-in box that appears on a web site.

FIG. 73 is a simulated screen for one implementation that illustrates modifying opt-in box settings for a web site.

FIG. 74 is a process flow diagram for one implementation that illustrates the stages involved in modifying autoresponder settings for a web site.

FIG. 75 is a simulated screen for one implementation that illustrates creating an autoresponder message that gets sent to subscribers who opt-in from a web site through its opt-in box.

FIG. 76 is a simulated screen for one implementation that illustrates viewing and managing the email addresses of those who have opted in from a web site through its opt-in box.

FIG. 77 is a simulated screen for one implementation that illustrates creating a bulk email message to be sent to subscribers.

FIG. 78 is a simulated screen for one implementation that illustrates sending the bulk email message to selected subscribers.

FIG. 79 is a process flow diagram for one implementation that illustrates the stages involved in viewing and modifying user permission settings.

FIG. 80 is a simulated screen for one implementation that illustrates viewing and modifying the permissions of the web site contributors.

FIG. 81 is a simulated screen for one implementation that illustrates changing the password that is used to access the administration features of a web site.

FIG. 82 is a simulated screen for one implementation that illustrates storing various login details for later reference and/or use by the content management system.

FIG. 83 is a simulated screen for one implementation that illustrates creating a new emailbox.

FIG. 84 is a simulated screen for one implementation that illustrates customizing details on how articles are displayed on a web site.

FIG. 85 is a process flow diagram for one implementation that illustrates the stages involved in creating and using tracking sub-id's to track certain activities that take place on a web site.

FIG. 86 is a simulated screen for one implementation that illustrates creating a new sub-id to be used for tracking different types of traffic that comes to the site.

FIG. 87 is a simulated screen for one implementation that illustrates viewing tracking details regarding traffic that came to the site through one or more sub-ids.

FIG. 88 is a simulated screen for one implementation that illustrates a heat map to show how visitors interacted with pages on a web site.

FIG. 89 is a simulated screen for one implementation that illustrates a heat map showing the areas visitors clicked on a certain page for the specified time frame.

FIG. 90 is a diagrammatic view of a computer system of one implementation.

### DETAILED DESCRIPTION

The technologies and techniques herein may be described in the general context as an application that creates and manages web sites, but the technologies and techniques also serve other purposes in addition to these. In one implementation, one or more of the techniques described herein can be implemented as features within a web site generator, from within a content management system, or from any other type of program or service that creates and/or manages web site contents and/or pages.

In one implementation, a content management system is disclosed that is able to generate web sites that contain advanced functionality that is typically found in custom systems that are developed by experienced web developers. From a simple user interface, a business owner or other user can create a sophisticated web site with numerous advanced features, without needing to know any HTML or other programming languages. The user simply points, clicks, fills in some data, and/or selects some options, and a highly sophisticated web site is generated automatically. The web site that is created can include features such as content in multiple languages, videos, social media site integration, page rendering for standard and mobile devices, custom video overlays that appear over the site, surveys, polls, coupons, products that can be sold, newsletter opt-in features, autoresponder messages, email accounts, integration with search engine maps, integration with search engine local business listings, automatic creation and submission of a site map, heat maps that show where visitors are clicking, live chat support, and/or other features as selected by the user. The web site that is generated by the content management system contains web pages with dynamic content that appears to the search engines as static web pages, thereby helping the web site to be indexed and found in the search engines.

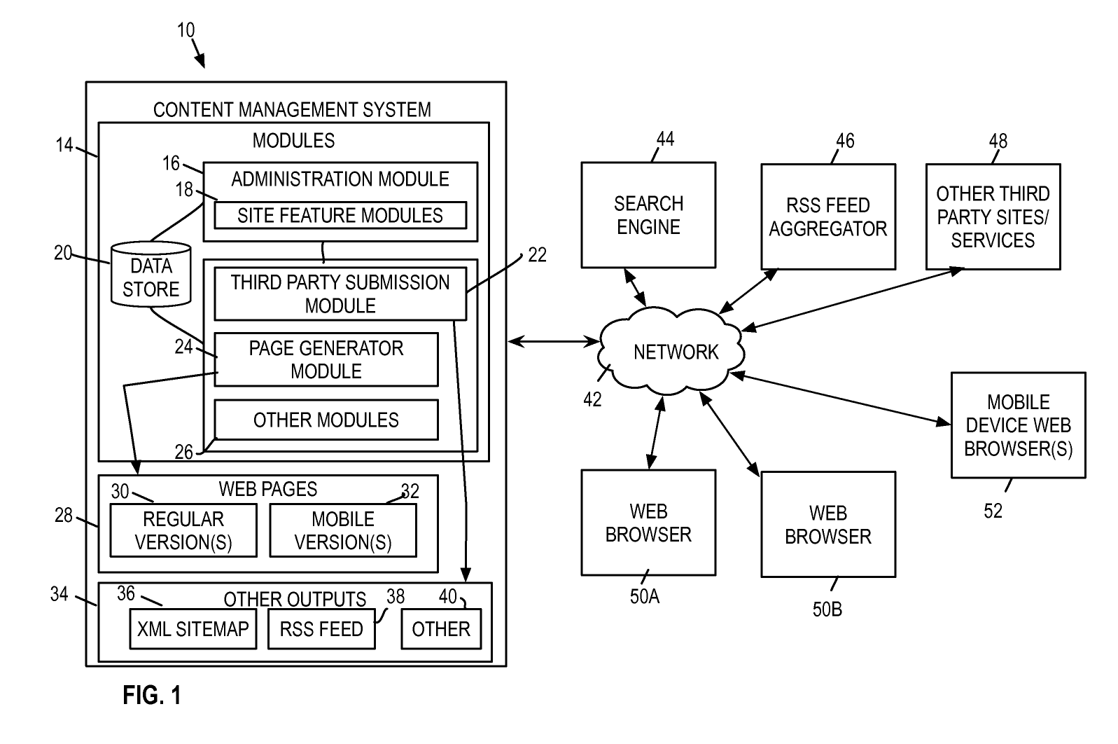

FIG. 1 is a diagrammatic view of a content management system 10 of one implementation. Content management system 10 includes various modules 14, including administration module 16, third party submission module 22, page generator module 24, and other modules 26. Content management system 10 also includes a data store 20 for storing the various settings for the web site. These settings stored in data store 20 can include various web site content and/or settings that are provided by one or more users of content management system 20, such as a web site administrator. These settings stored in data store 20 can also include various system specified settings that are used by content management system 20.

In one implementation, some or all of modules 14 for content management system 10 are executed on the same web site and/or domain as the web site that is being managed by content management system 10. In another implementation, modules 14 are executed on a different web site and/or domain as the web site that is being managed by content management system. Content management system 10 communicates with other computers and devices over network 42, and/or through other communication connections as available and/or appropriate.

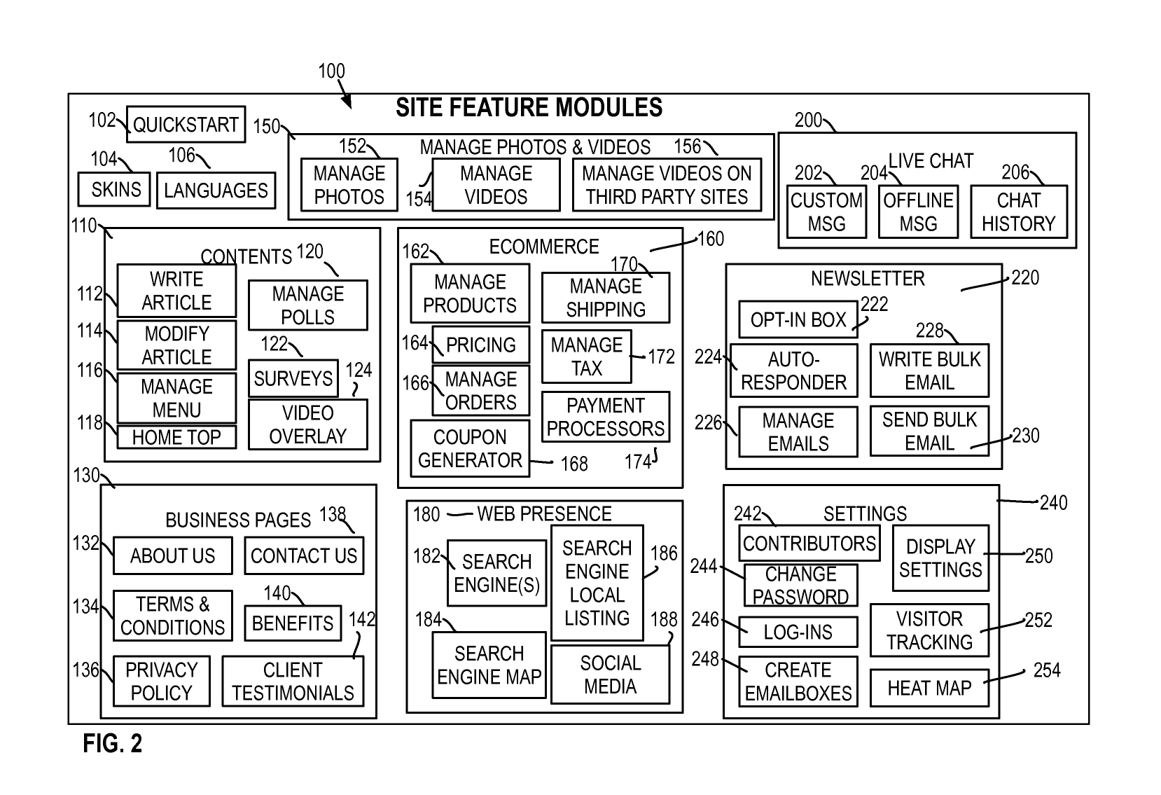

Administration module 16 includes various site feature modules 18. Site feature modules 18 include the features that can be customized by a user of content management system 10 to customize a particular web site being created and managed by content management system 10. A web browser (such as 50A or 50B) can be used by an administrator or other user (having proper permissions) to access the administration module 16. Site feature modules 18 are described in detail in FIG. 2.

Page generator module 24 is responsible for generating web pages 28 for the web site. In one implementation, page generator module 24 uses a URL rewrite feature to create a static URL for each respective page, so each page has a name that is search-engine friendly and user friendly. Once the static URL is accessed by a visitor or otherwise, the URL rewrite feature translates the URL into the actual dynamic page (with any variables or other parameters), and any dynamic data is retrieved from data store 20. The URL rewrite feature allows one URL to redirect to another URL without the visitor even noticing it.

In one implementation, page generator module 24 generates and publishes the web pages 28 automatically whenever changes are made through administration module 16 that impact the web site. In another implementation, a user is notified that the changes being made will cause the web site to need generated and published (or regenerated and republished), and upon user selection of a publish option, web pages 28 are generated and published to the web site.

In one implementation, this generation and publishing of web pages 28 occurs by creating or updating any URL rewrites, if and when appropriate, and also by making the revised version of the page available the next time a visitor accesses the page. In such an implementation, since the data that is displayed on each web page is retrieved dynamically from data store 20, the code behind the web pages 28 may or may not have actually changed when the page generator module 24 generates and publishes them. In other words, the data store 20 may have been updated in what is stored for the respective web page, and such data will then be displayed the next time the respective web page is accessed by a visitor. In another implementation, some or all of the contents of the web pages 28 are actually generated and published to the web site as static content whenever changes are made trough administration module 16 that impact the web site.

In one implementation, page generator module 24 is responsible for generating each of the web pages 28 for the site in two formats: a regular version 30, and a mobile version 32. The regular version 30 of the web pages 28 can include typical web pages that are displayed on a device with full display capabilities, such as a web browser (such as 50A or 50B) running on a desktop or laptop computer. The mobile version 32 produced by page generator module 24 is designed for display on a web browser of a mobile device 52 that has limited display space available, and/or for times when user has indicated a preference for viewing a mobile version of a site.

Third party submission module 22 is responsible for creating outputs 34 that are submitted to third party web sites over network 42. As one non-limiting example, third party submission module 22 generates a sitemap 36 (such as an XML sitemap), and then submits that sitemap to one or more search engines 44 (such as Google) to help the search engines 44 index the web pages 28 of the web site better, and ultimately to help the web site rank higher in the search engines. As another non-limiting example, third party submission module 22 generates an RSS feed 38, and then provides that RSS feed on an ongoing basis to one or more RSS feed aggregators 46. Other types of content 40 can be created and submitted by third party submission module 22 to other third party sites and/or services 48.

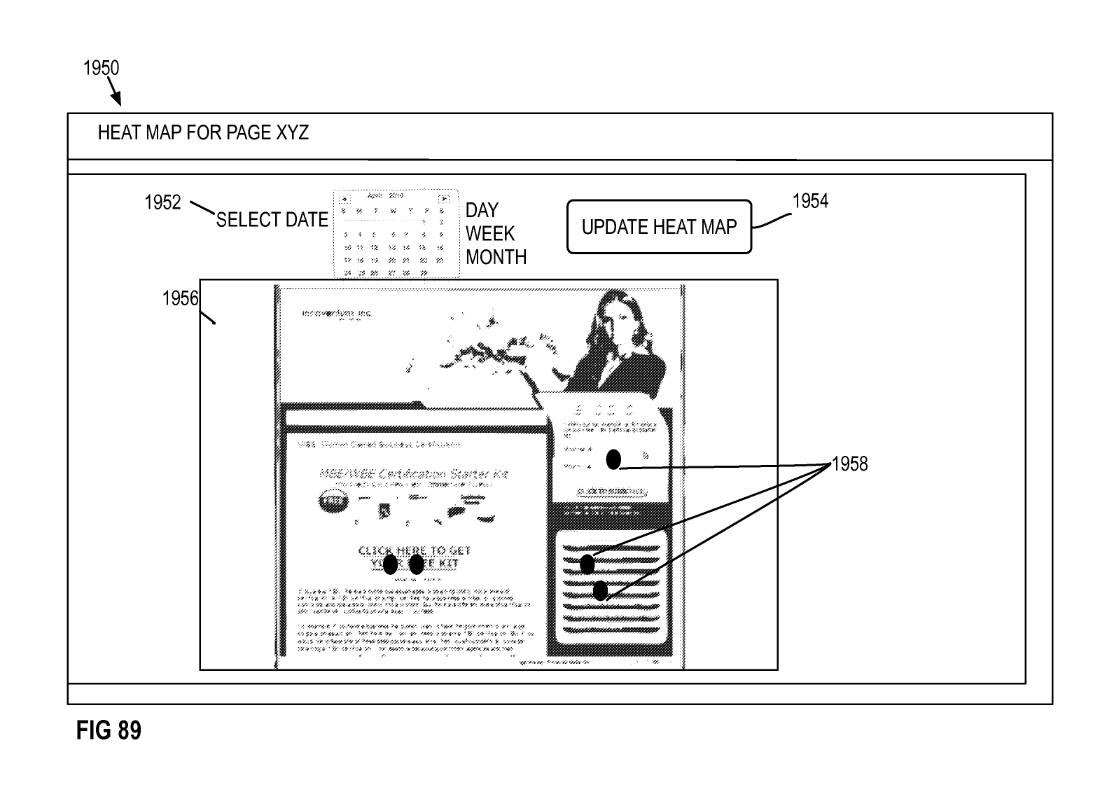

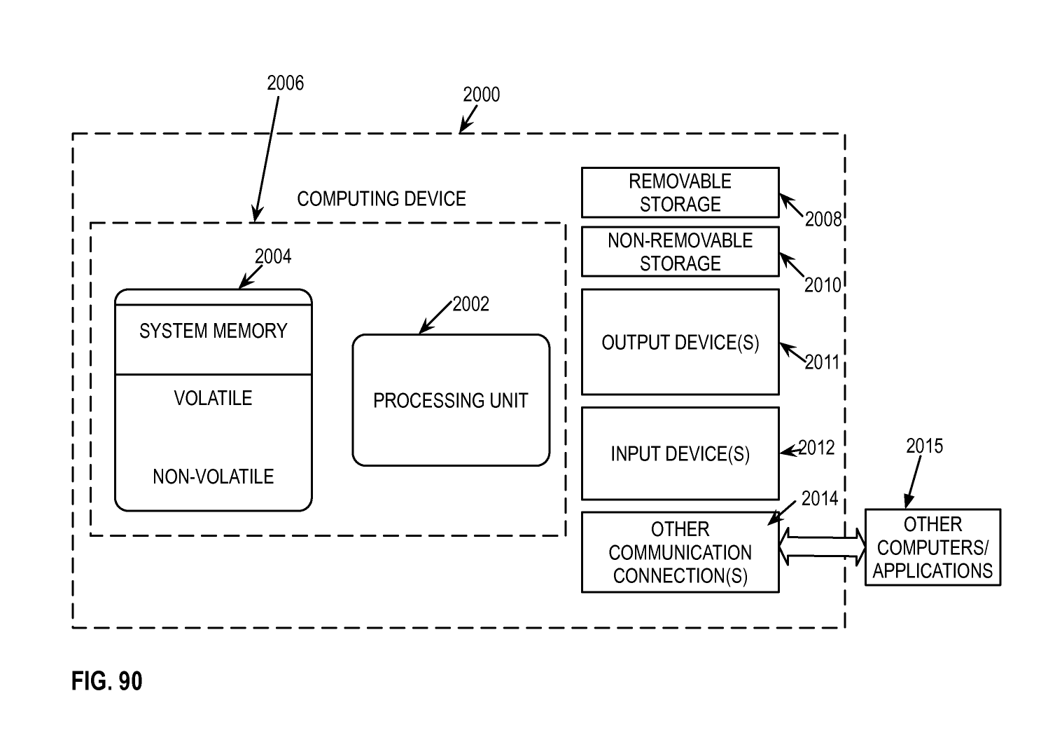

Turning now to FIGS. 2-89, techniques for implementing one or more implementations of content management system 10 are described in further detail. In some implementations, the processes of FIG. 2-89 are at least partially implemented in the operating logic of computing device 500 (of FIG. 90). Some of the Figures discussed herein are simulated screens of an exemplary user interface for content management system 10. These screens can be displayed to users on output device(s) 2011 (of FIG. 90). Furthermore, these screens can receive input from users from input device(s) 2012 (of FIG. 90).

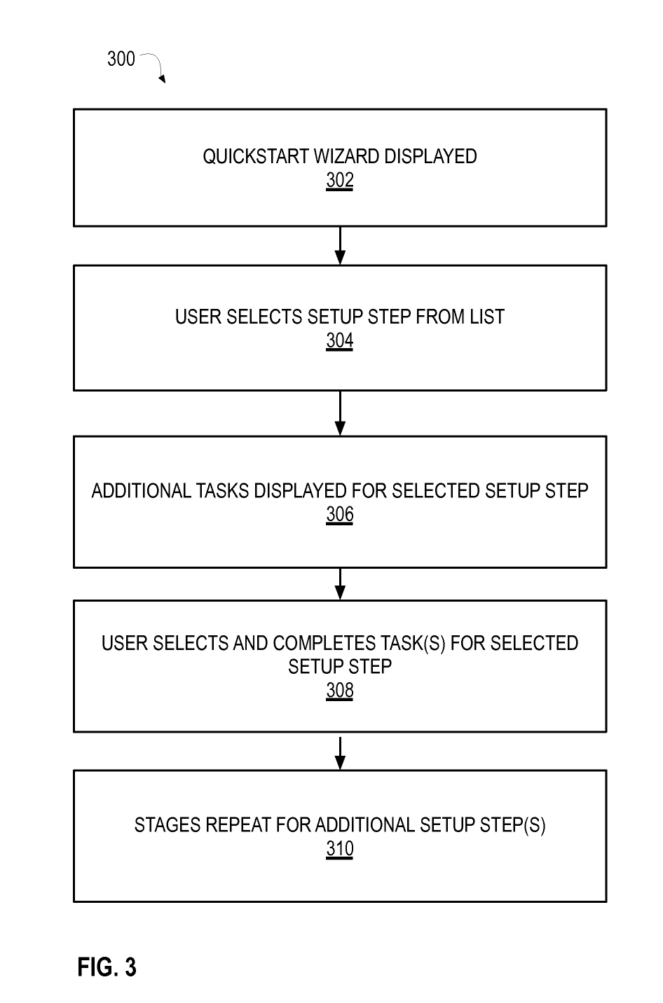

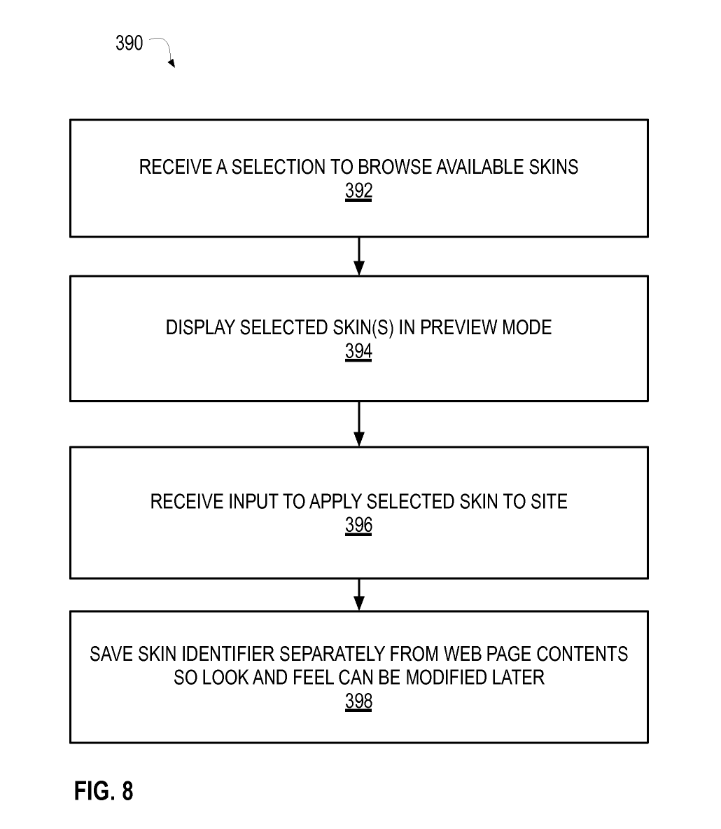

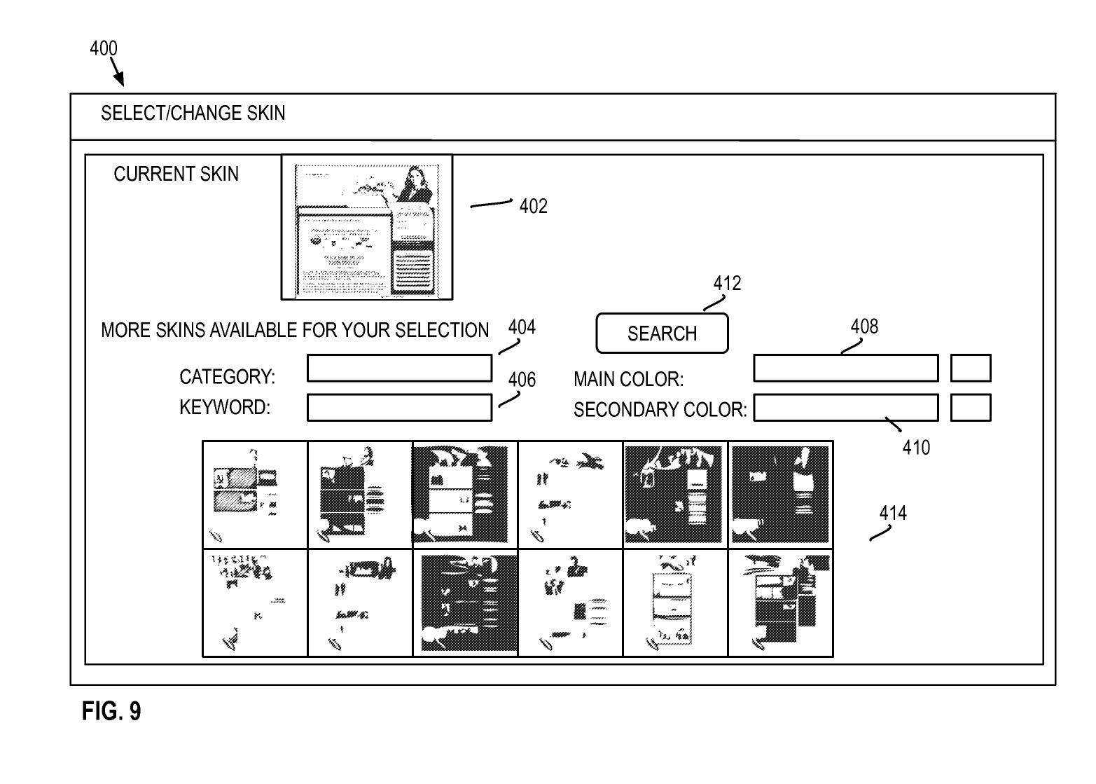

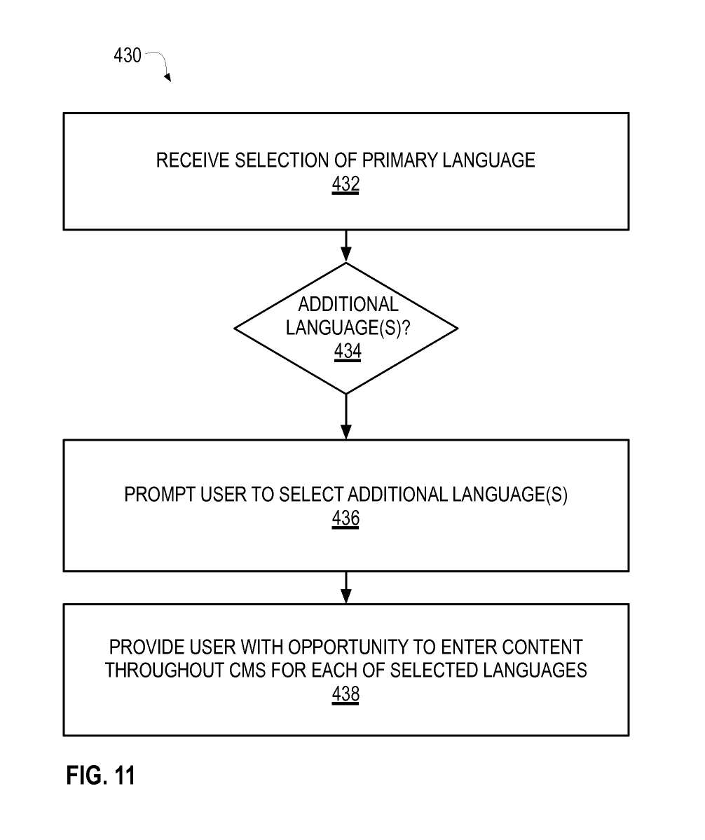

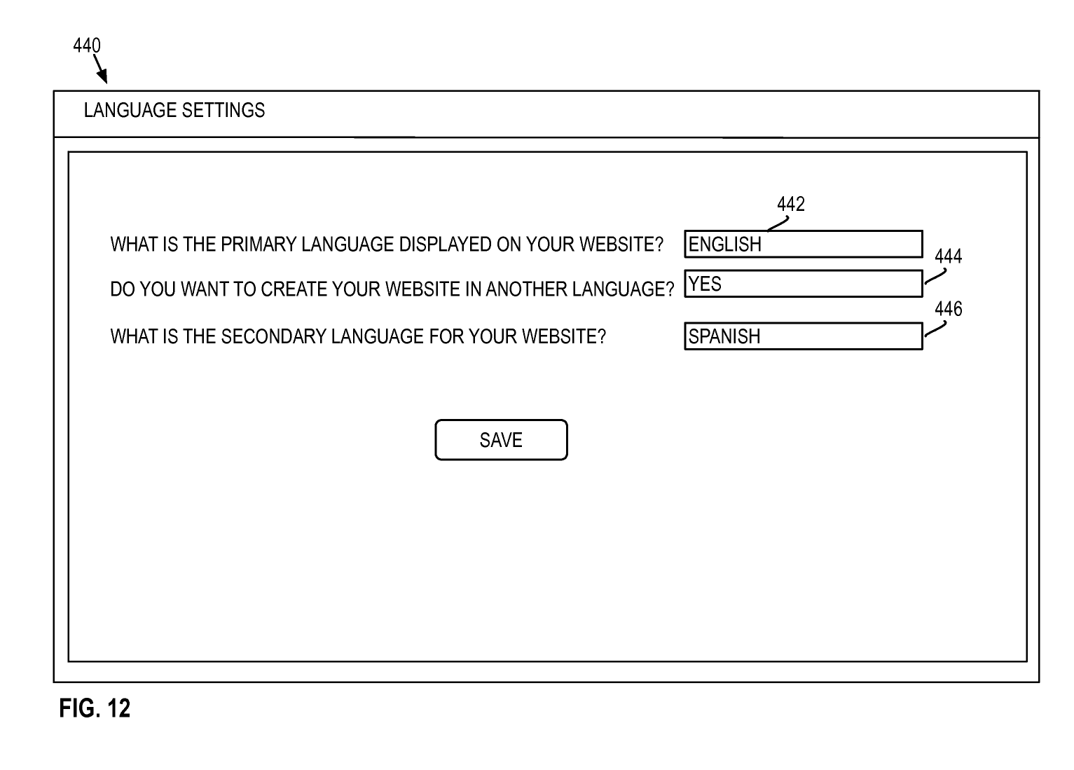

FIG. 2 is a diagrammatic view 100 of several site feature modules that are included in content management system 10 in one implementation. Quickstart module 102 is responsible for providing a quickstart menu that assists users in creating a new web site. Quickstart module 102 is explained in further detail in FIGS. 3-7. Skins module 104 is responsible for allowing a user to customize the look and feel for a web site. Skins module 104 is explained in further detail in FIGS. 8-9. Languages module 106 is responsible for allowing a user to specify the language(s) that are to be used on a web site. Languages module 106 is described in further detail in FIGS. 11-12.

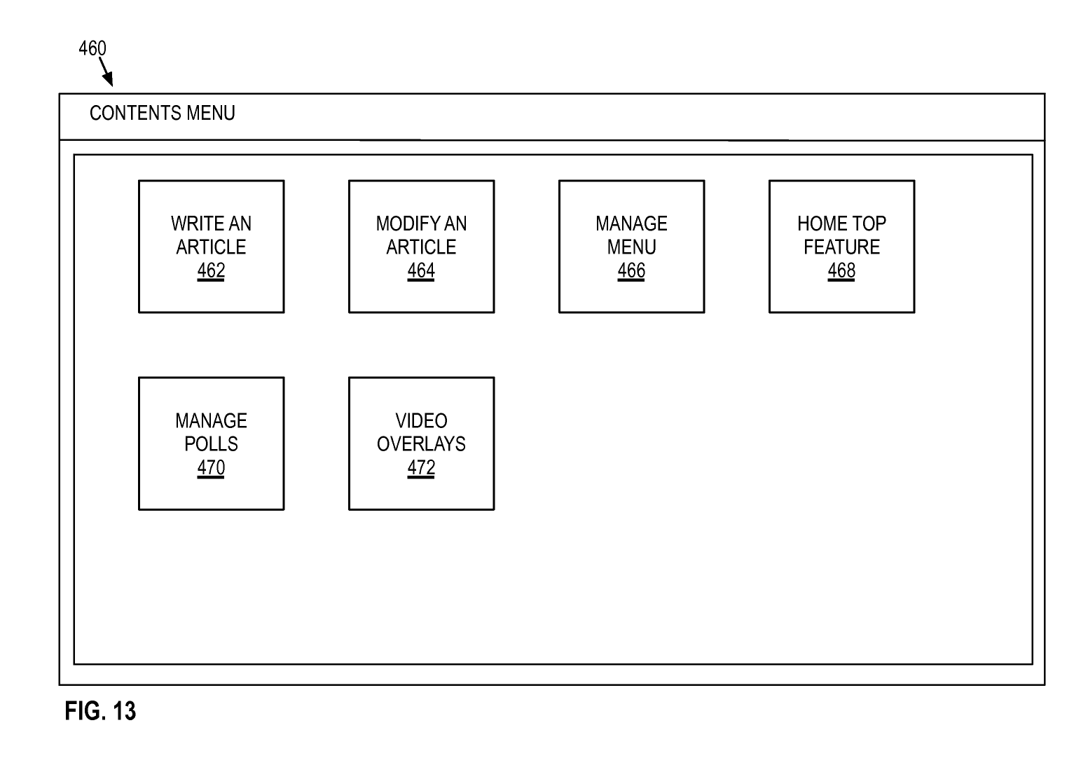

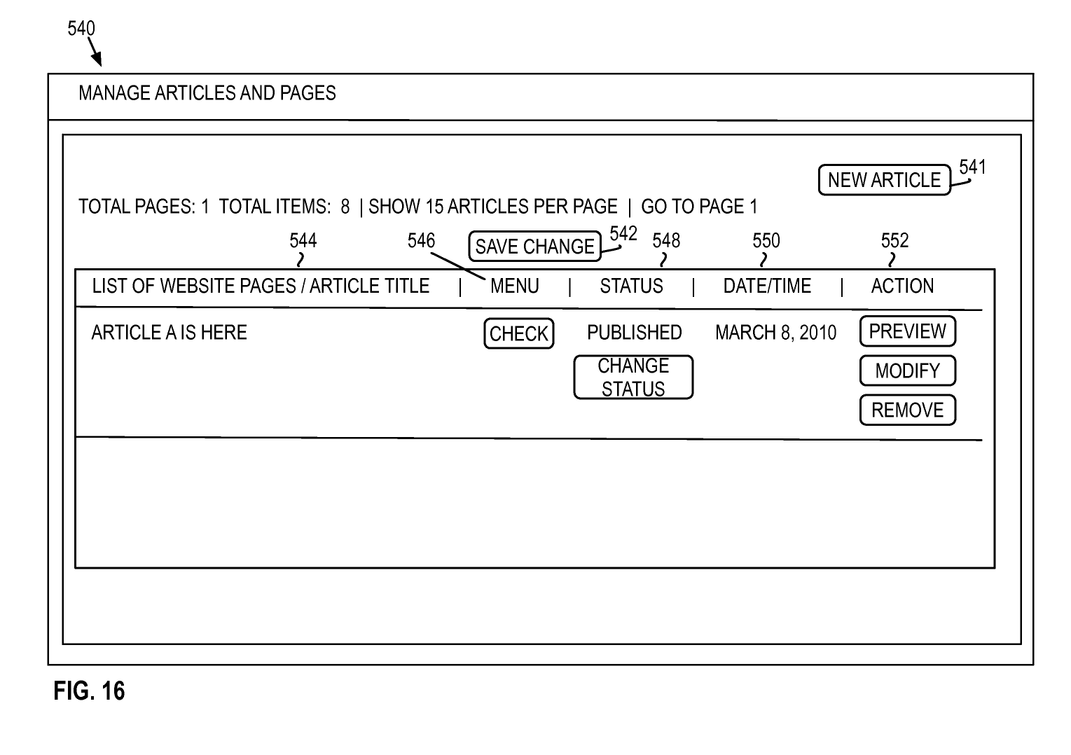

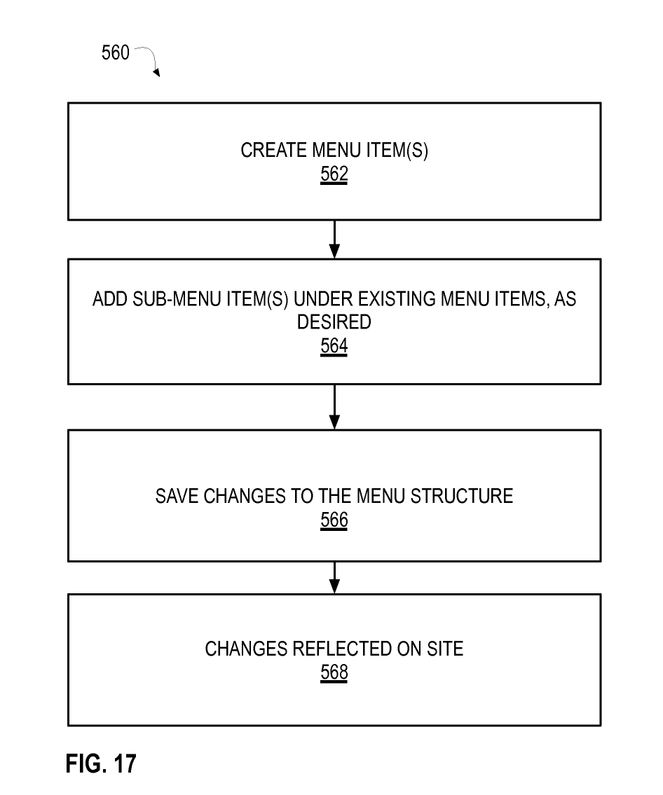

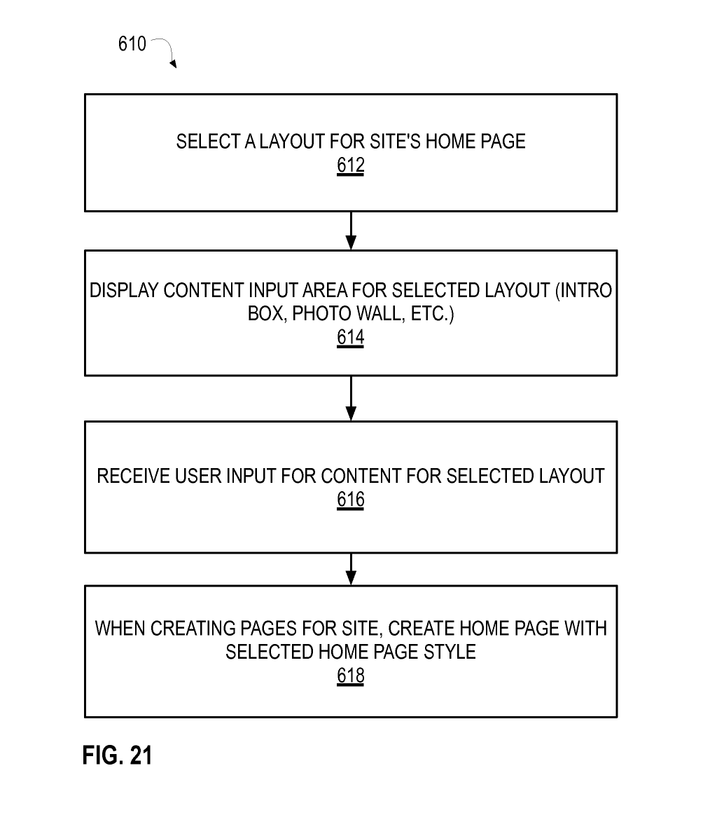

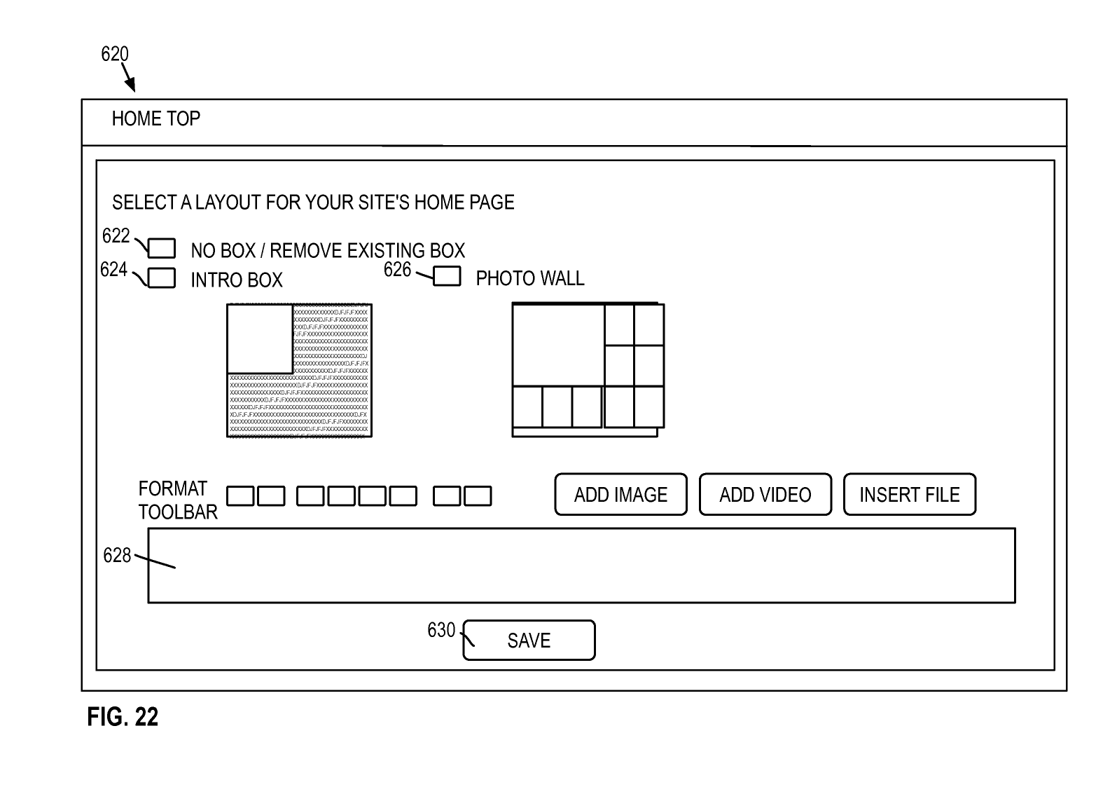

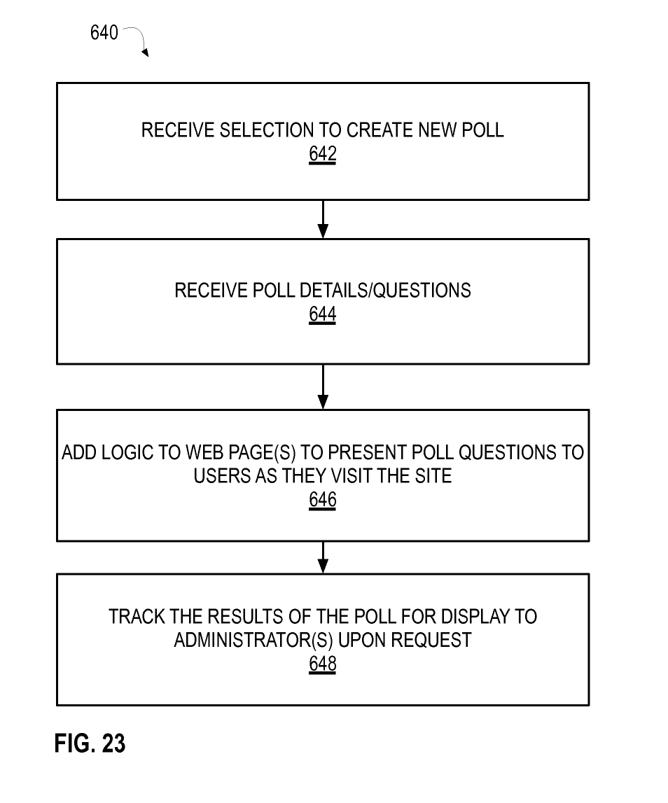

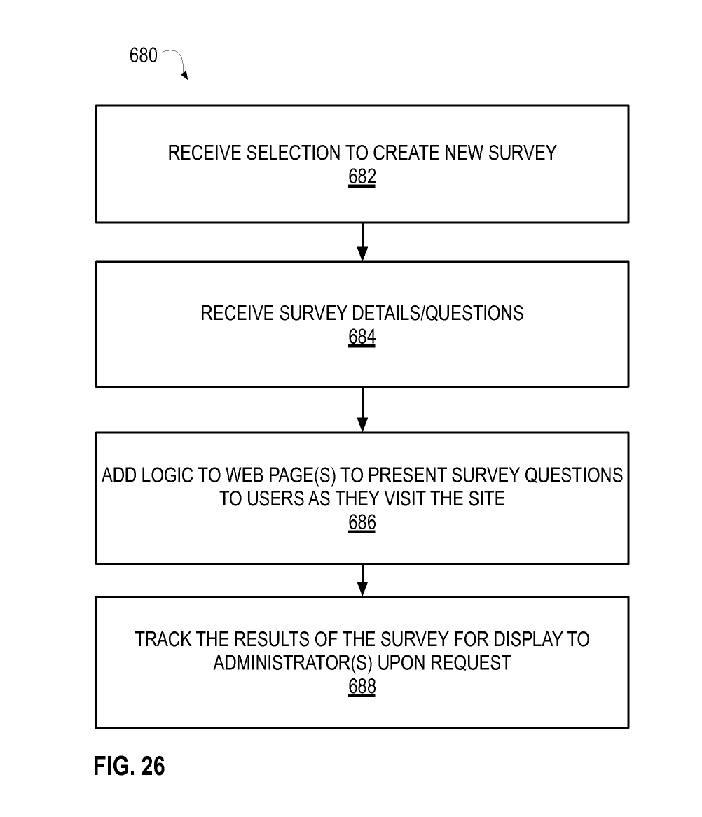

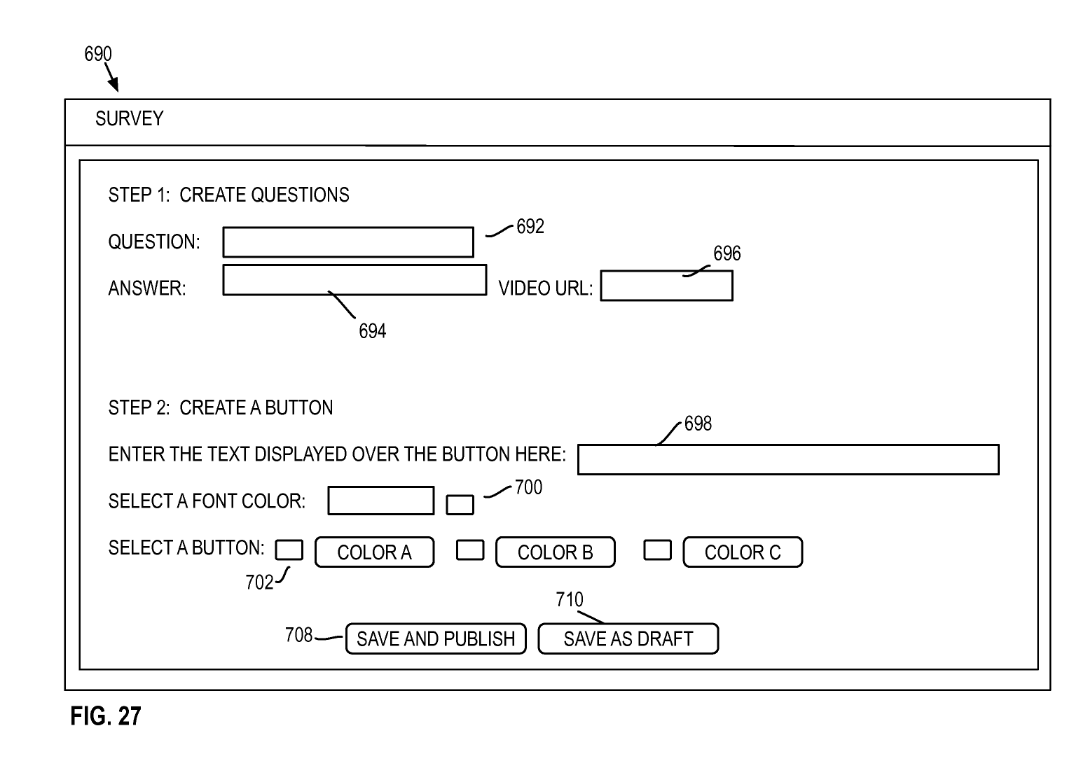

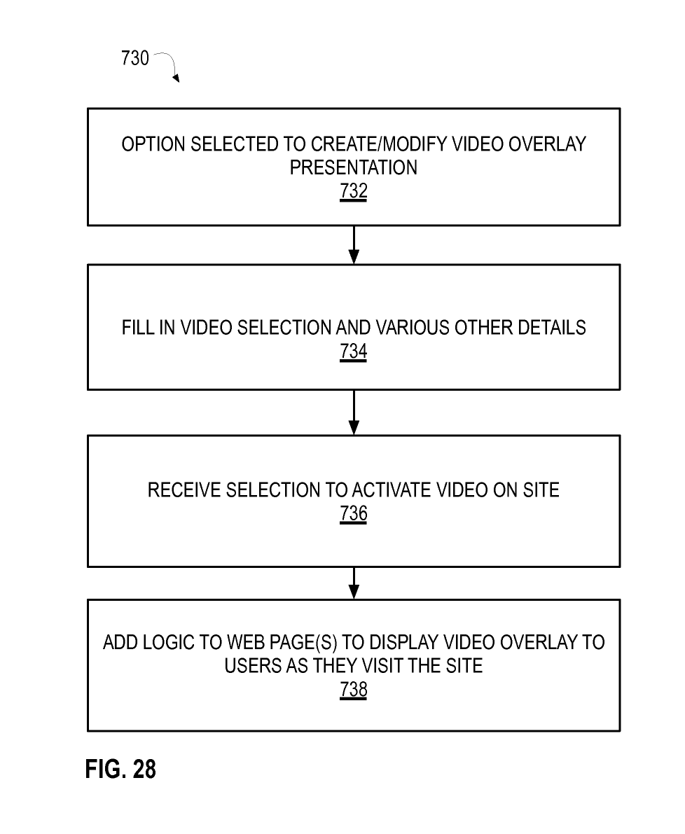

Contents module 110 is responsible for and operable to allow various types of content to be customized that will appear on a web site. The various features of contents module 110 are described in more detail in FIGS. 13-31. For example, write article module 112 is described in FIGS. 11-15, modify article module 114 is described in FIG. 16, and manage menu module 116 is described in FIGS. 17-20. Home top module 118 is described in FIGS. 21-22, manage polls module 120 is described in FIGS. 23-25, surveys module 122 is described in FIGS. 26-27, and video overlay module 124 is described in FIGS. 28-31.

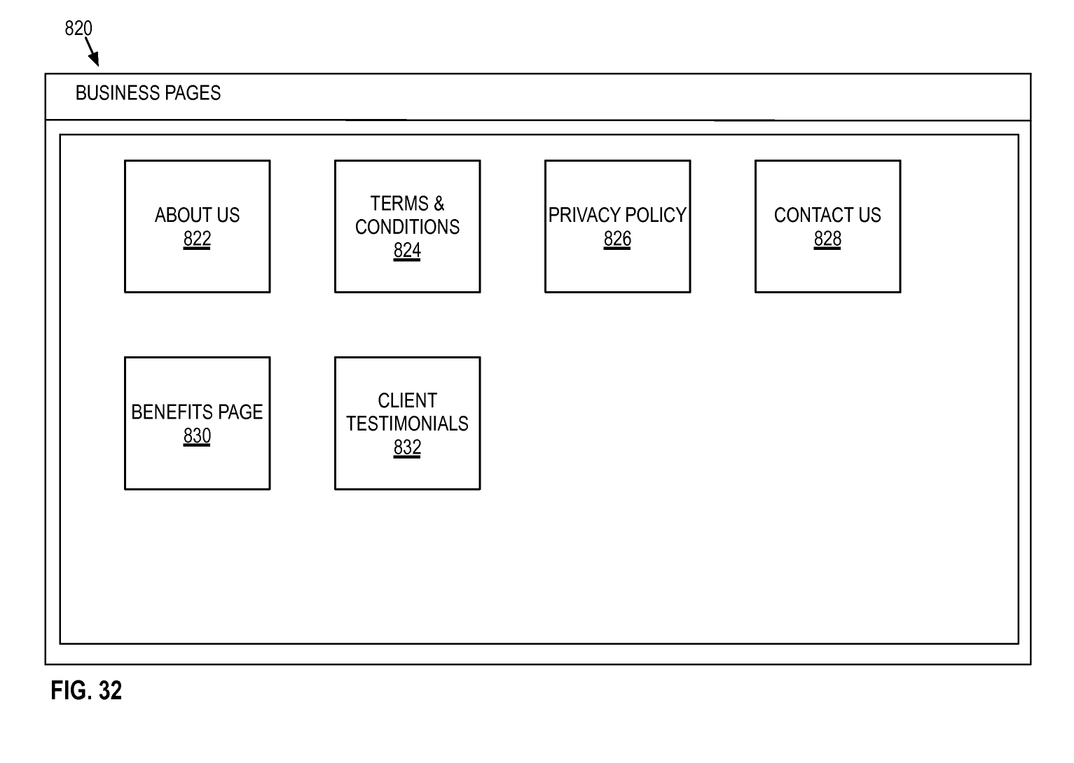

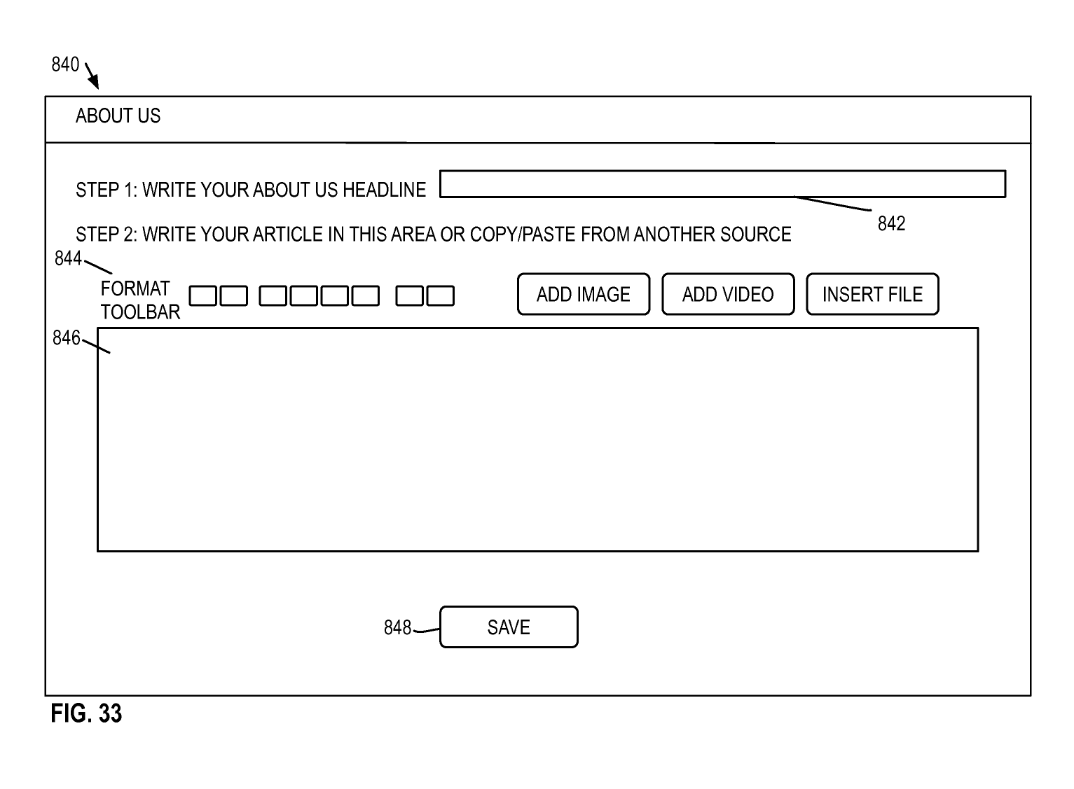

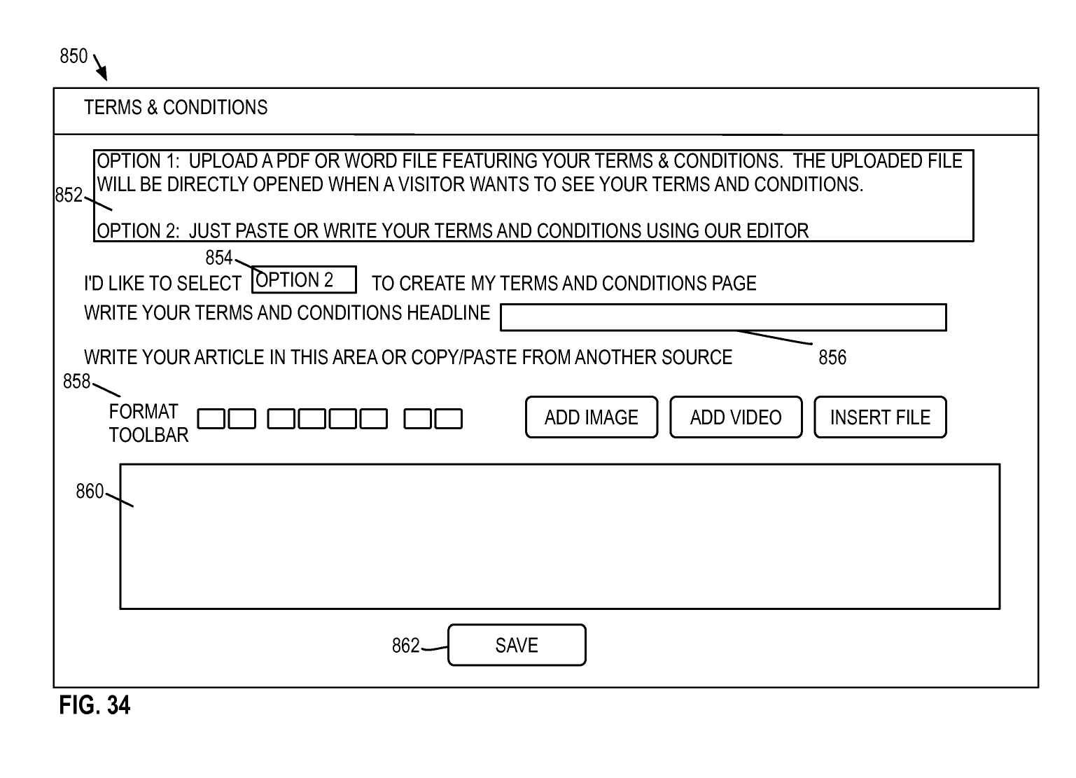

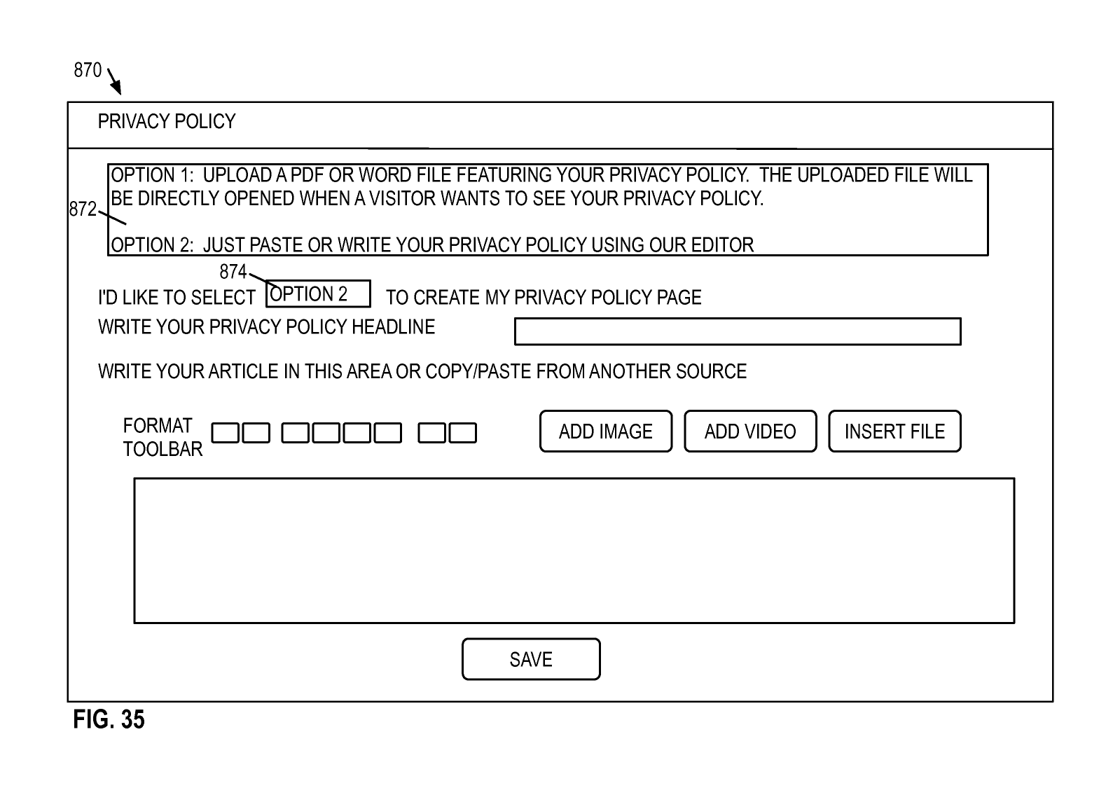

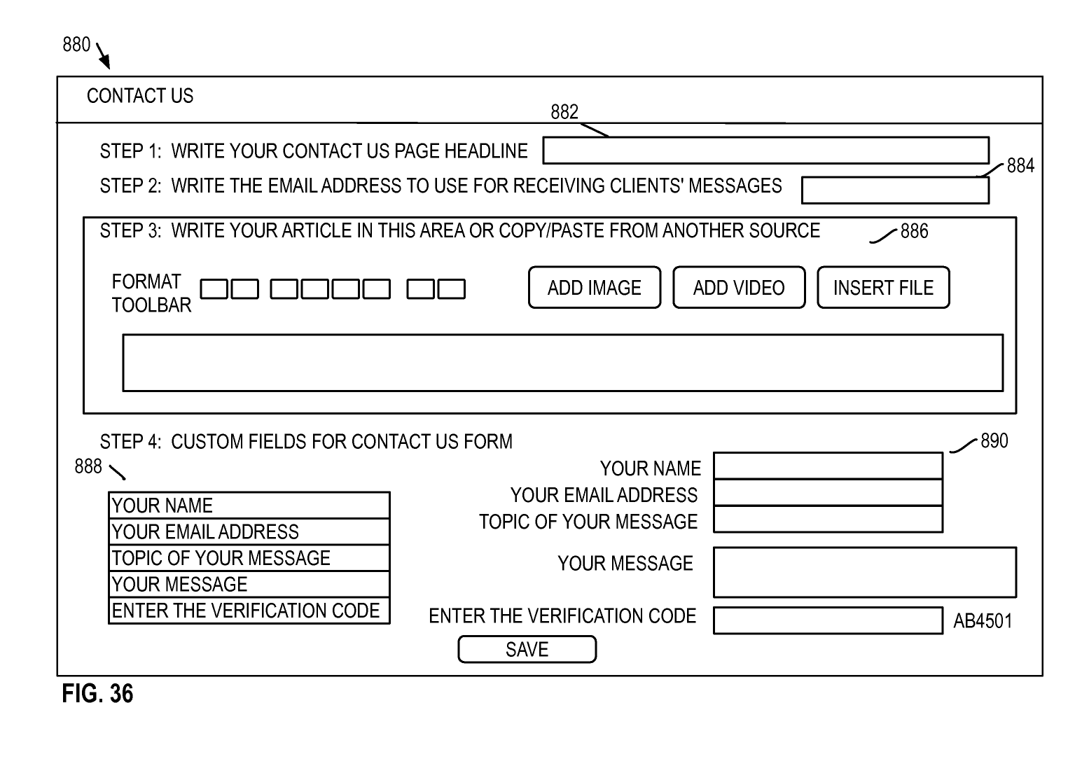

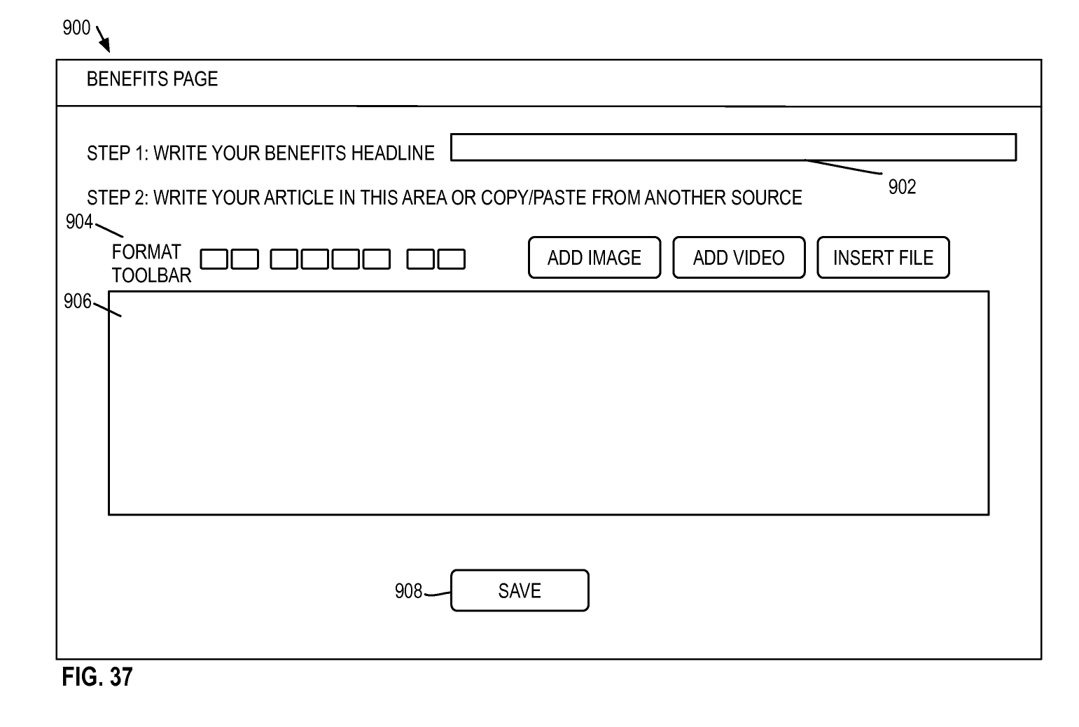

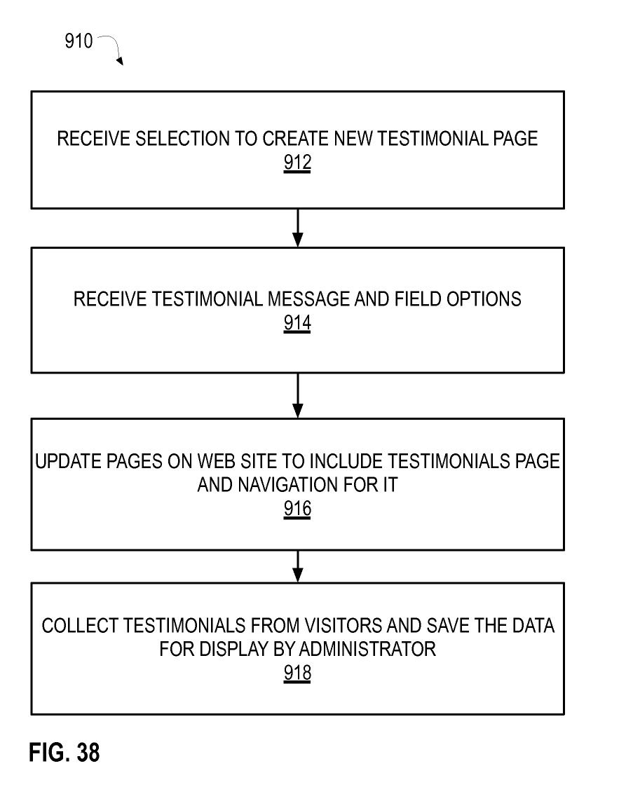

Business pages module 130 is responsible for and operable to allow content to be entered for standard business pages appearing on a web site that are common across multiple sites. The various features of business pages module 130 are described in more detail in FIGS. 32-41. For example, about us module 132 is described in FIG. 33, terms and conditions module 134 is described in FIG. 34, and privacy policy module 136 is described in FIG. 35. Contact us module 138 is described in FIG. 36, benefits module 140 is described in FIG. 37, and client testimonials module 142 is described in FIGS. 38-41.

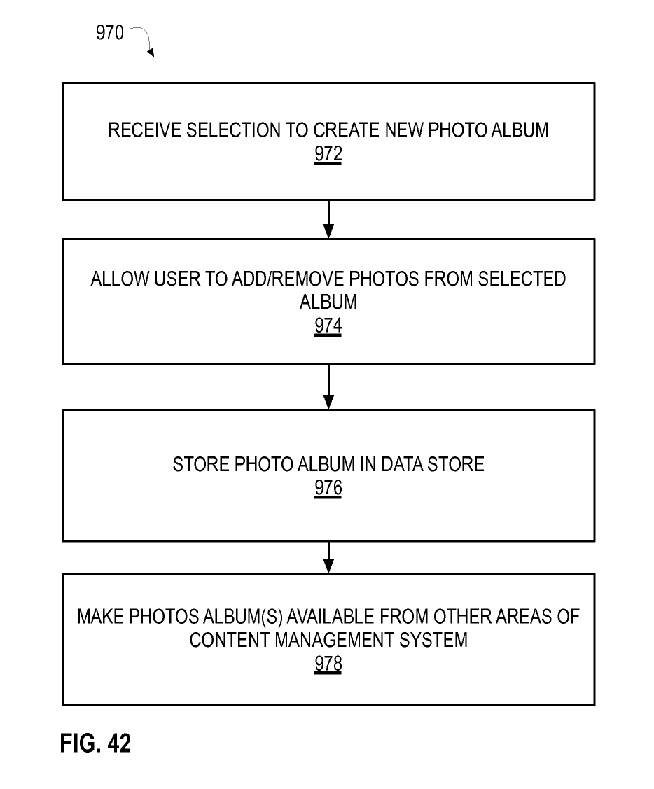

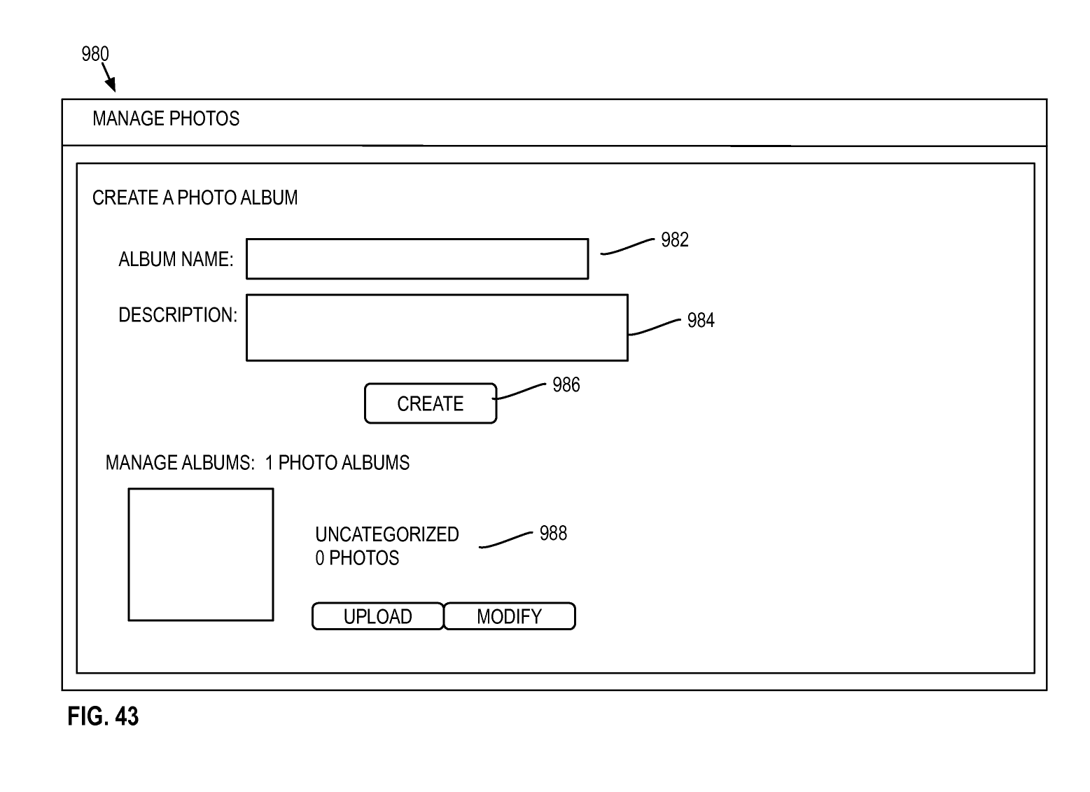

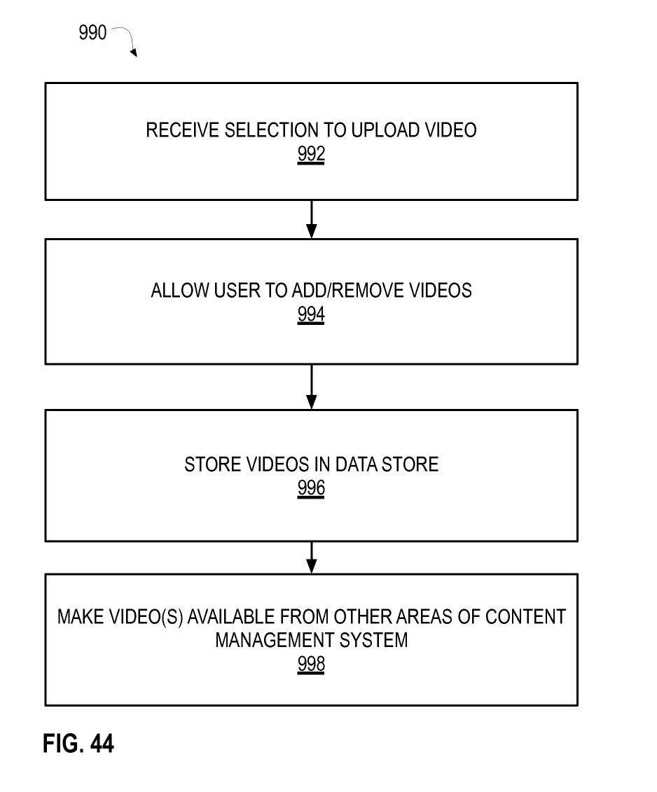

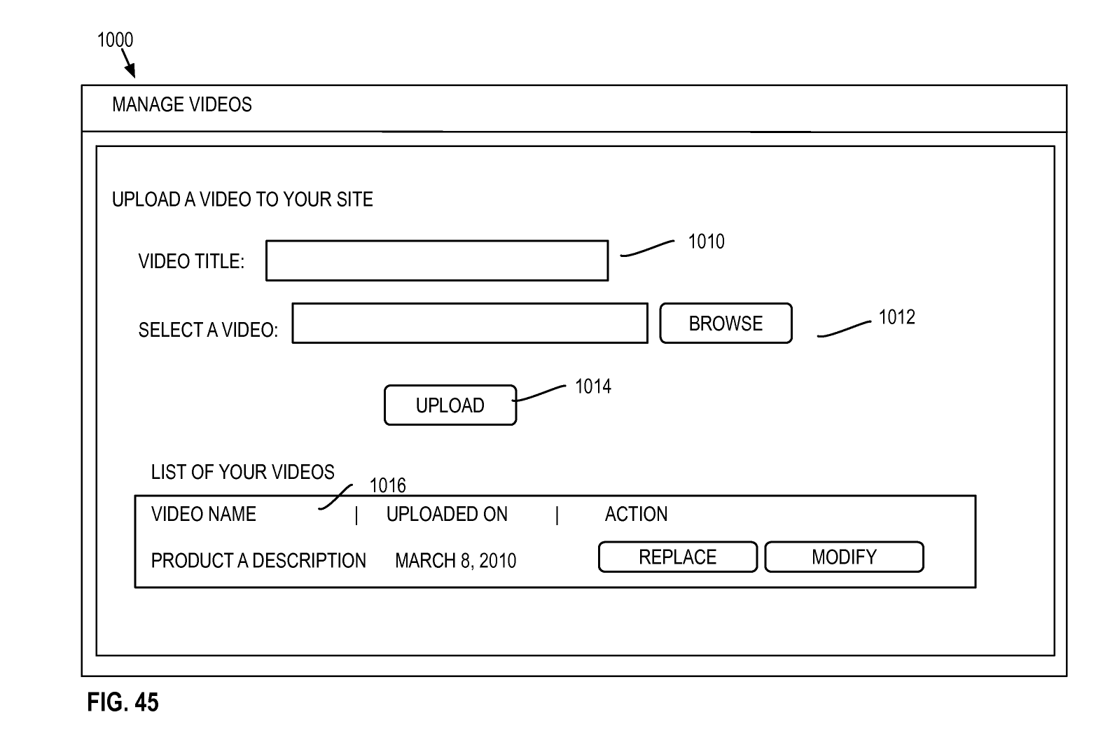

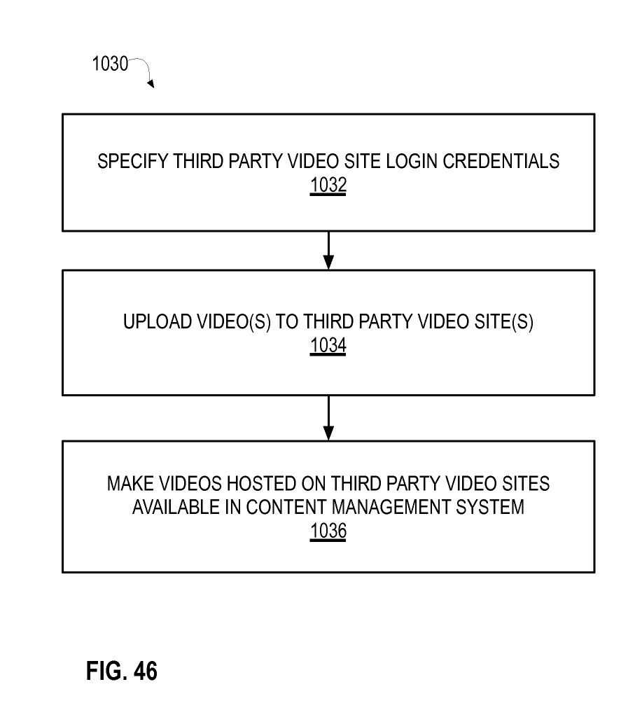

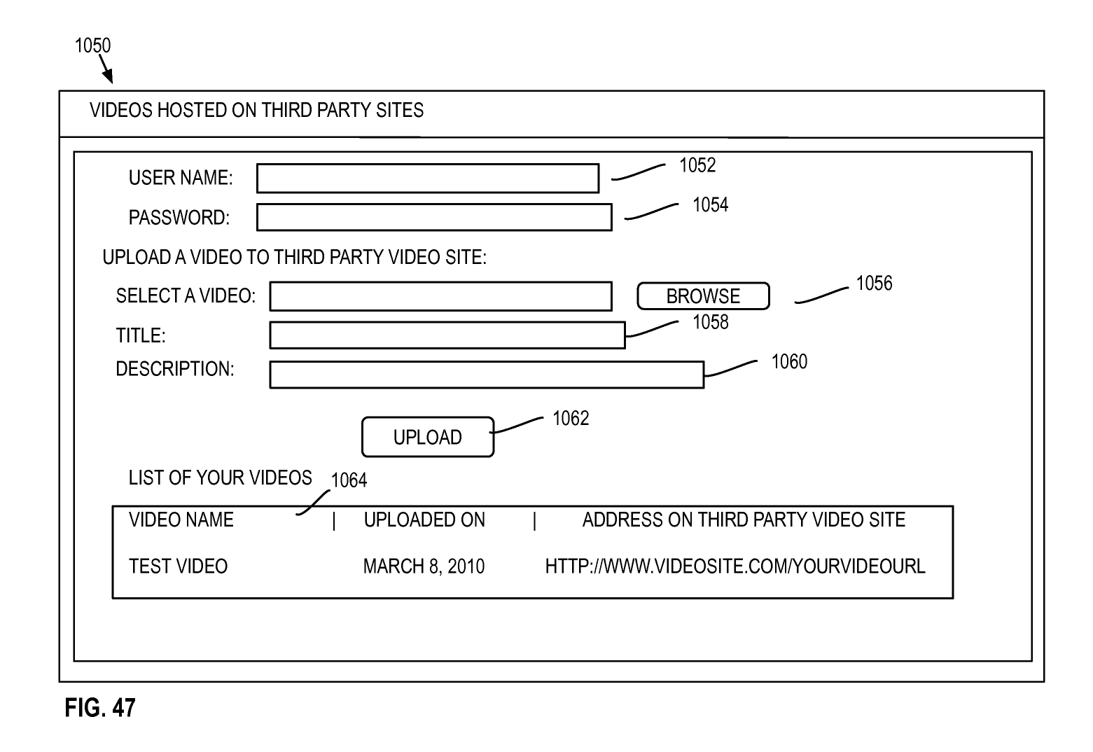

Manage photos and videos module 150 is responsible for managing the photos and videos that are used by a web site. Manage photos and videos module 150 is described in more detail in FIGS. 42-47. For example, the manage photos module 152 is described in FIGS. 42-43, the manage videos module 154 is described in FIGS. 44-45, and the manage videos on third party sites module 156 is described in FIGS. 46-47.

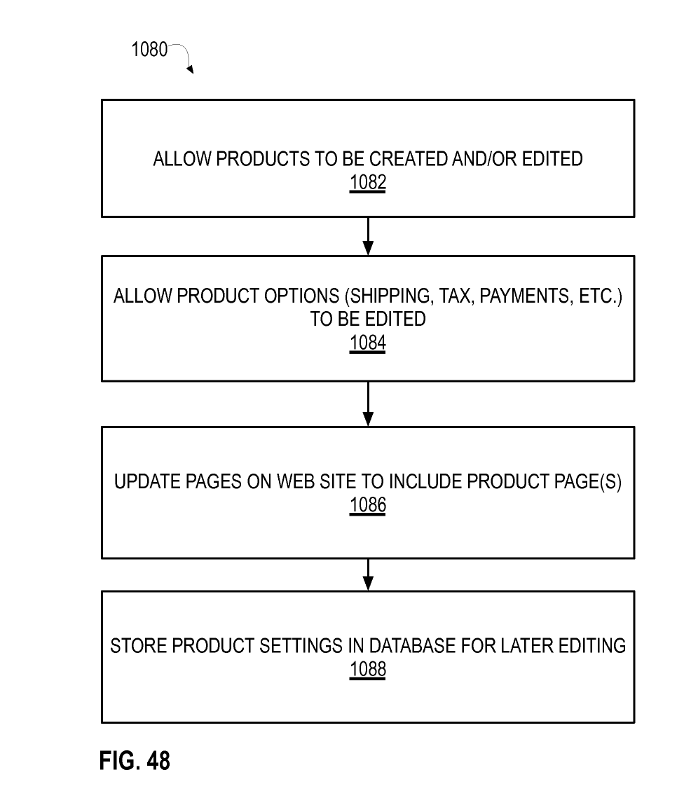

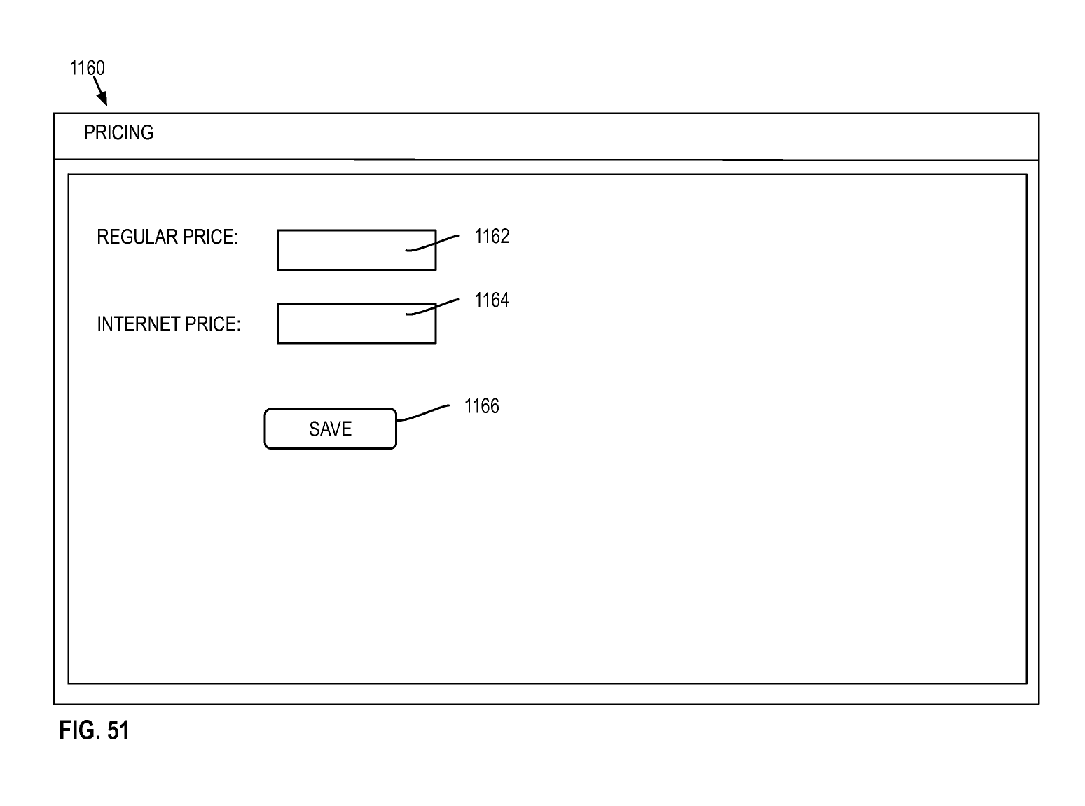

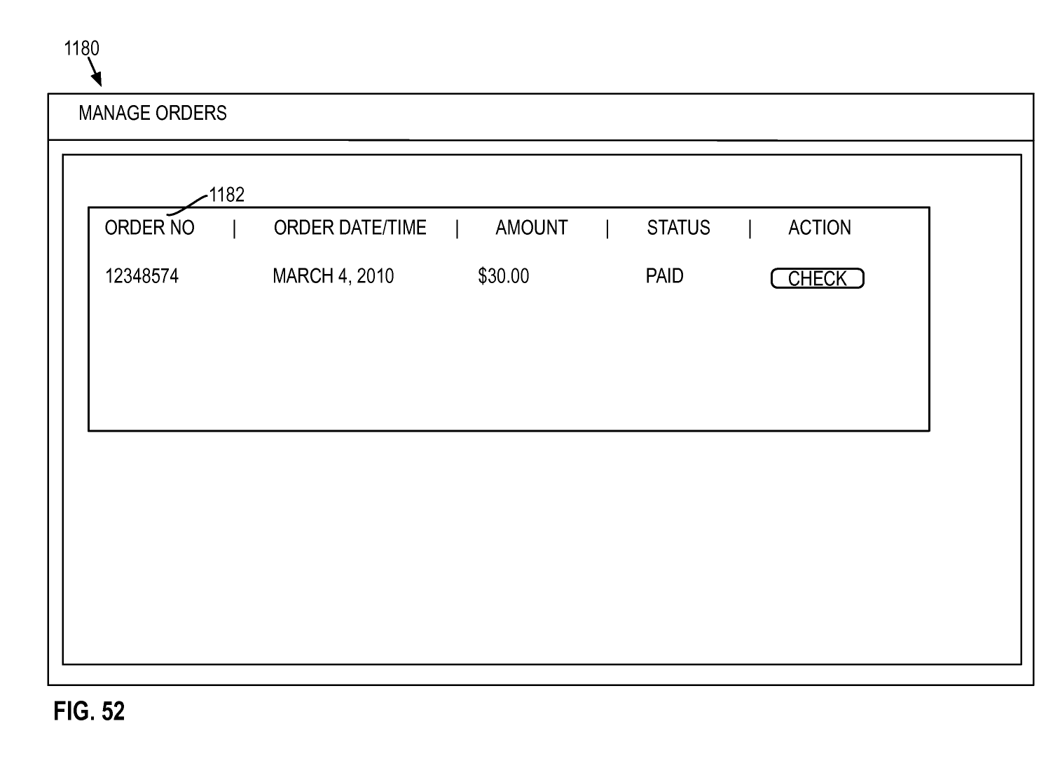

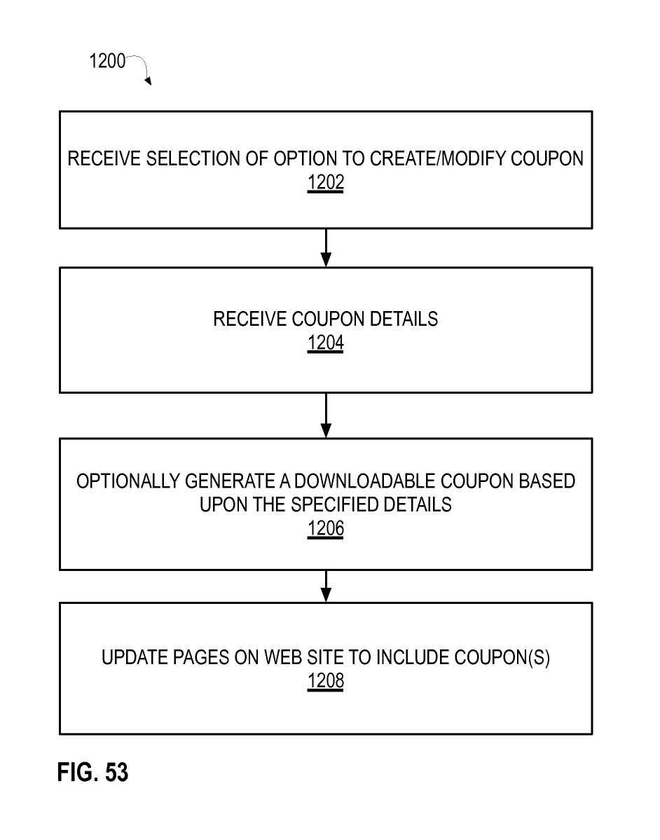

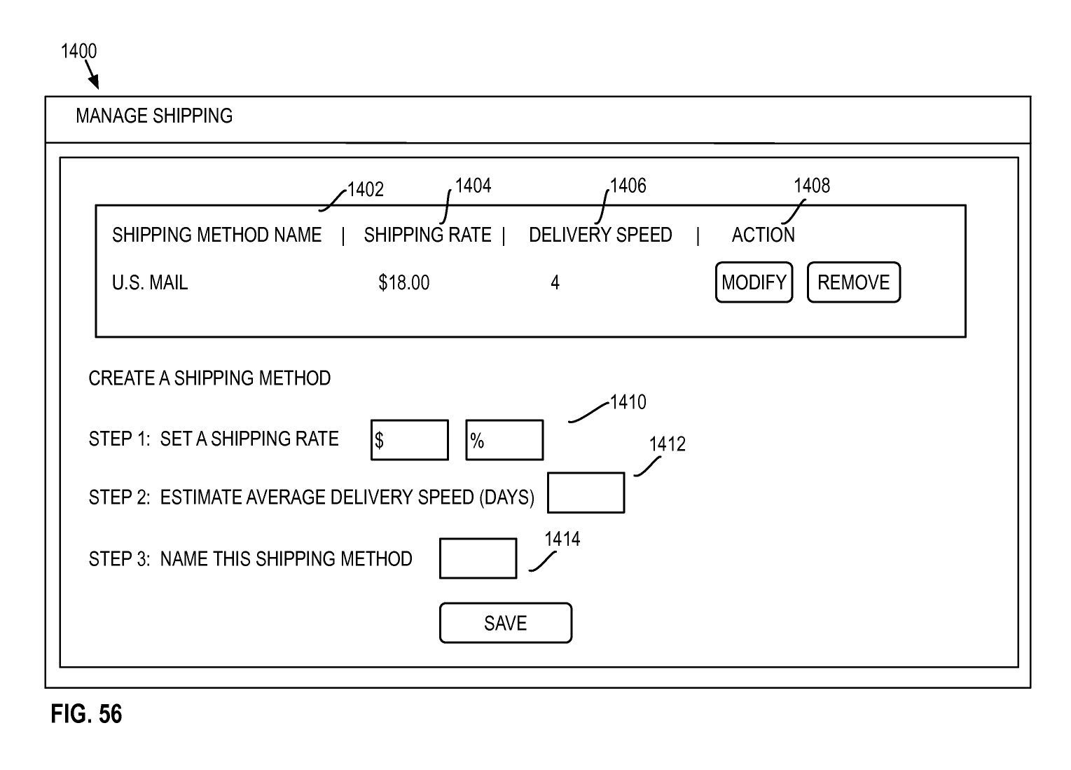

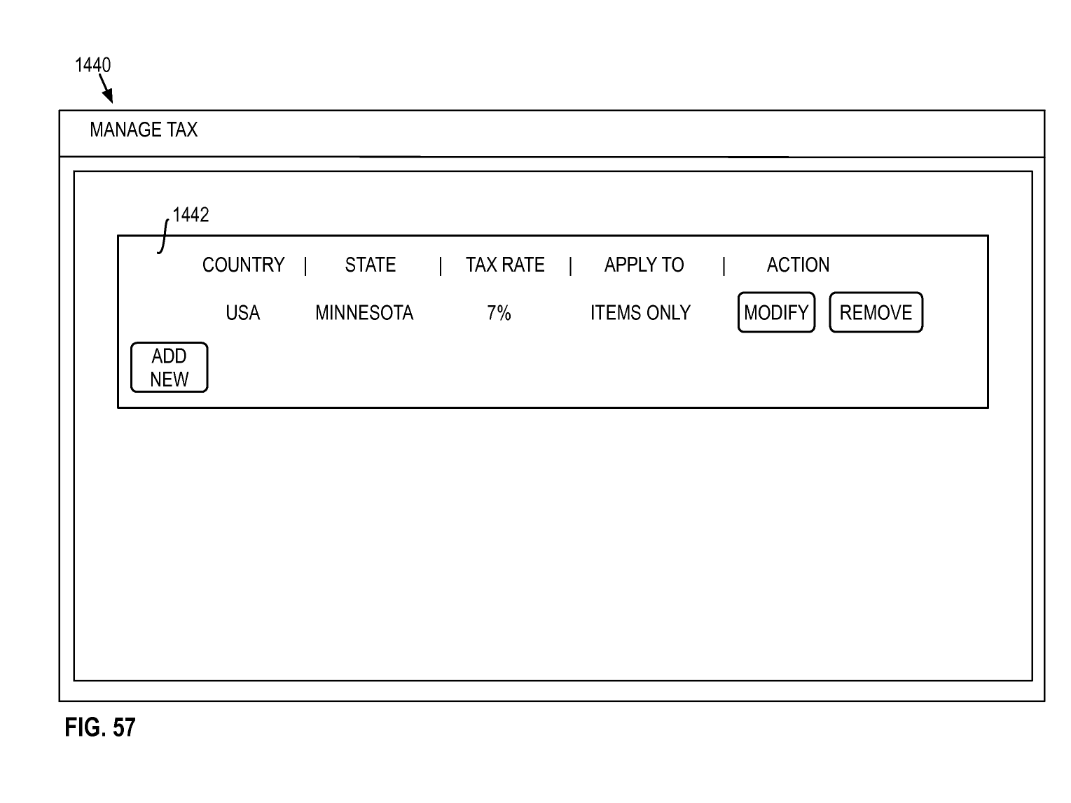

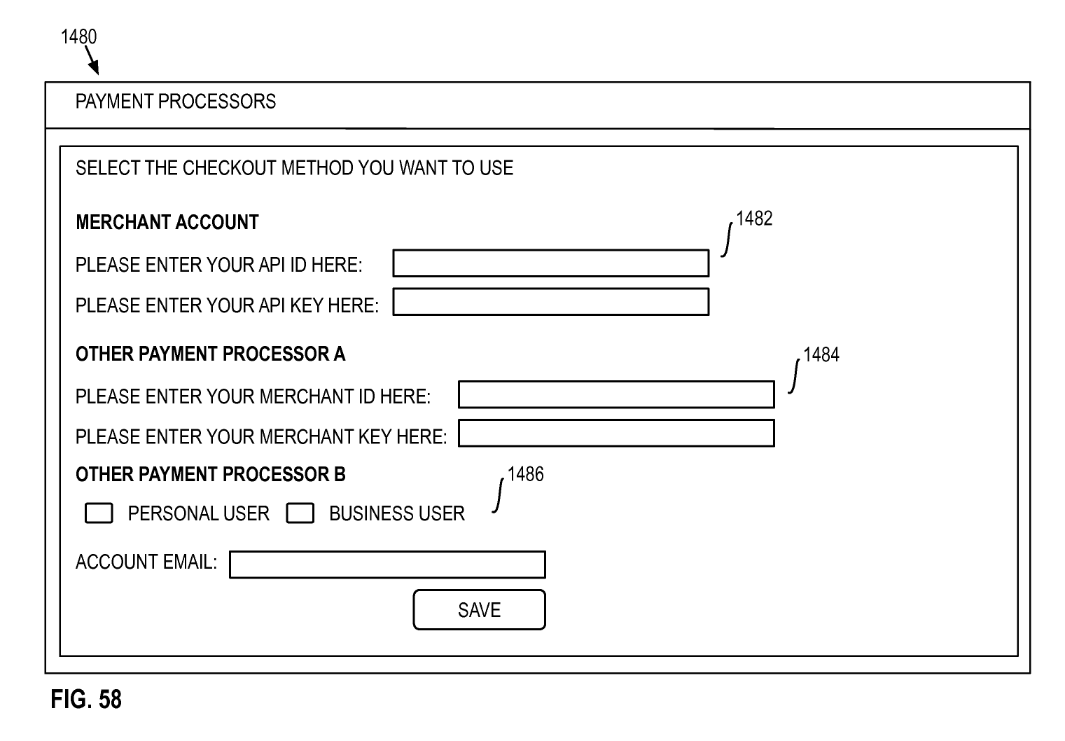

Ecommerce module 160 is responsible for and operable to allow ecommerce settings to be customized for a web site. The various features of ecommerce module 160 are described in more detail in FIGS. 48-58. For example, the manage products module 162 is described in FIGS. 48-50, the pricing module 164 is described in FIG. 51, the manage orders module 166 is described in FIG. 52, and the coupon generator module 168 is described in FIGS. 53-55. The manage shipping module 170 is described in FIG. 56, the manage tax module 172 is described in FIG. 57, and the payment processors module 174 is described in FIG. 58.

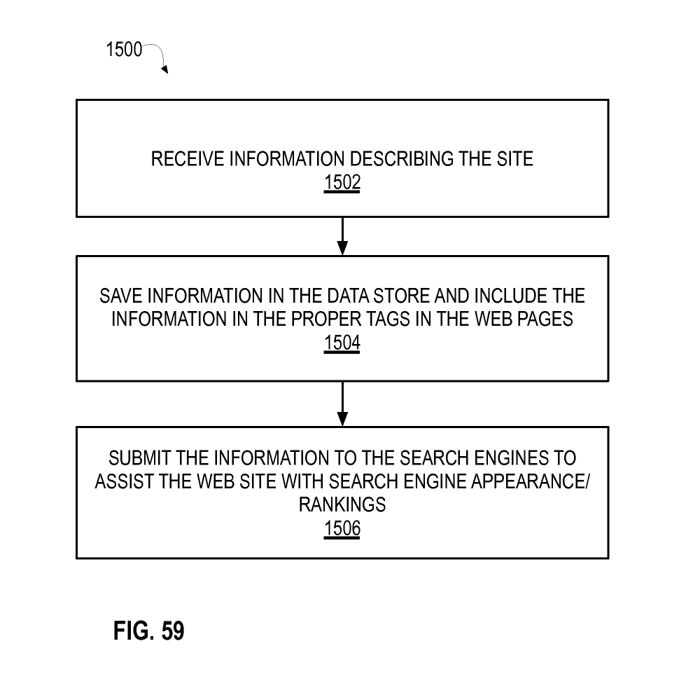

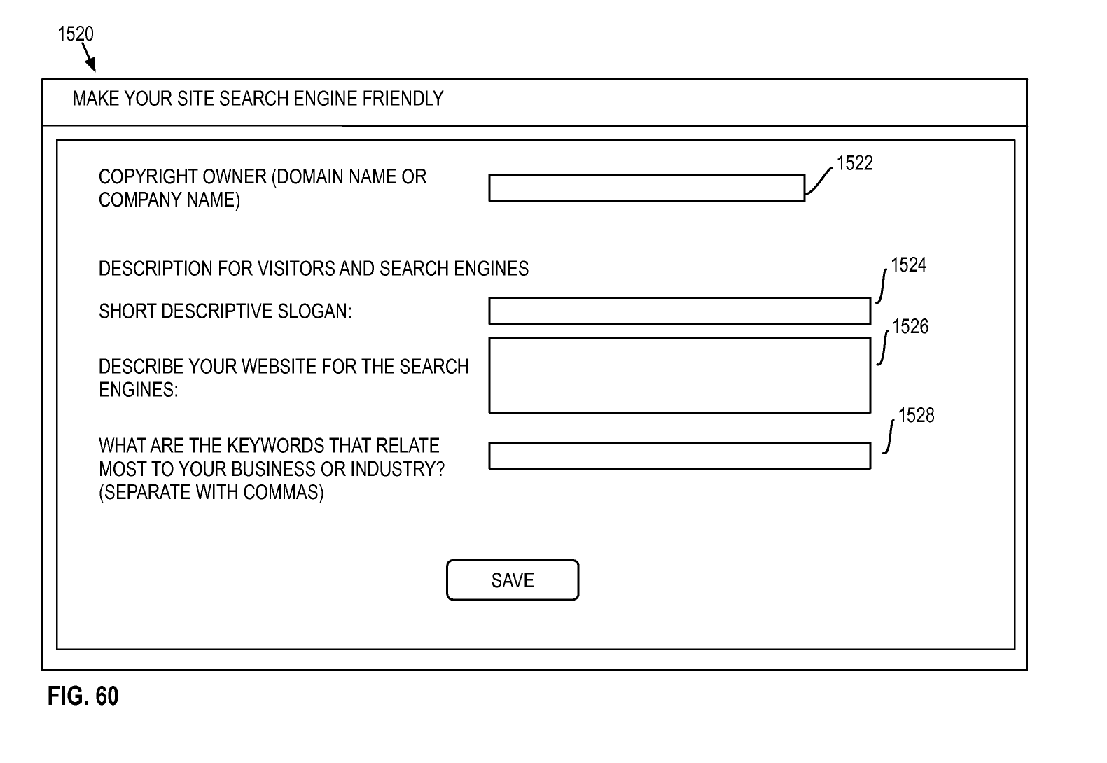

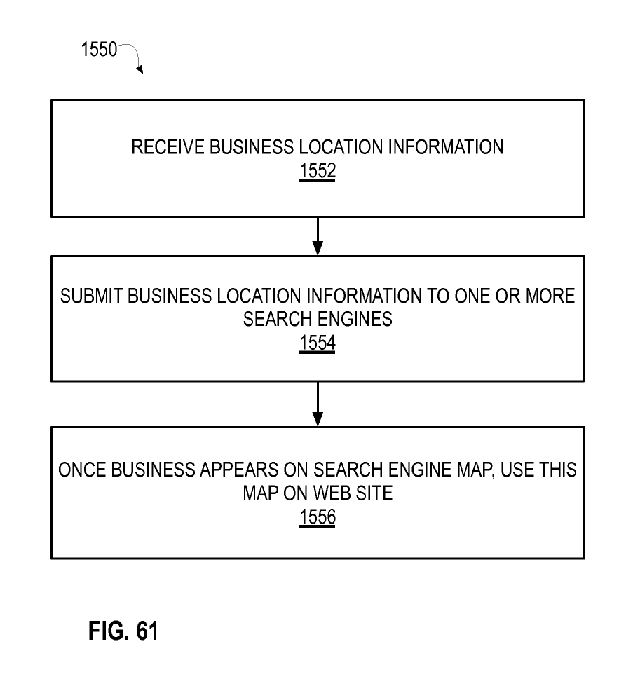

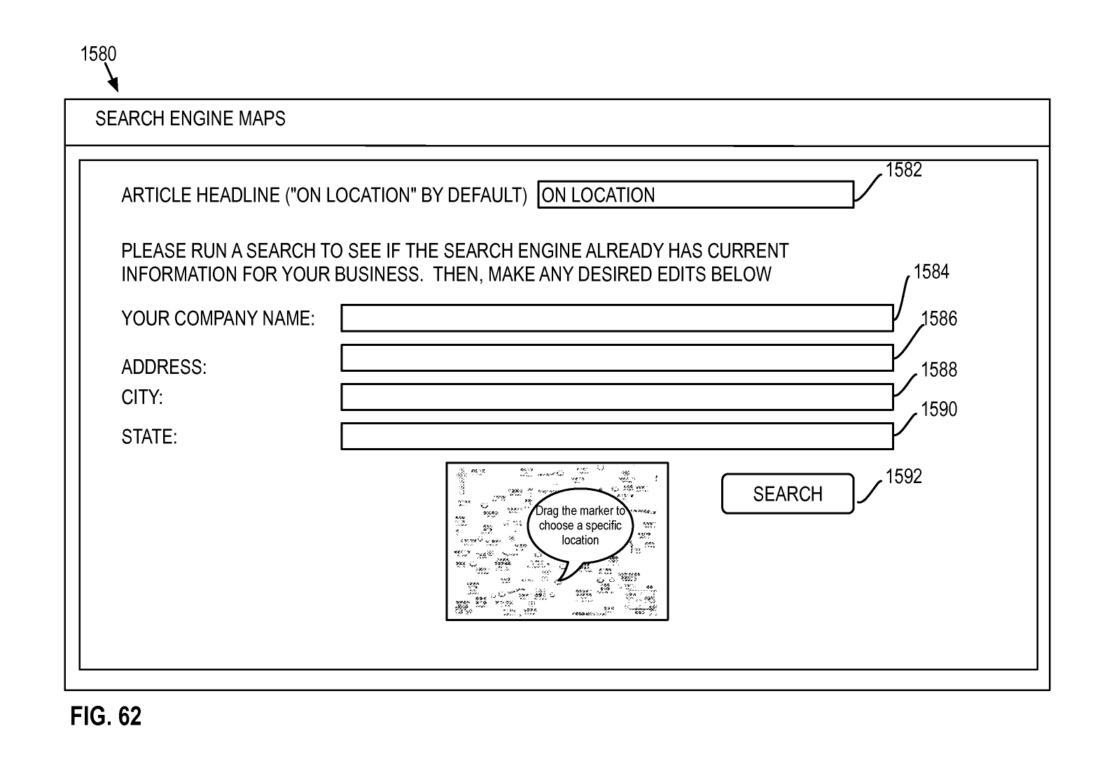

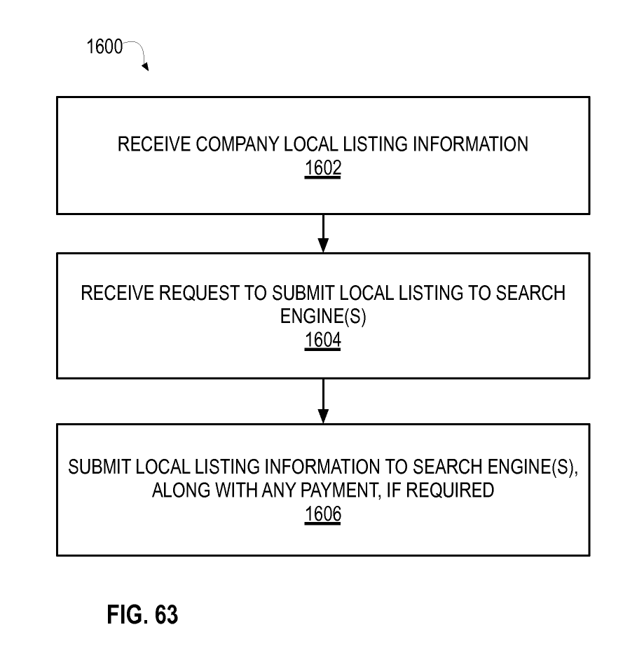

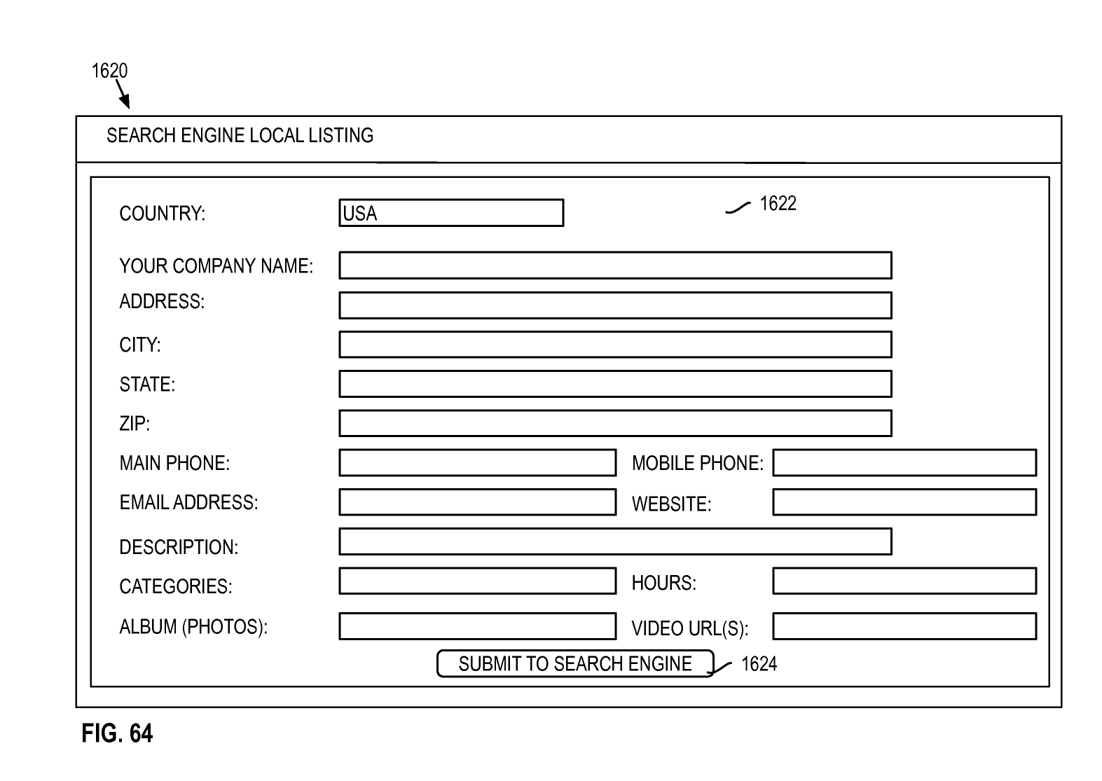

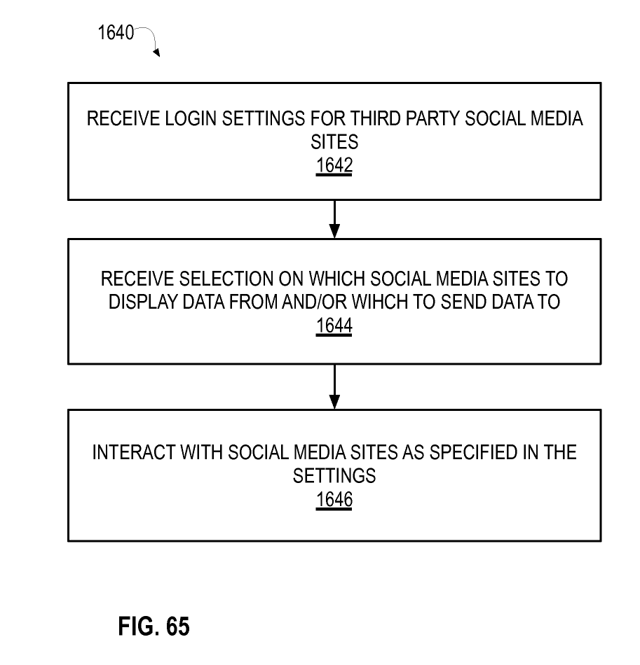

Web presence module 180 is responsible for and operable to manage site information about the web site that is submitted to third party web sites. The various features of web presence module 180 are described in more detail in FIGS. 59-68. For example, search engine module 182 is described in FIGS. 59-60, search engine map module 184 is described in FIGS. 61-62, search engine local listing module 186 is described in FIGS. 63-64, and social media module 188 is described in FIGS. 65-68.

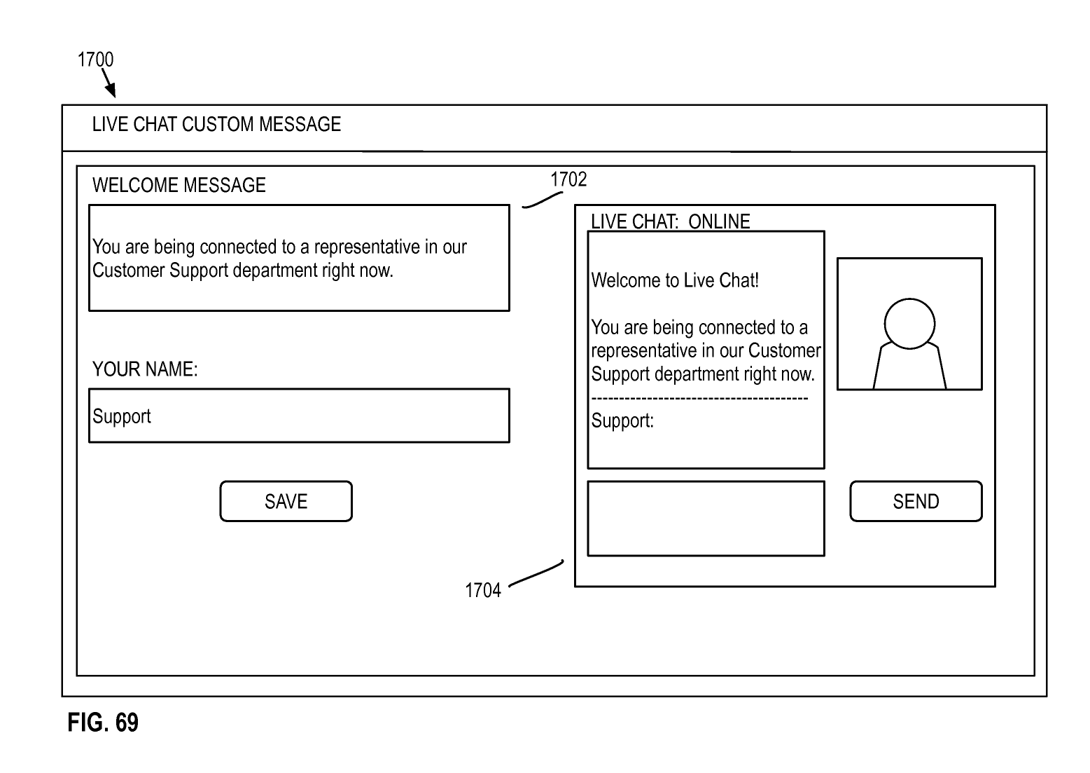

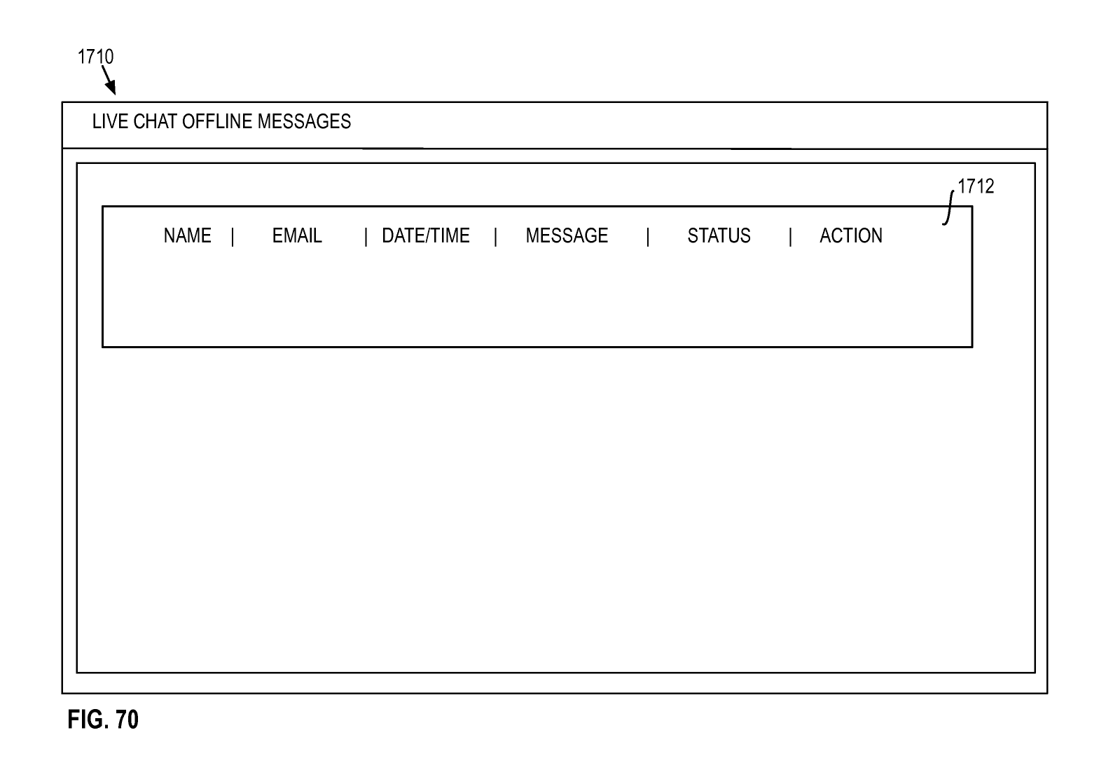

Live chat module 200 is responsible for and operable to manage live chat settings for the web site. The various features of live chat module 200 are described in more detail in FIGS. 69-71. For example, the custom message module 202 is described in FIG. 69, the offline message module 204 is described in FIG. 70, and the chat history module 206 is described in FIG. 206.

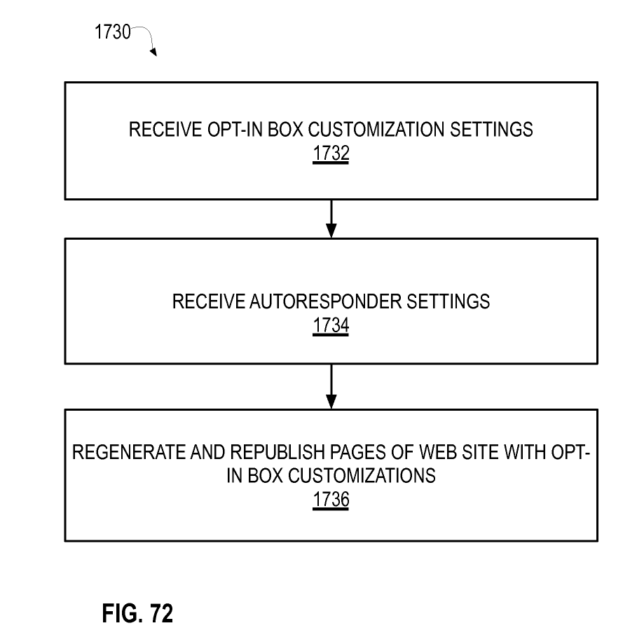

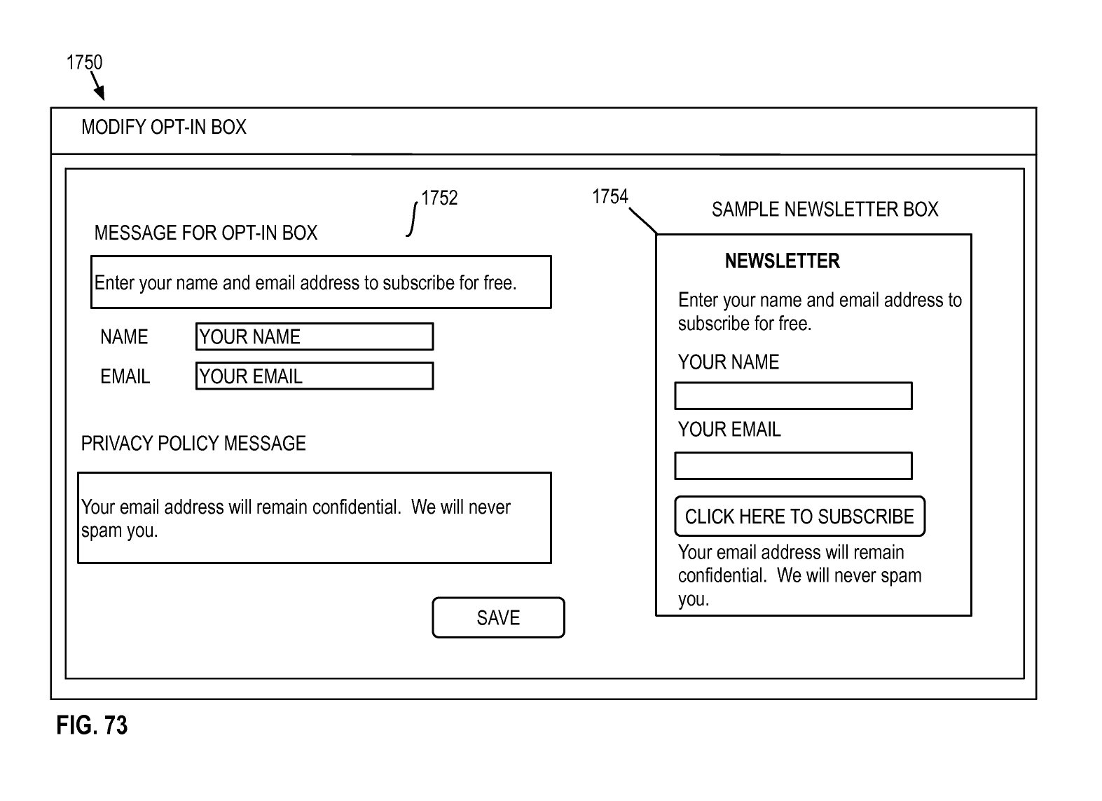

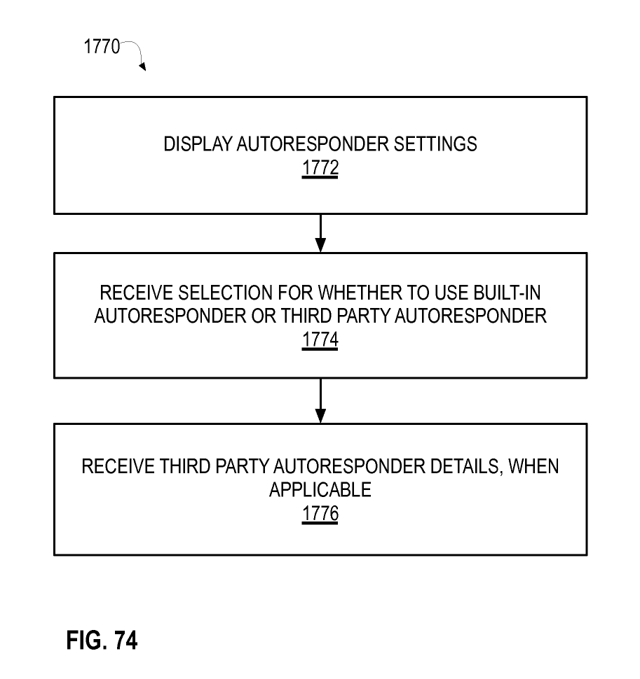

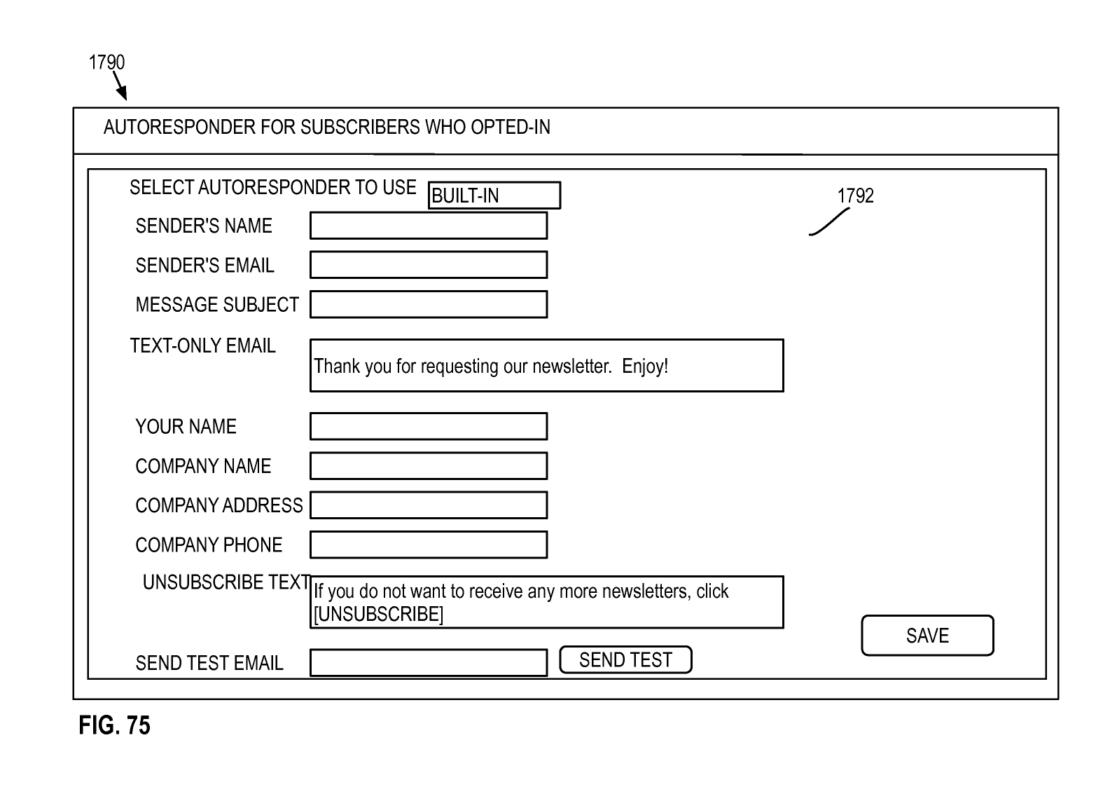

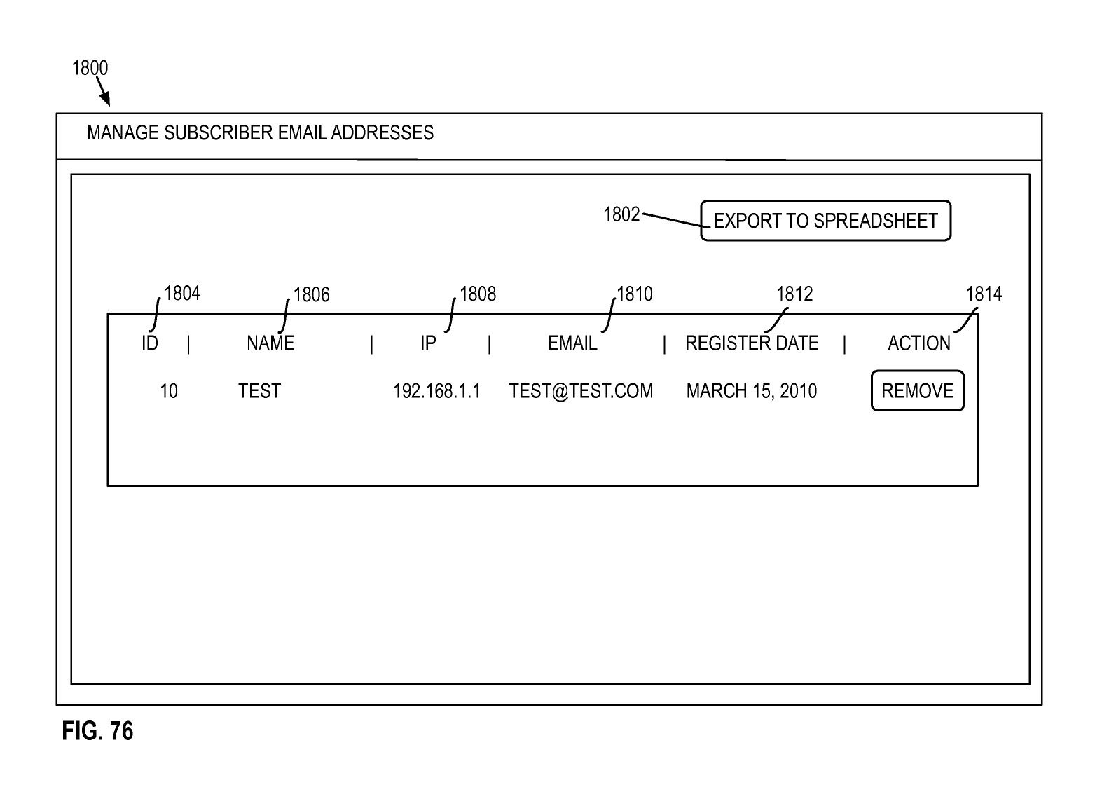

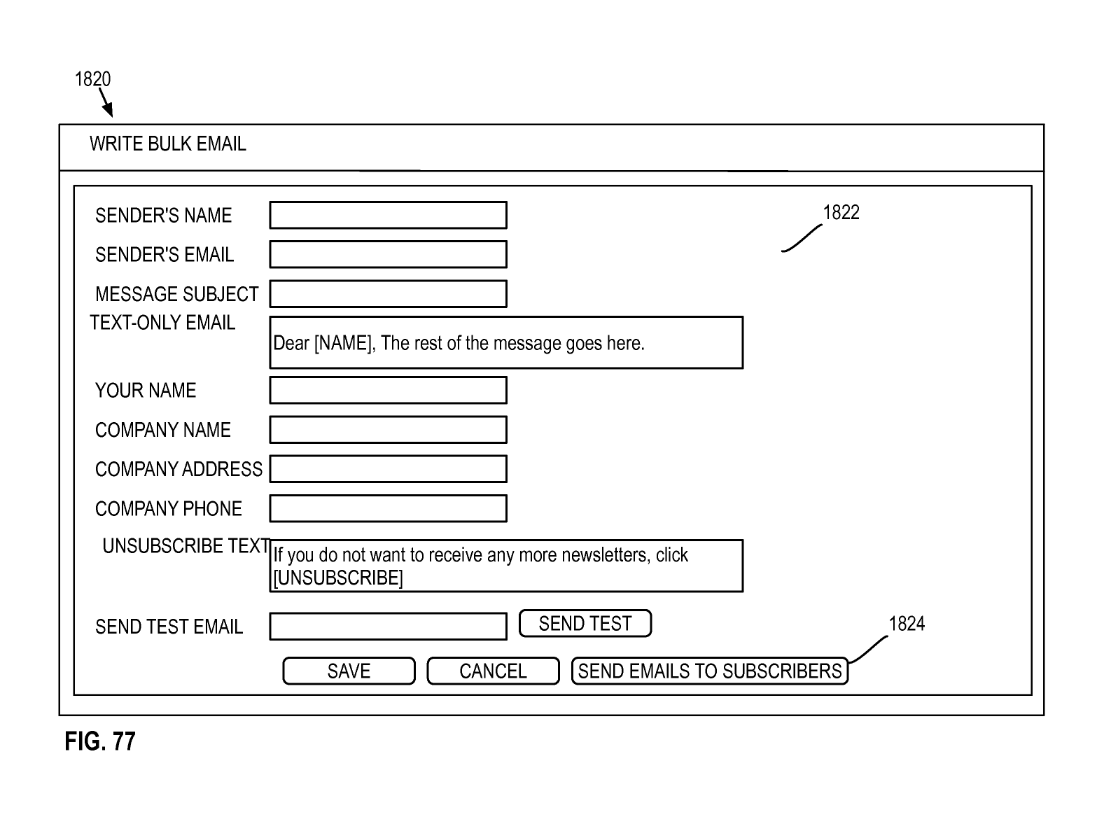

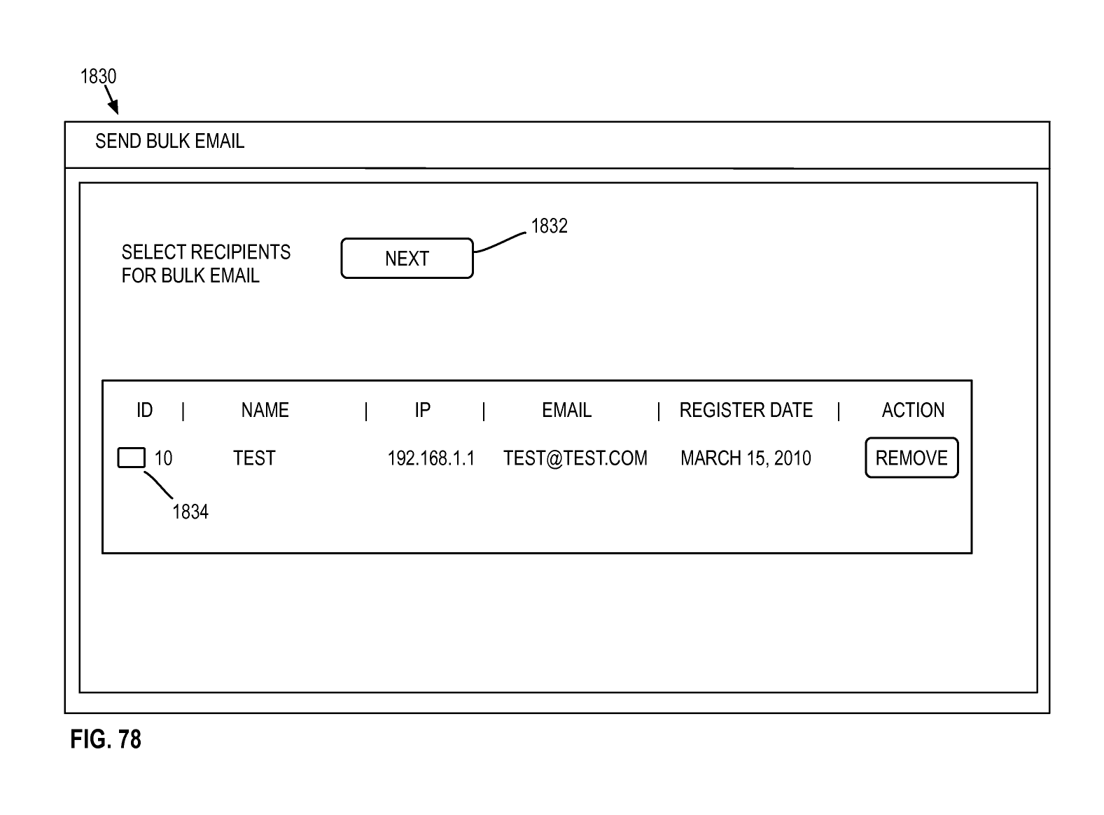

Newsletter module 220 is responsible for and operable to manage settings for an opt-in box that can be displayed on a web site. The various features of newsletter module 220 are described in more detail in FIGS. 72-78. For example, opt-in box module 222 is described in FIGS. 72-73, autoresponder module 224 is described in FIGS. 74-75, and manage emails module 226 is described in FIG. 76. Write bulk email module 228 is described in FIG. 77 and send bulk email module 230 is described in FIG. 78.

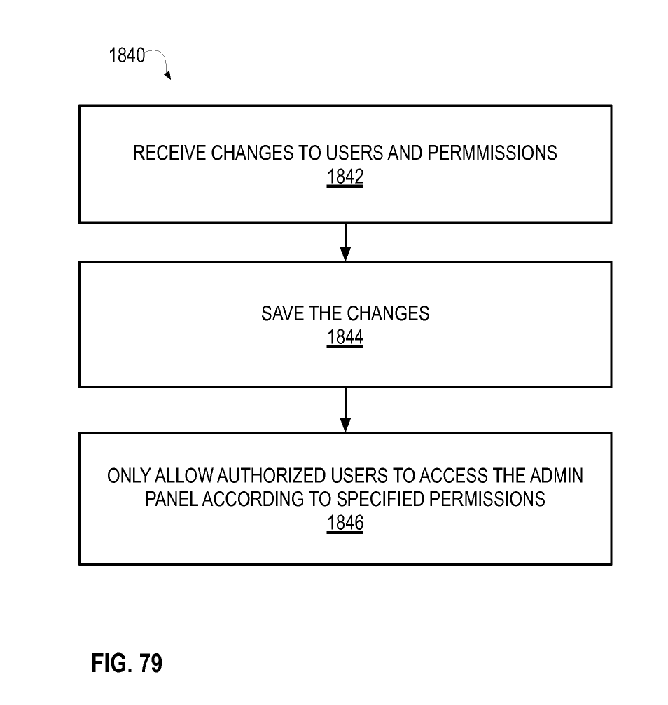

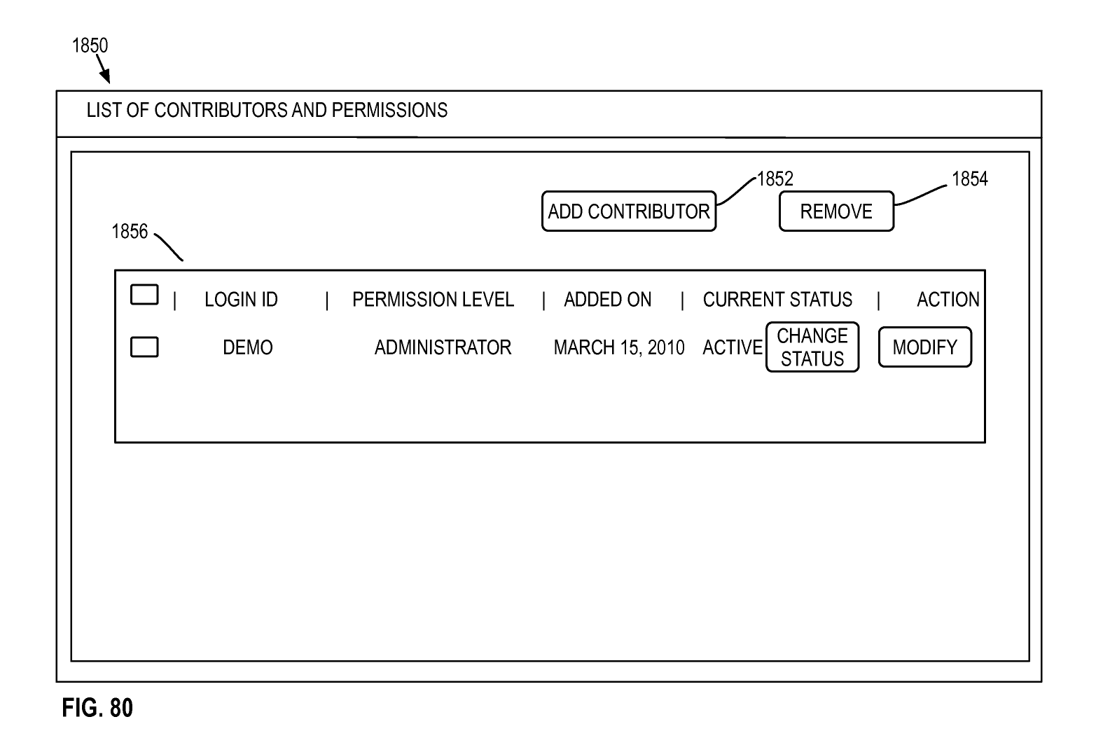

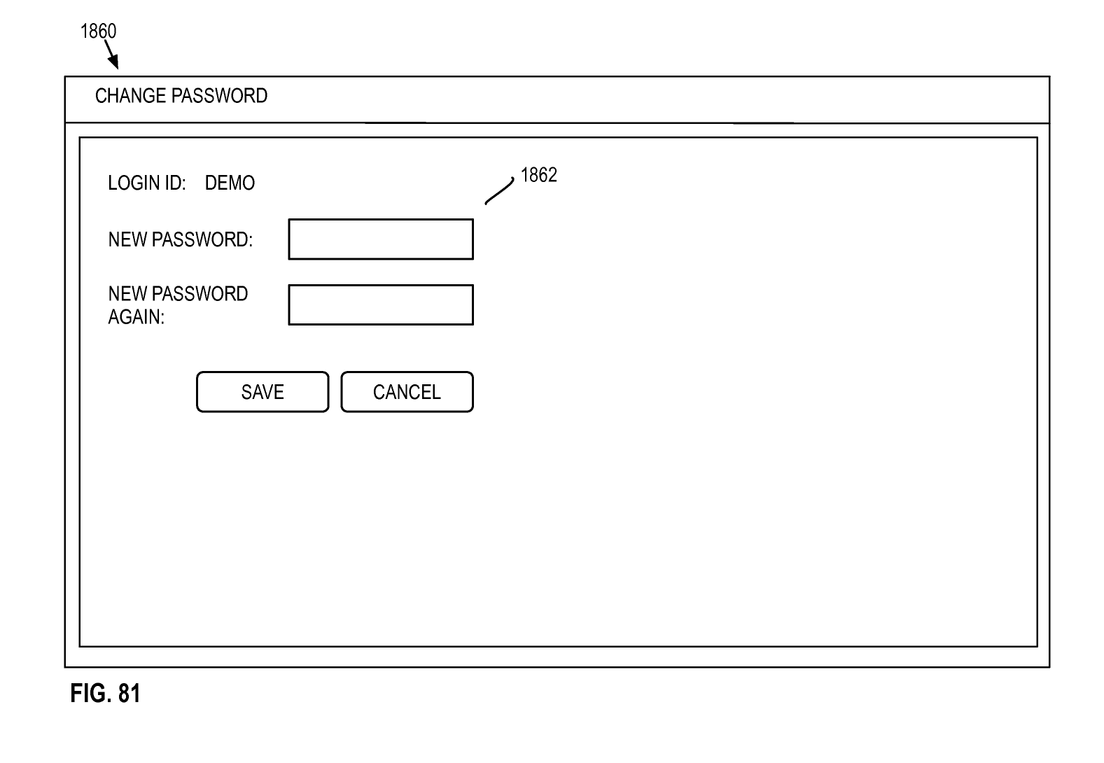

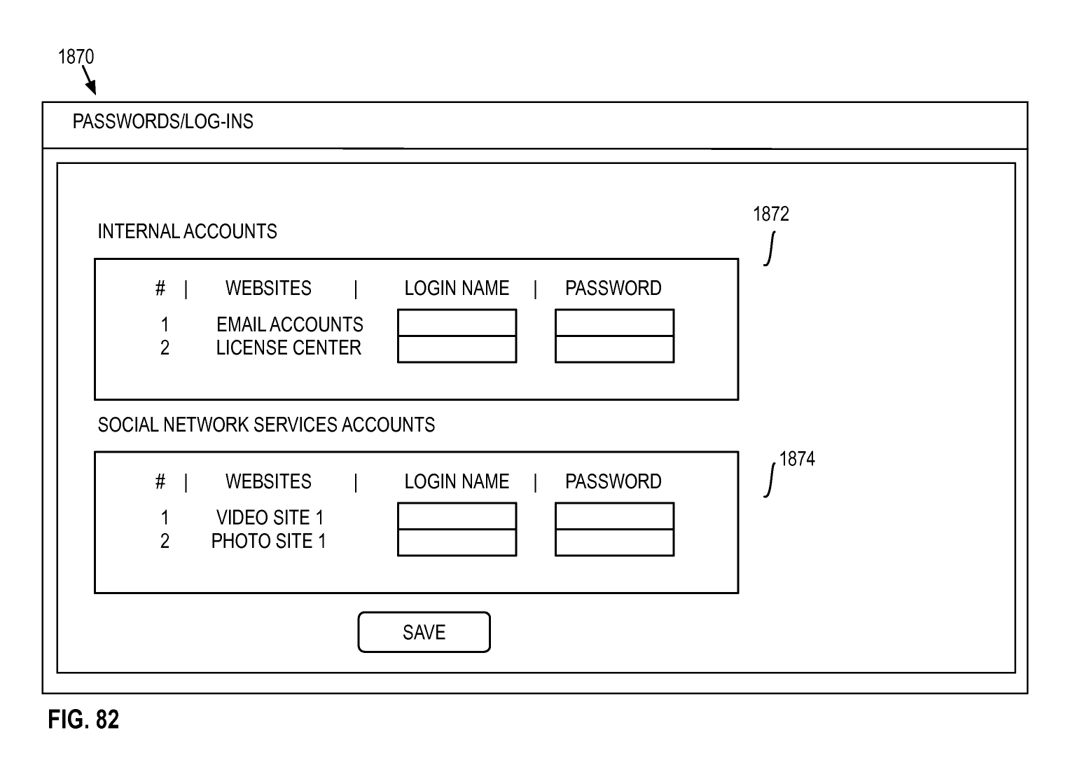

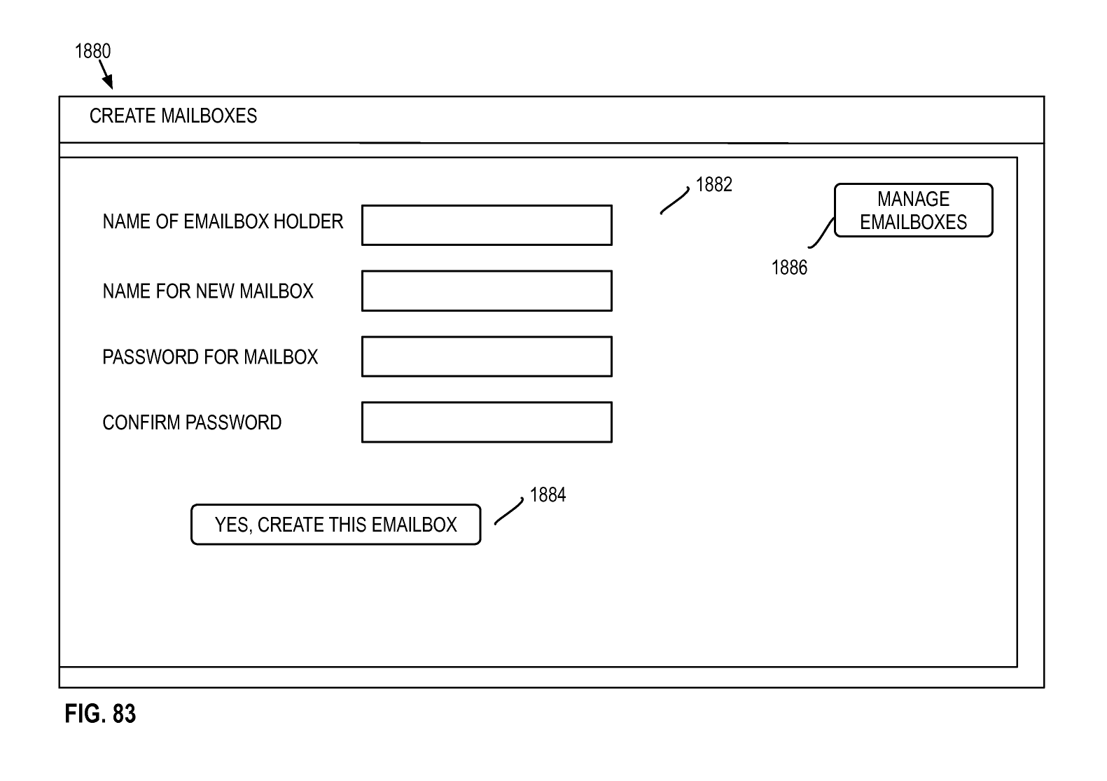

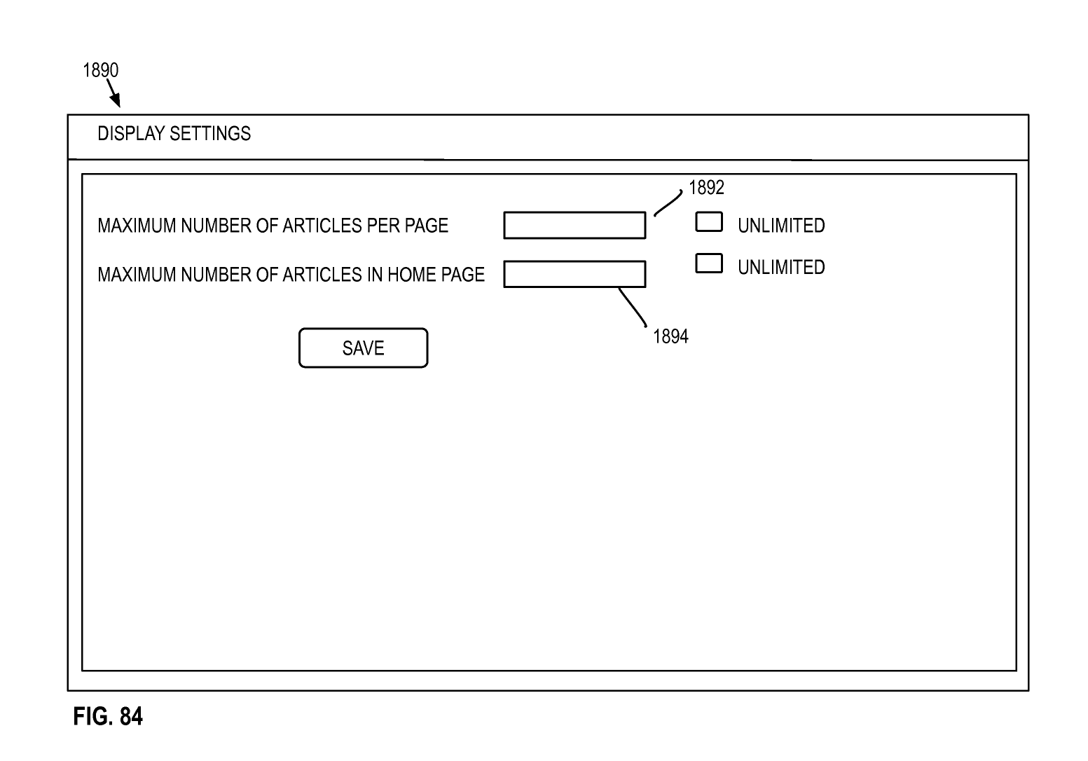

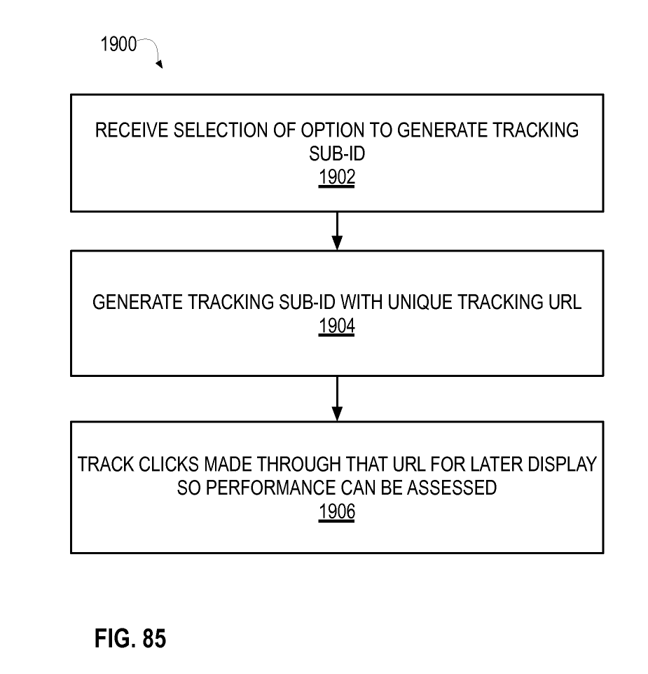

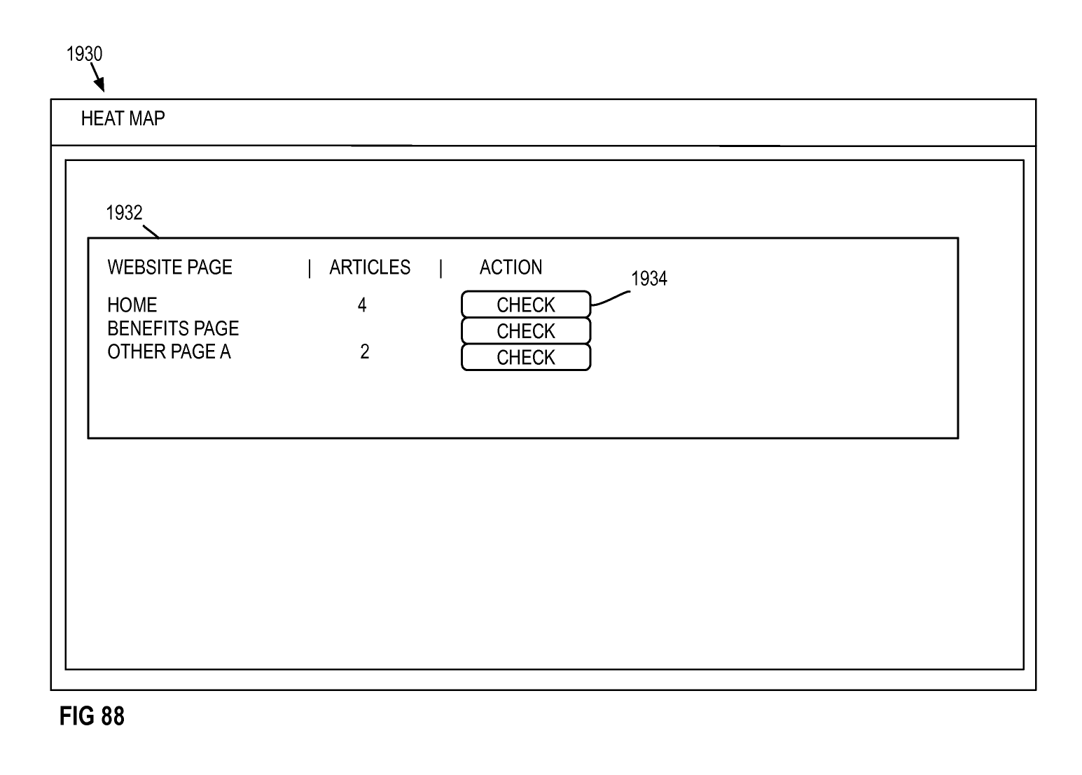

Settings module 240 is responsible for and operable to manage various settings for a web site. The various features of settings module 240 are described in more detail in FIGS. 79-89. For example, the contributors module 242 is described in FIGS. 79-80, the change password module 244 is described in FIG. 81, the log-ins module is described in FIG. 82, and the create emailboxes module 248 is described in FIG. 83. The display settings module 250 is described in FIG. 84, the visitor tracking module 252 is described in FIG. 85, and the heat map module 254 is described in FIGS. 88-89.

While these modules are shown in the arrangement of FIG. 2 for the sake of illustration, it will be appreciated that in other implementations, some of the modules described herein could be combined into the same module, or otherwise be in different arrangements than those illustrated. For example, the contents module 110 and the business pages module 130 could be included within a single module. In other implementations, some of the modules may be omitted. Each of these modules will now be discussed in further detail in FIGS. 3-89.

Turning now to FIG. 3, a process flow diagram 300 for one implementation is described that illustrates the stages involved in using an interactive quickstart menu to quickly create a new web site. A quickstart wizard is displayed (stage 302). The user can select a setup step from the list of steps contained in the quickstart wizard (stage 304). Once the user selects a particular setup step in the list, additional tasks are then displayed for the selected setup step (stage 306). The user selects and completes the tasks for the selected setup step as desired (stage 308). The stages are repeated for additional setup steps (stage 310).

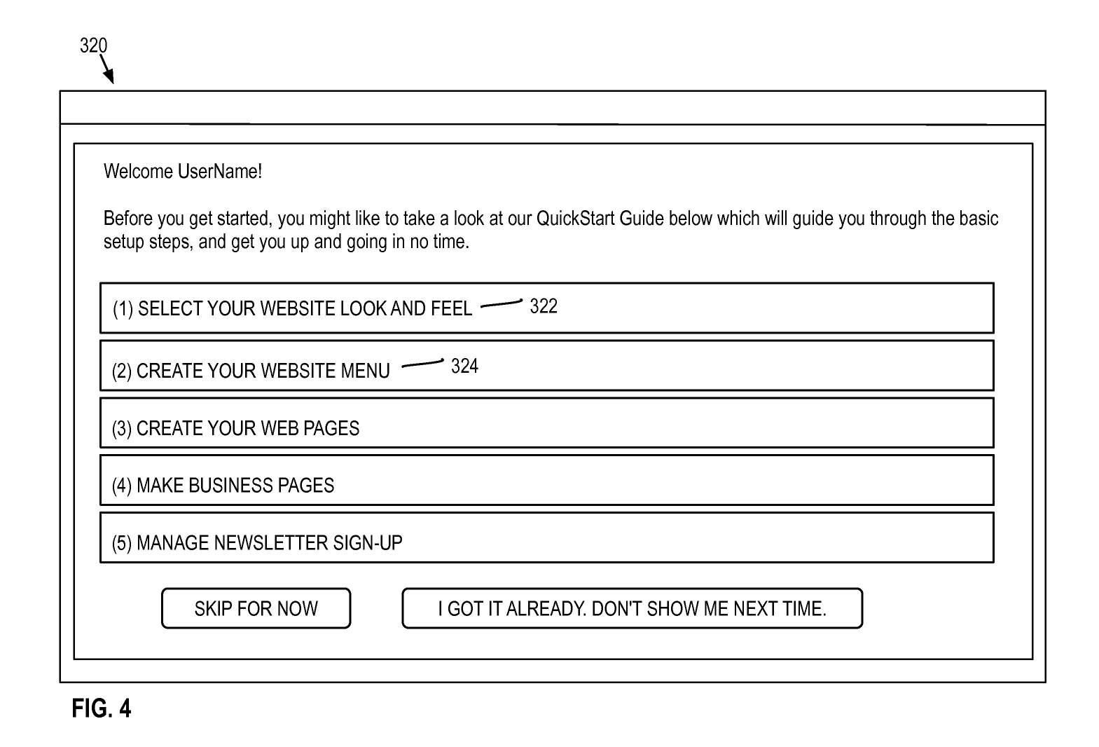

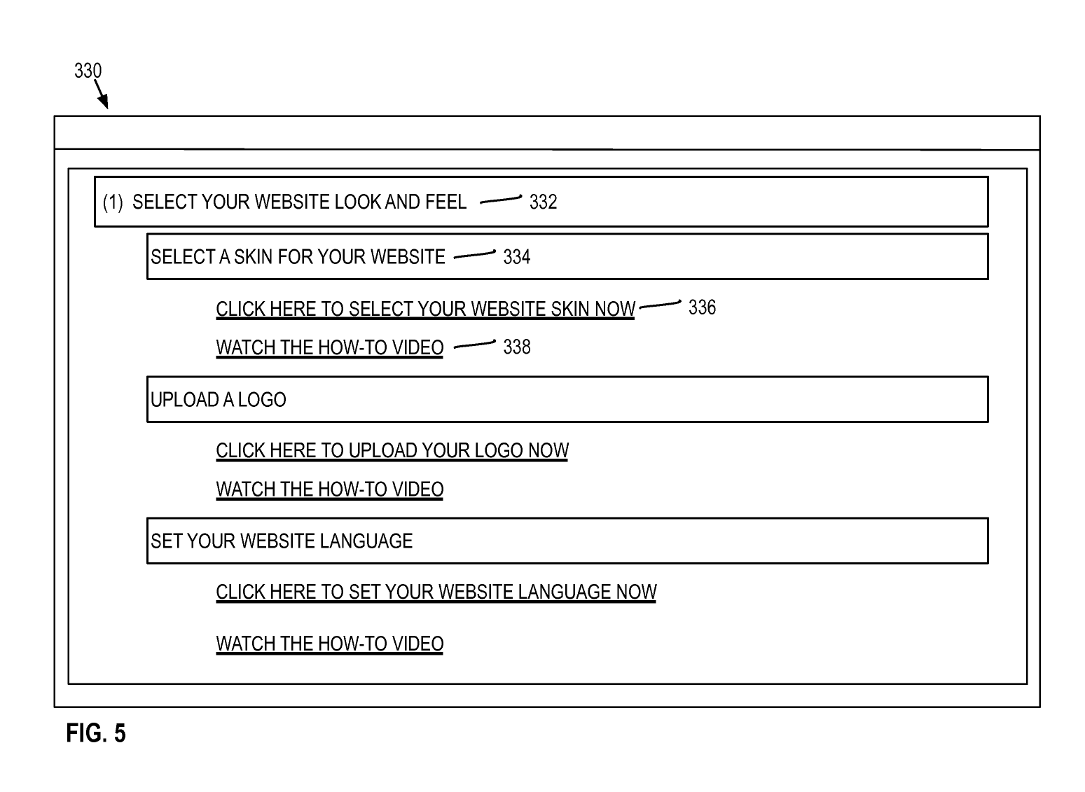

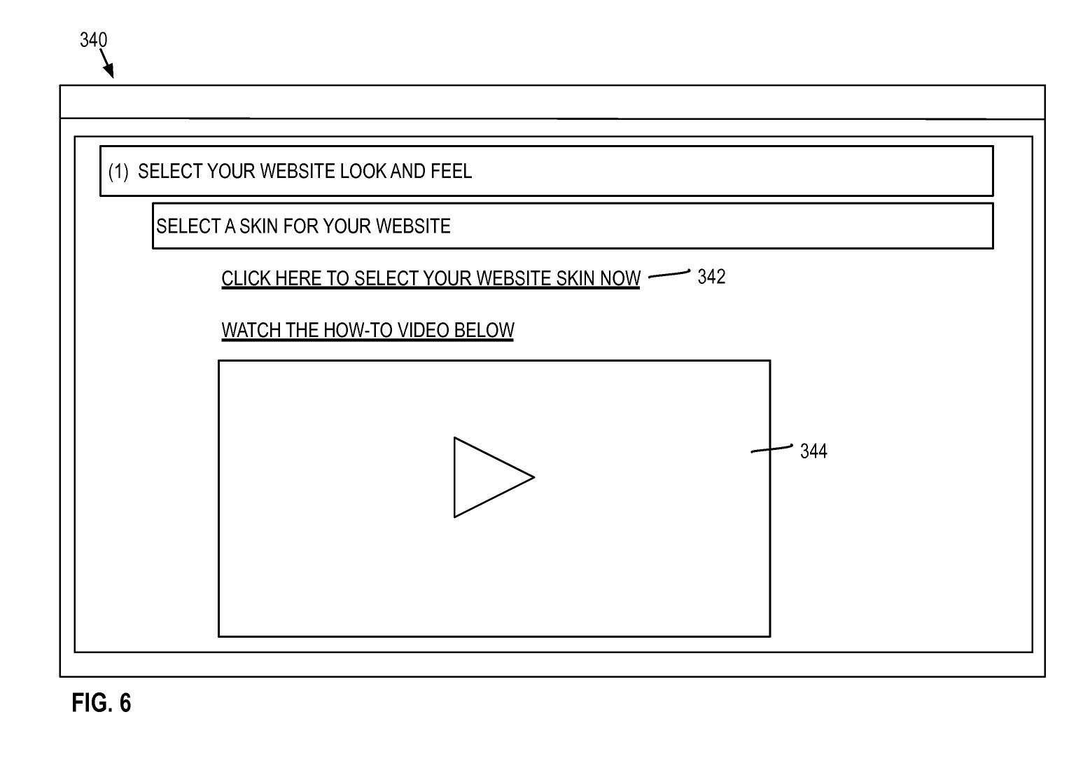

FIG. 4 is a simulated screen 320 for one implementation that illustrates a quickstart menu that outlines some high level steps 320 that can be completed to set up a new web site. As shown in further detail in FIGS. 5 and 6, the steps can be expanded and collapsed to reveal other sub-steps that need to be taken in order to complete the given step. In one implementation, quickstart menu 320 is displayed when the administration module 16 is opened for content management system 10. In another implementation, the quickstart menu 320 can be accessed from other modules within the administration module 16.

FIG. 5 is a simulated screen 330 for one implementation that illustrates revealing additional details about a selected step in the quickstart menu. In the example shown, a selected step 332 has been expanded to reveal additional steps (such as sub-step 334) that need to be performed in order to complete that step. Additional details are then displayed for each sub-step, such as a link 336 that navigates to the feature within the site where the step can be completed, and/or a link to a training video 338 or other training information.

FIG. 6 is a simulated screen 340 for one implementation that illustrates using training videos as part of the quickstart menu. A training video 344 appears for a particular step 342 in the quickstart menu to provide further instruction on how to complete that step.

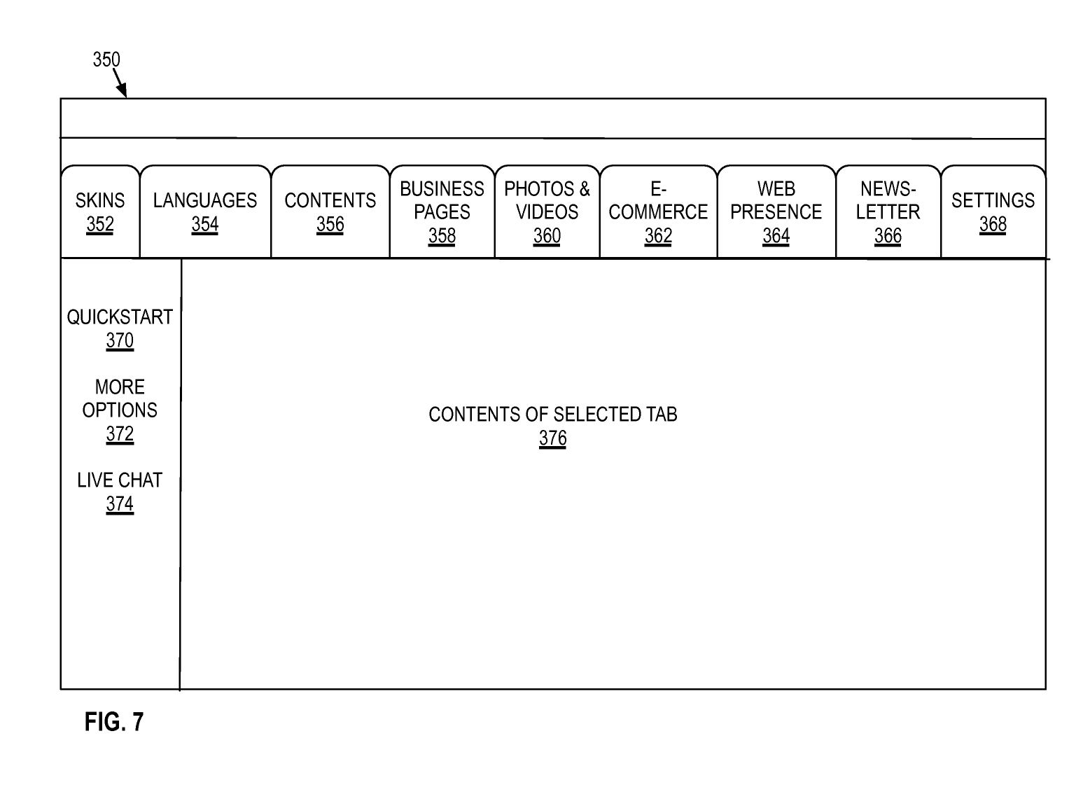

FIG. 7 is a simulated screen 350 for one implementation that illustrates an exemplary navigation menu for content management system 10. In one implementation, navigation menu is used to access different menus of content management system 10. Navigation menu allows access to various system features, including skins 352, languages 354, contents 356, business pages 358, photos and videos 360, e-commerce 362, web presence 364, newsletter 366, and settings 368. A side menu is also included in one implementation to include quickstart menu 370, more options 372, and live chat 374. The contents of the selected tab 376 are also displayed on the screen. This is just one of many possible variations that can be used for accessing the features of content management system 10. In other implementations, other types of navigation arrangements can be used.

FIG. 8 is a process flow diagram 390 for one implementation illustrating the stages involved in setting a site's look and feel by choosing a skin. A selection is received to browse through the available skins (stage 392). Selected skins can be displayed in a preview mode as desired (stage 394). Input is received to apply the selected skin to a web site (stage 396). The skin identifier is saved separately from the web page contents so the look and feel of the web site can be modified later by just selecting a different skin (stage 398).

FIG. 9 is a simulated screen 400 for one implementation that illustrates selecting a skin from numerous available skins The current skin 402 is displayed, along with options for searching for skins by category 404, keyword 406, main color 408 and secondary color 410. Another skin can be selected from the list 414 and applied to the current web site.

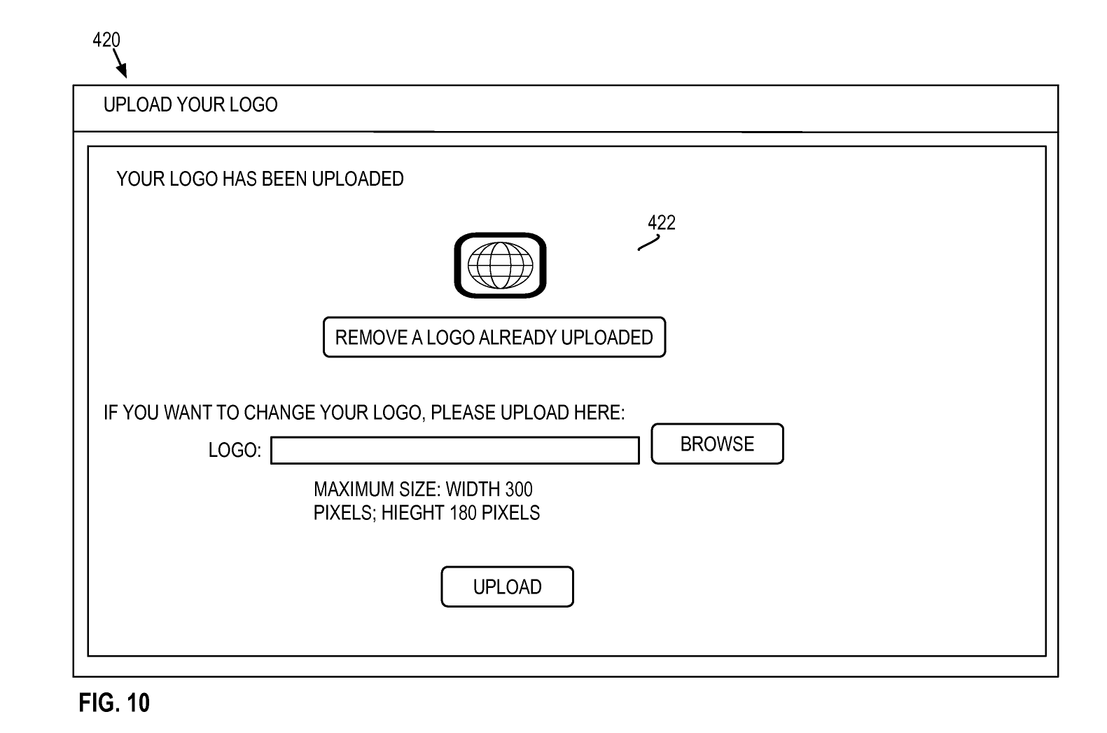

FIG. 10 is a simulated screen 420 for one implementation that illustrates uploading a logo 422 to be used with the selected skin. In one implementation, logo 422 is displayed in the upper corner of the selected skin on a web site generated by content management system 10. In other implementations, logo 422 is displayed in other positions along with the selected skin.

FIG. 11 is a process flow diagram 430 for one implementation illustrating the stages involved in assigning one or more languages for the web site. A user selection is received of a primary language to be used on a web site (stage 432). If the user wishes to have the web site published in other languages in addition to the primary language (decision point 434), then the user is prompted and can specify the additional language(s) (stage 436). The user is provided with an opportunity to enter content in various modules of the content management system for each of the selected languages (stage 438). In other words, whenever content is being requested to appear on the site in one language, an option is also provided to allow the user to specify that same type of content for any other languages being specified for the site.

FIG. 12 is a simulated screen 440 for one implementation that illustrates selecting the language(s) to be used for the web site. The primary language 442 is specified, along with an option indicating whether to have another language 444, and what the second language is 446 that should be used. In this non-limiting example shown in FIG. 12, there is a primary and secondary language that can be specified. In other implementations, more than two languages can be specified.

FIG. 13 is a simulated screen 460 for one implementation that illustrates a navigation menu for the contents module. Contents can be accessed to write an article 462, modify an article 464, manage menus 466, access the home top feature 468, manage polls 470, and video overlays 472. Each of these will now be discussed in further detail.

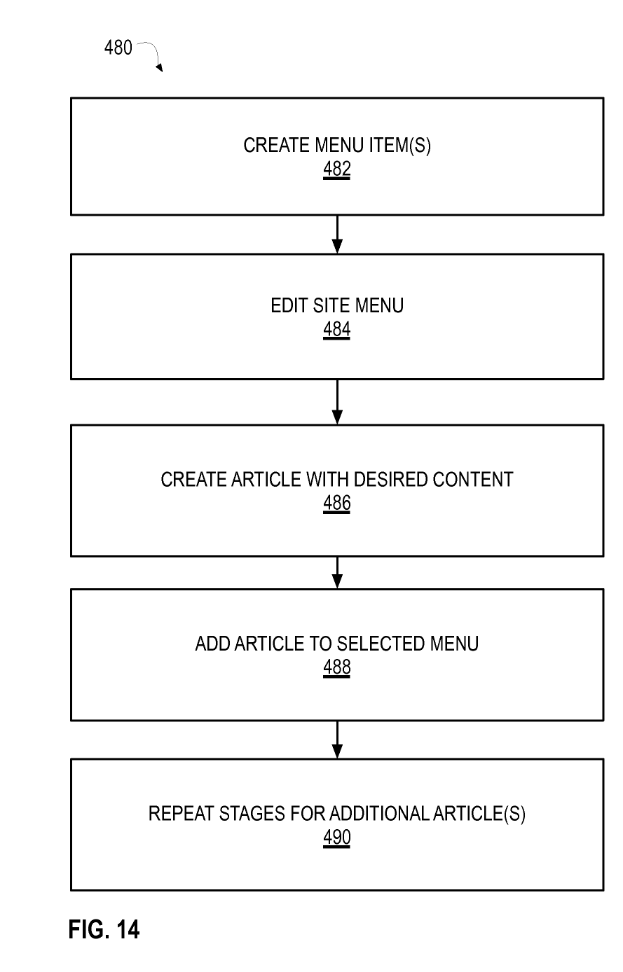

FIG. 14 is a process flow diagram 480 for one implementation illustrating the stages involved in creating and modifying articles that will be displayed on selected web pages. Menu items are created to specify the various items that will appear on a navigation menu on a web site (stage 482). The site menu can be edited to change the order and other details for how the web pages are organized and accessed by visitors (stage 484). An article can be created with the desired content (stage 486), and can then be added to a selected menu (stage 488). Some or all of these stages can be repeated for additional articles (stage 490).

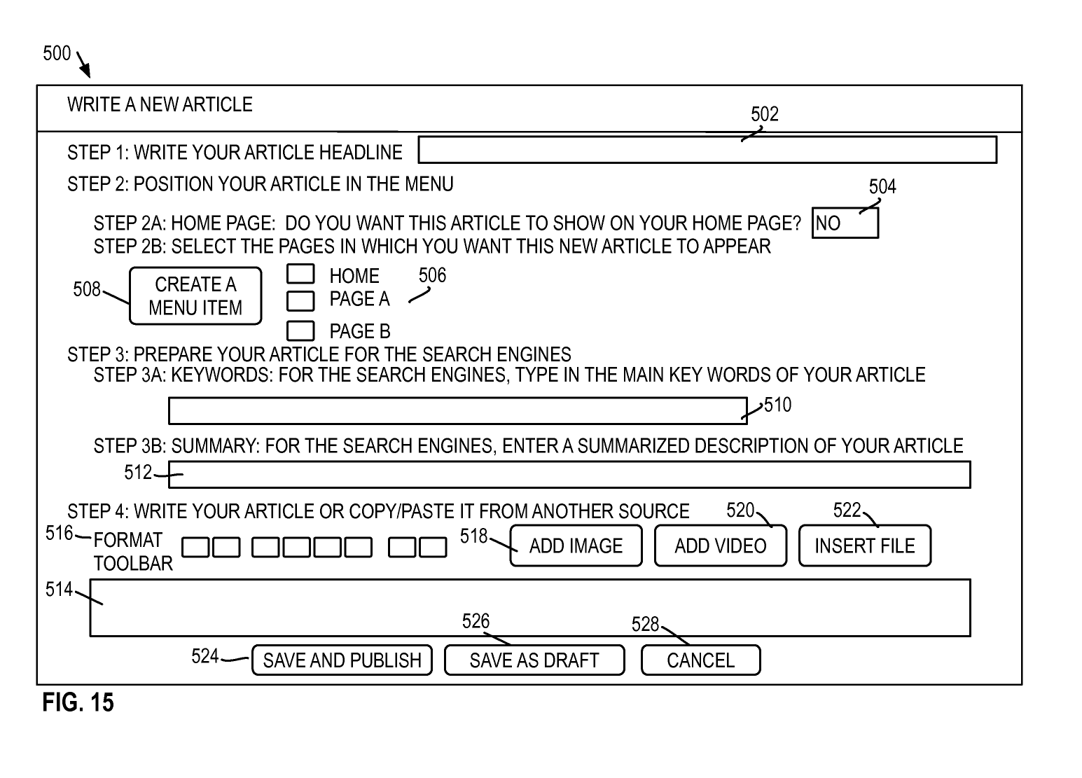

FIG. 15 is a simulated screen 500 for one implementation that illustrates creating a new article. Various details about the article can be specified, such as article headline 502, whether to show this article on the home page 504, pages in which the article should appear 506, key words for the article 510, summary for the article 512, article contents 514. The format toolbar 516 can be used to customize the article, and the options for add image 518, add video 520, and insert file 522 can be used. In the example shown, the article can be saved and published 524, saved as a draft 526, and canceled 528. In one implementation, when the article is saved and published, it becomes part of a web page with zero or more other articles, based upon the menu settings and/or other articles that have been assigned to the same menu (such as those described in FIGS. 17-20).

FIG. 16 is a simulated screen 540 for one implementation that illustrates modifying an existing article. A new article option can be selected 542 to create a new article. A list of current articles is displayed, with details such as article name 544, menu 546, status 548, date/time 550, and action that can be performed on the article 552. Details and/or contents of existing articles can be modified.

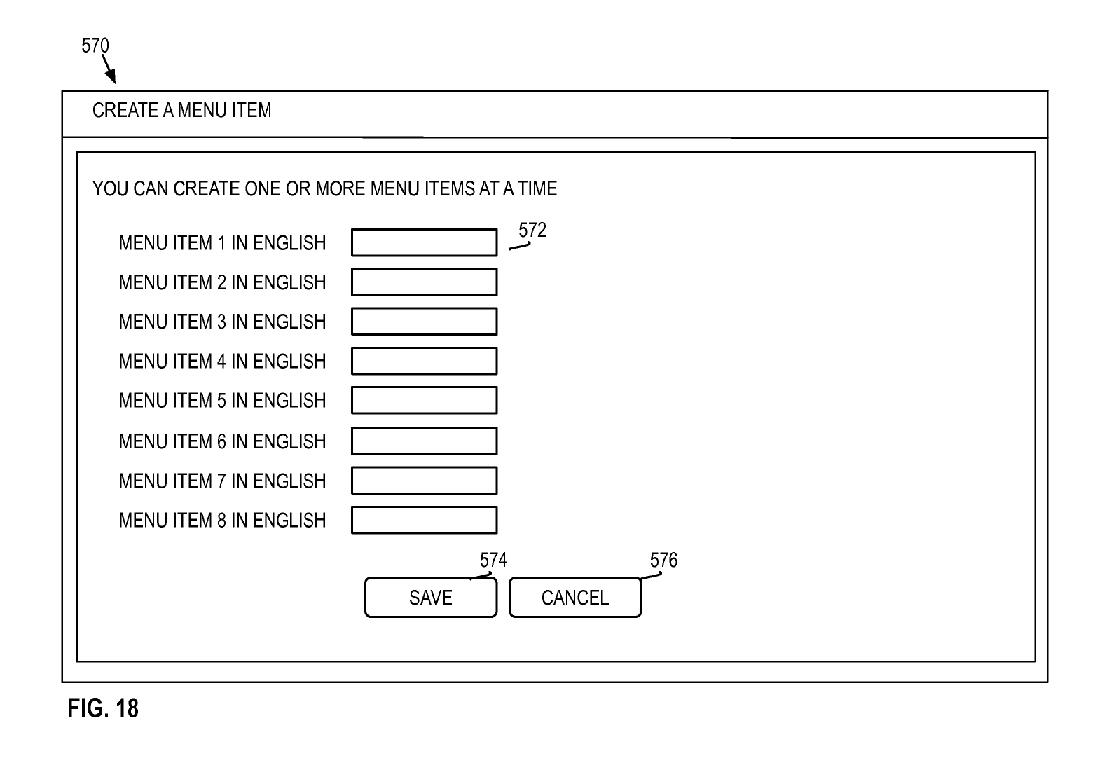

FIG. 17 is a process flow diagram 560 for one implementation illustrating the stages involved in managing the navigation menu for a web site. Menu items are created (stage 562), and sub-menu item(s) can be added under existing menu items, as desired (stage 564). The changes can be saved to the menu structure (stage 566), and the changes are reflected on the web site (stage 568). FIGS. 18-20 illustrate some exemplary screens that can be used to create and/or manage menu items and sub-menu items.

FIG. 18 is a simulated screen 570 for one implementation that illustrates creating a menu item. Menu items can be specified 572, and saved 574 and/or canceled 576.

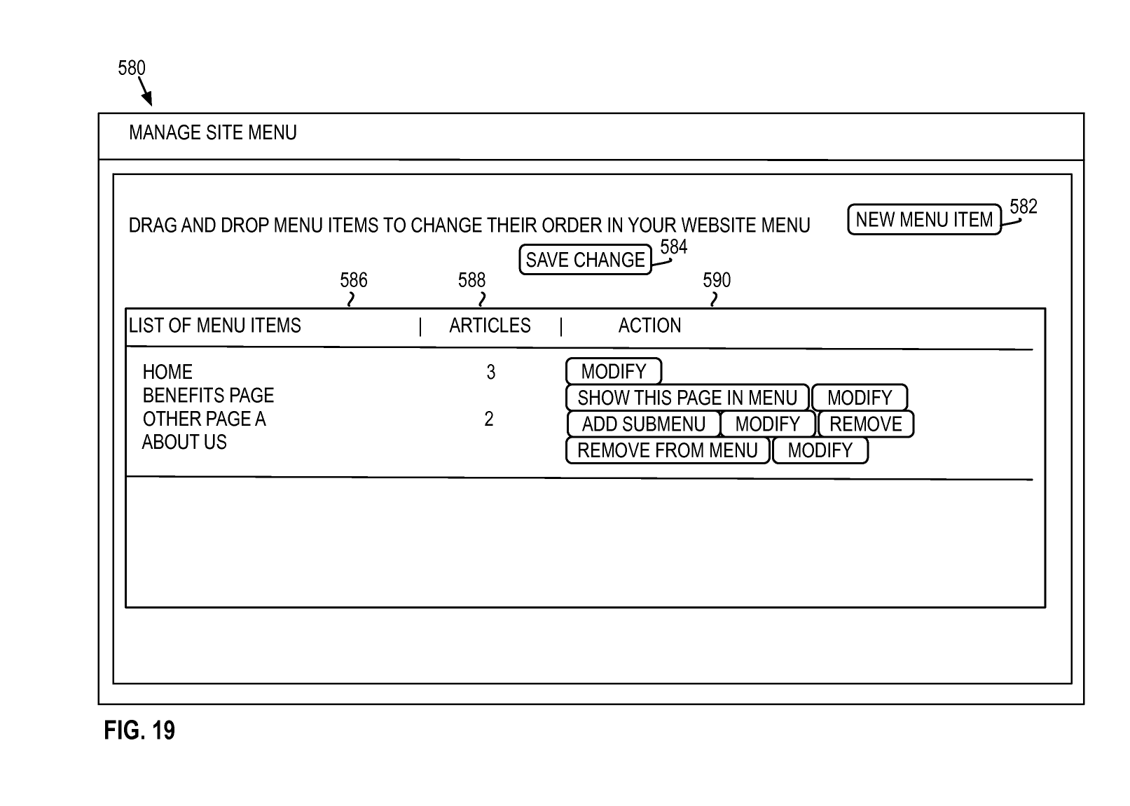

FIG. 19 is a simulated screen 580 for one implementation that illustrates managing the site menu. A new menu item can be added 582. A list of current menu items is displayed, with the name 586, number of associated articles 588, and actions that can be taken 590. The existing menu items can be edited as desired. Changes can be saved upon selecting save change 584.

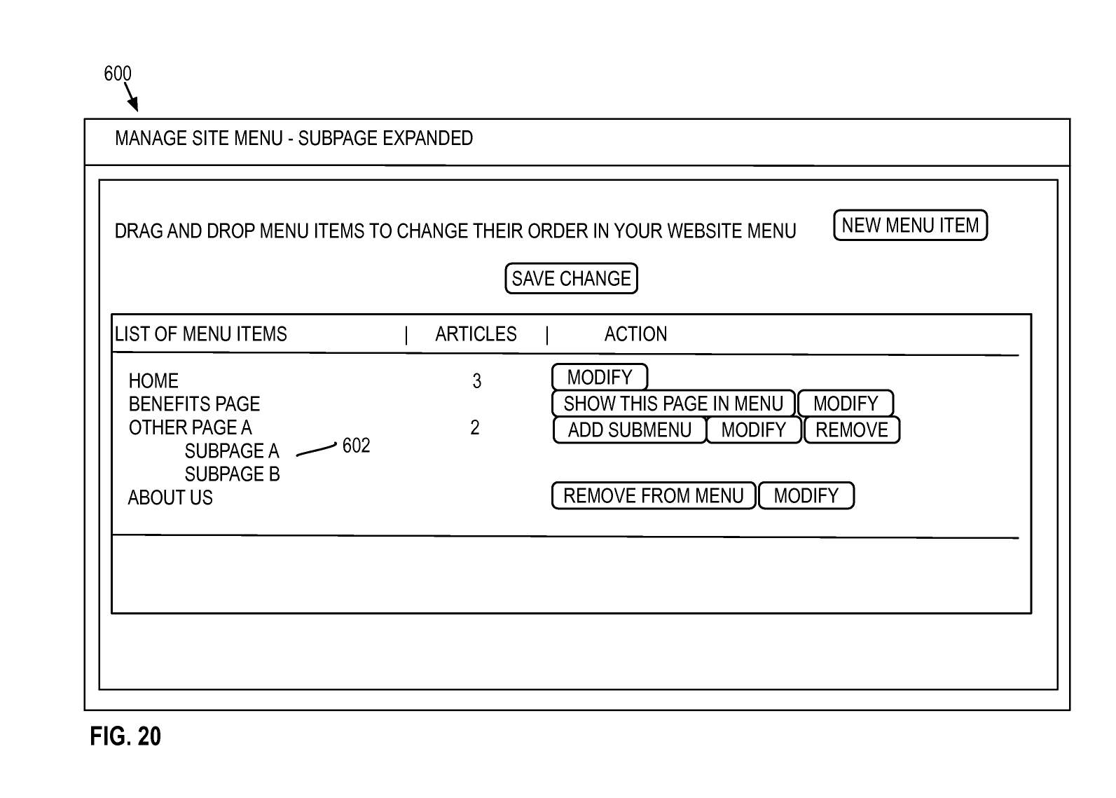

FIG. 20 is a simulated screen 600 for one implementation that illustrates creating and managing sub-pages 602 on the site menu. Sub-pages are those pages that will appear under the navigation for the parent page.

FIG. 21 is a process flow diagram 610 for one implementation that illustrates the stages involved in modifying the home top feature of a web site. The user can select a desired layout for the web site's home page (stage 612). A content input area is displayed for the selected layout (Stage 614). For example, if an intro box format is selected, then the content input area for an intro box is displayed. If a photo wall format is selected, then a photo wall input area is displayed. Input is received from the user to specify the content for the selected layout (stage 616). When creating the web pages for the web site, the home page is created with the selected home page style/format (stage 618).

FIG. 22 is a simulated screen 620 for one implementation that illustrates selecting a home top feature to specify the layout of the home page. A home top feature is simply used to specify how the home page will be laid out. A layout can be specified, such as for no box 622, an intro box 624, a photo wall 626, and then for the contents 628 depending on the selected layout.

FIG. 23 is a process flow diagram 640 for one implementation that illustrates the stages involved in creating and managing polls for a web site. A user selection is received to create a new poll (stage 642). The user inputs the poll details and/or question, which are received by the system (stage 644). Logic (such as HTML, JavaScript, or other code) is added to one or more web pages to present the poll questions to site visitors (stage 646). The results of the poll are tracked, and available for display to administrators of the web site upon request (stage 648).

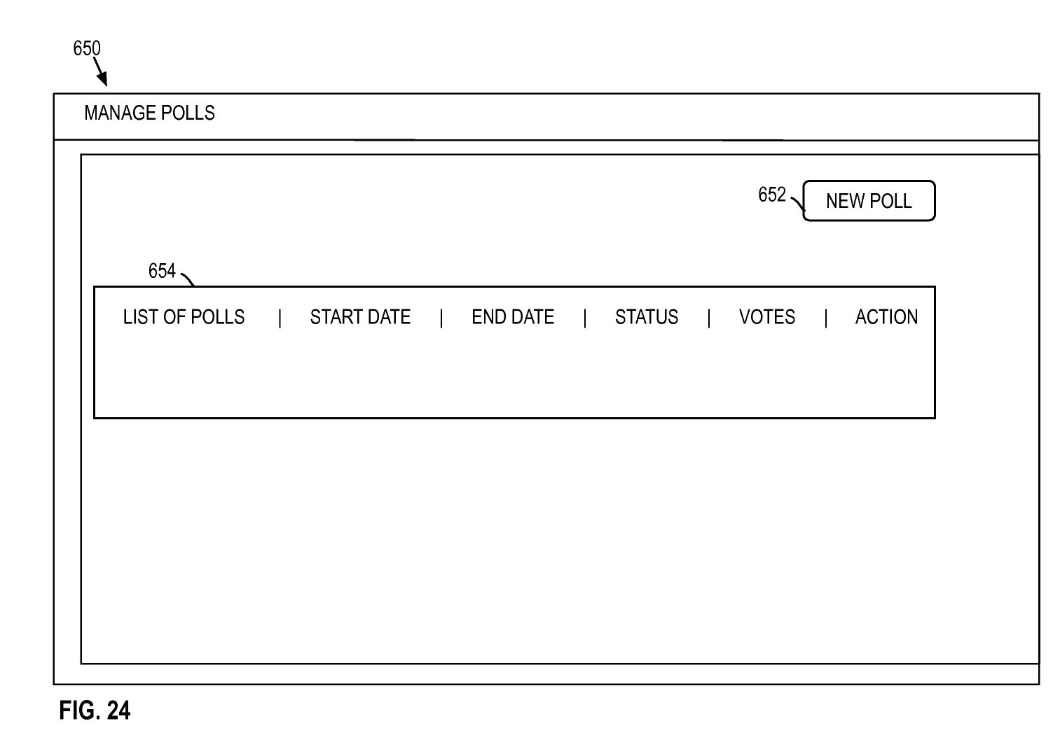

FIG. 24 is a simulated screen 650 for one implementation that illustrates managing polls for a web site. A new poll can be created upon selecting the new poll option 652. A list of current polls 654 is displayed, along with details about the results of the current polls.

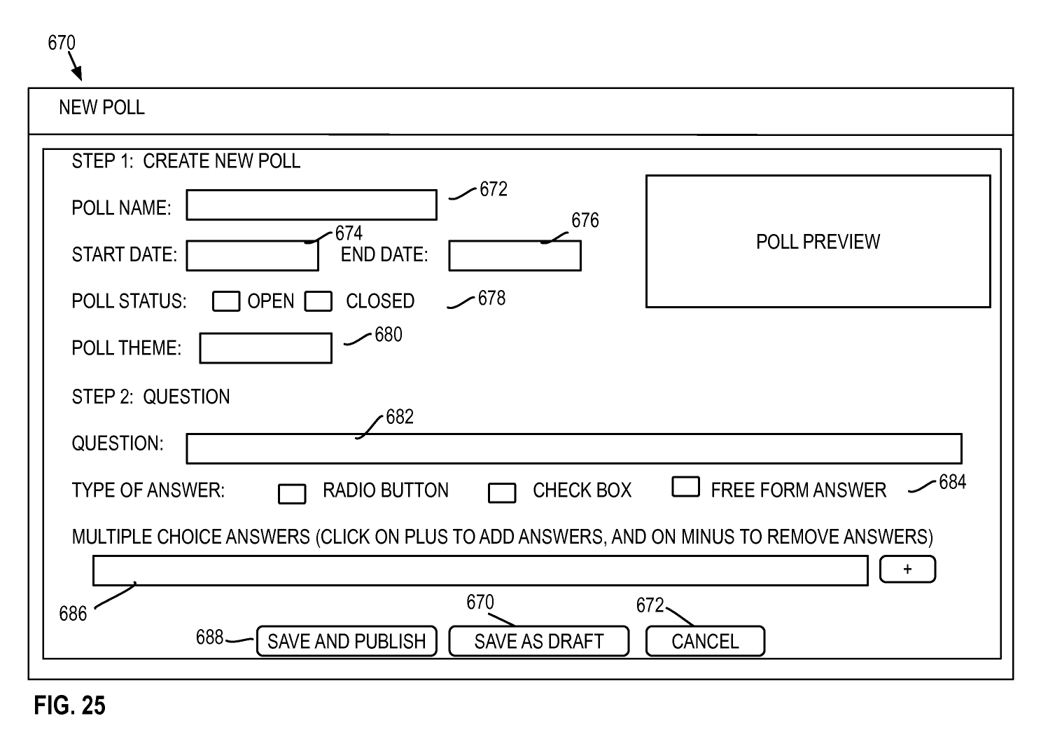

FIG. 25 is a simulated screen 670 for one implementation that illustrates creating a new poll for a web site. Various poll details can be specified, such as the poll name 672, start date 674, end date 676, poll status 678, theme 680. The question text 682 is specified, as well as the type of answer 684 and multiple-choice answers 686. In the example shown, the poll can be saved and published 688, saved as a draft 670, or cancelled 672.

FIG. 26 is a process flow diagram 680 for one implementation that illustrates the stages involved in creating and managing surveys for a web site. A selection is received from an administrative user to create a new survey that will be displayed on a web site (stage 682). The user inputs the survey details and/or questions, and the details and questions are received by the system (stage 684). Logic (such as HTML code, JavaScript, etc.) is added to one or more web pages to present the survey questions to visitors of the web site (stage 686). The results of the survey are tracked, and can be displayed to administrators upon request (stage 688).

FIG. 27 is a simulated screen 690 for one implementation that illustrates creating a survey for a web site. The survey question 692, answer 694, and video URL 696 can be specified. A button can also be created for the survey upon specifying the button text 698, font color 700, and button type 702. The survey can be saved and published 708 or saved as a draft 710.

FIG. 28 is a process flow diagram 730 for one implementation that illustrates the stages involved in creating a video overlay for a web site. The term “video overlay” as used herein is meant to include a video that is displayed/overlaid over the top of an existing web page. An option is selected by an administrator user to create and/or modify a video overlay presentation (stage 732). The user fills in the video selection and/or various other details about the video overlay (stage 734). A selection is received from the user to activate the video on a web site (stage 736). Logic (HTML, JavaScript, etc.) is added to one or more of the web pages to display the video overlay to visitors as the come to the web site (stage 738). The video is displayed in its own content area on top of the other page of the web site that launched the video overlay.

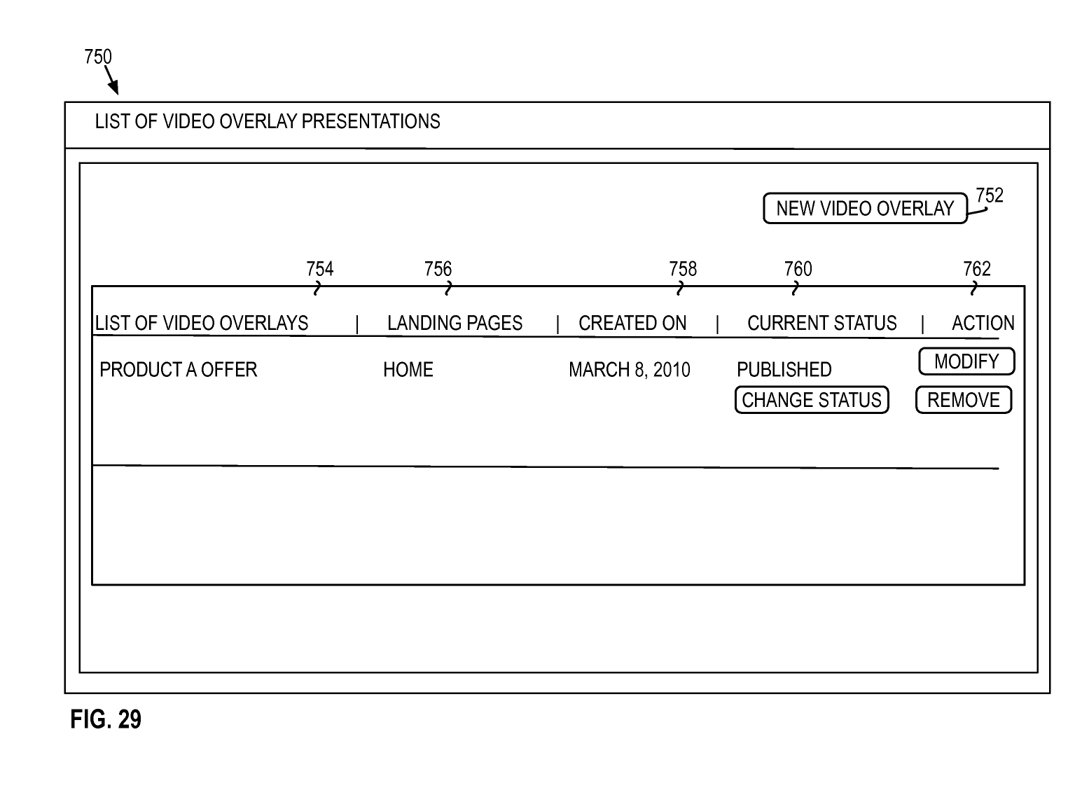

FIG. 29 is a simulated screen 750 for one implementation that illustrates a list of video overlay presentations. A new video overlay can be created upon selecting the new video overlay option 752. A list of existing video overlays is also displayed. The list includes details such as video overlay name 754, landing page the video overlay is associated with 756, create date 758, current status 760, and actions that can be performed 762 on the selected video overlay.

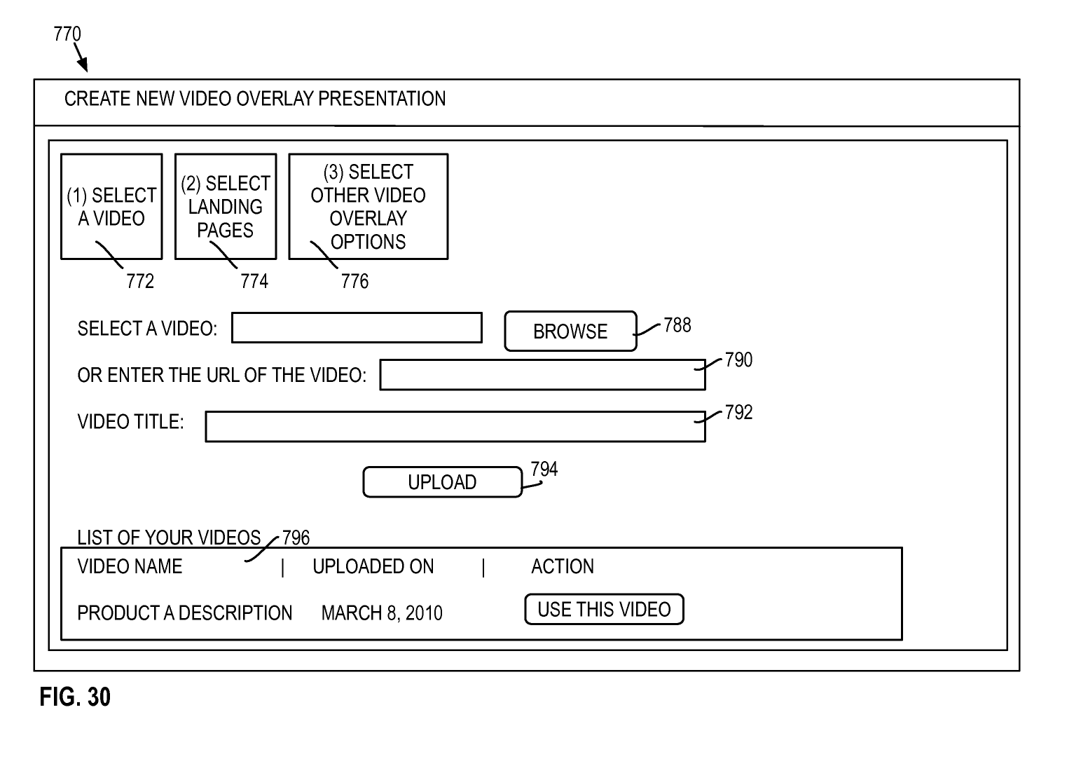

FIG. 30 is a simulated screen 770 for one implementation that illustrates creating a new video overlay presentation. Various details can be specified for a selected video 772 to create a video overlay. For example, an existing video can be selected 788 and uploaded to use with a video overlay. A video URL 790 and video title 792 can also be specified. Details about any uploaded videos are displayed 796. Once a video has been selected, one or more landing pages 774 that the video should be displayed over can be specified, and/or other video overlay options 776 can be specified. In one implementation, the video overlay can also be previewed to see how it will look on the web site.

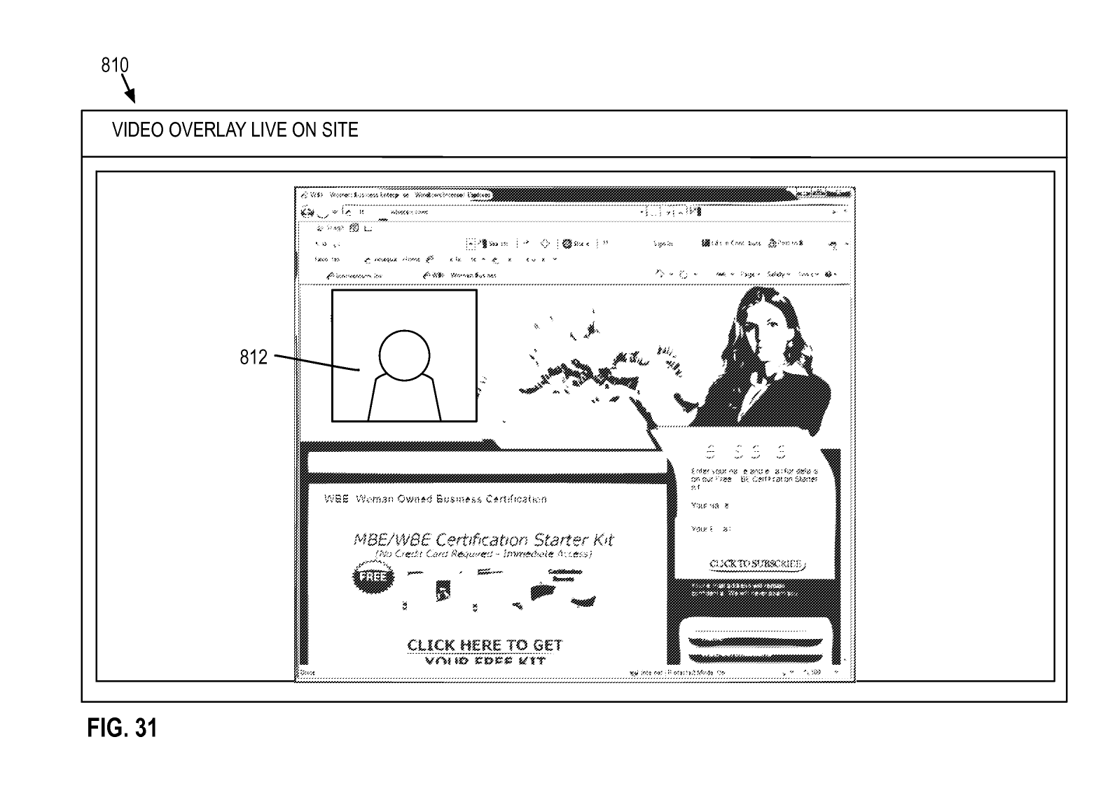

FIG. 31 is a simulated screen 810 for one implementation that illustrates a video overlay 812 being displayed on a live web site. The video is displayed over the top of the existing web site in its own window.

Turning now to FIG. 32, a simulated screen 820 for one implementation is shown that illustrates a navigation menu for the business pages module. The user can access a variety of modules from this navigation menu, such as to customize page contents for various pages that will appear on the web site, such as About Us 822, Terms and Conditions 824, Privacy Policy 826, Contact Us 828, Benefits Page 830, and Client Testimonials 832. Each of these will now be discussed in further detail.

FIG. 33 is a simulated screen 840 for one implementation that illustrates creating and modifying an About Us web page. The headline 842 can be specified, along with the contents of the page 846. The contents for the About Us page can be customized using the format toolbar 844, and saved using the save option 848. The About Us page can be used to specify information about the business or other person being represented on the web site.

FIG. 34 is a simulated screen 850 for one implementation that illustrates creating and modifying a Terms and Conditions web page. An option 854 can be selected to indicate whether to use a normal terms and conditions page (such as HTML), or whether to link to a separate file (such as PDF) 852. Other details can then be specified for the page, such as the contents of the page 860. The contents can be styled using format toolbar 858. In one implementation, the Terms and Conditions page can include details about what terms visitors who use the site are agreeing to be bound to by using the site.

FIG. 35 is a simulated screen 870 for one implementation that illustrates creating and modifying a Privacy Policy web page. A Privacy Policy web page can be used to specify the details about how data that is collected on the web site will be used. An option 874 can be selected to indicate whether to use a normal privacy policy page (such as HTML), or whether to link to a separate file (such as a PDF) 872. Other details can then be specified based upon the selected option.

FIG. 36 is a simulated screen 880 for one implementation that illustrates creating and modifying a Contact Us web page. The Contact Us page is used to give visitors a way to communicate with the web site owner (business, etc.). The headline can be specified 882, along with the email address to use for receiving client messages 884. The contents of the Contact Us page can also be specified 886. Custom fields for the contact form 888 can be edited. A contact preview 890 is also displayed to give a visual indicator for how the form will look.

FIG. 37 is a simulated screen 900 for one implementation that illustrates creating and modifying a Benefits web page. The benefits headline 902 and body content can be specified 906 and saved 908. The contents of the page can be customized using the format toolbar 904.

FIG. 38 is a process flow diagram 910 for one implementation that illustrates the stages involved in adding a testimonials feature to a web site to allow testimonials to be collected from visitors and/or customers. A selection is received from a user to create a new testimonial page that will be displayed on a web site (stage 912). The testimonial message and field options are entered by the user and received by the system (stage 914). One or more of the pages are updated for the web site to include the testimonials page and navigation for it (stage 916). Testimonials are then collected from visitors, and the testimonial data can later be displayed to an administrator (stage 918).

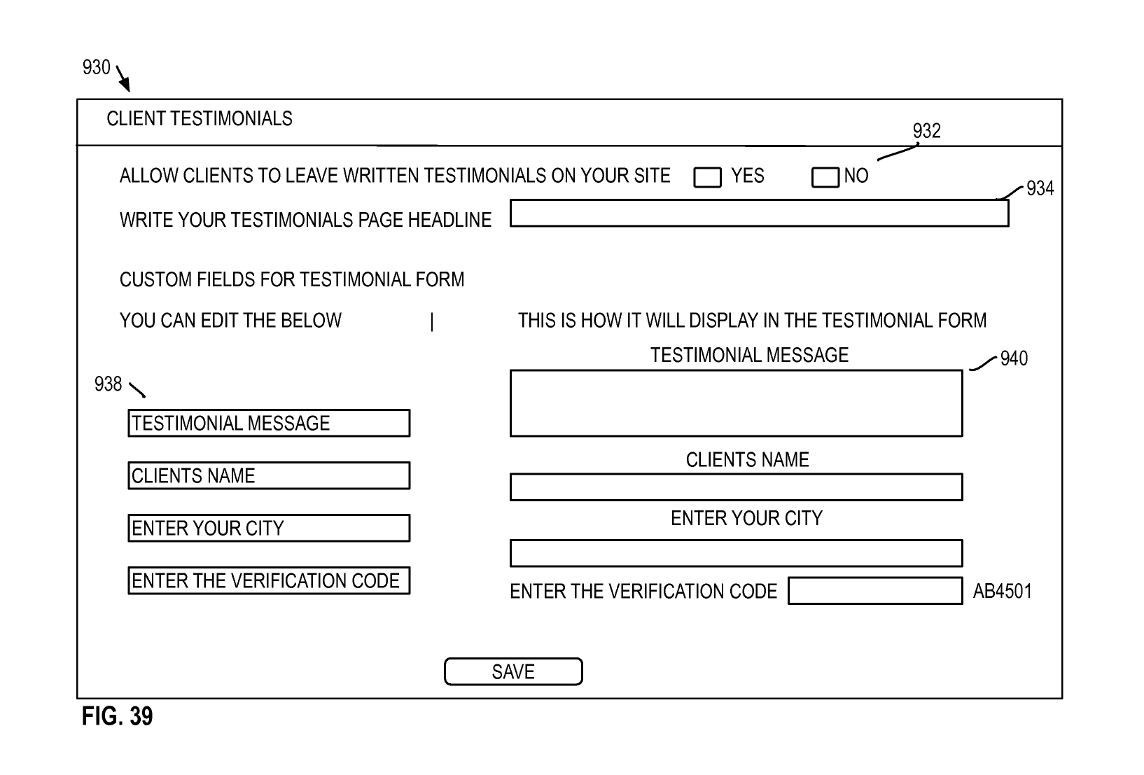

FIG. 39 is a simulated screen 930 for one implementation that illustrates specifying the settings for a testimonials page to be used on a web site. The user can customize how the testimonial message will be displayed to visitors of the site by changing the values, such as by selecting whether or not visitors can leave testimonials 932 and by changing the custom field values 938. A testimonial preview is displayed to show how the testimonial fields will look to visitors 940.

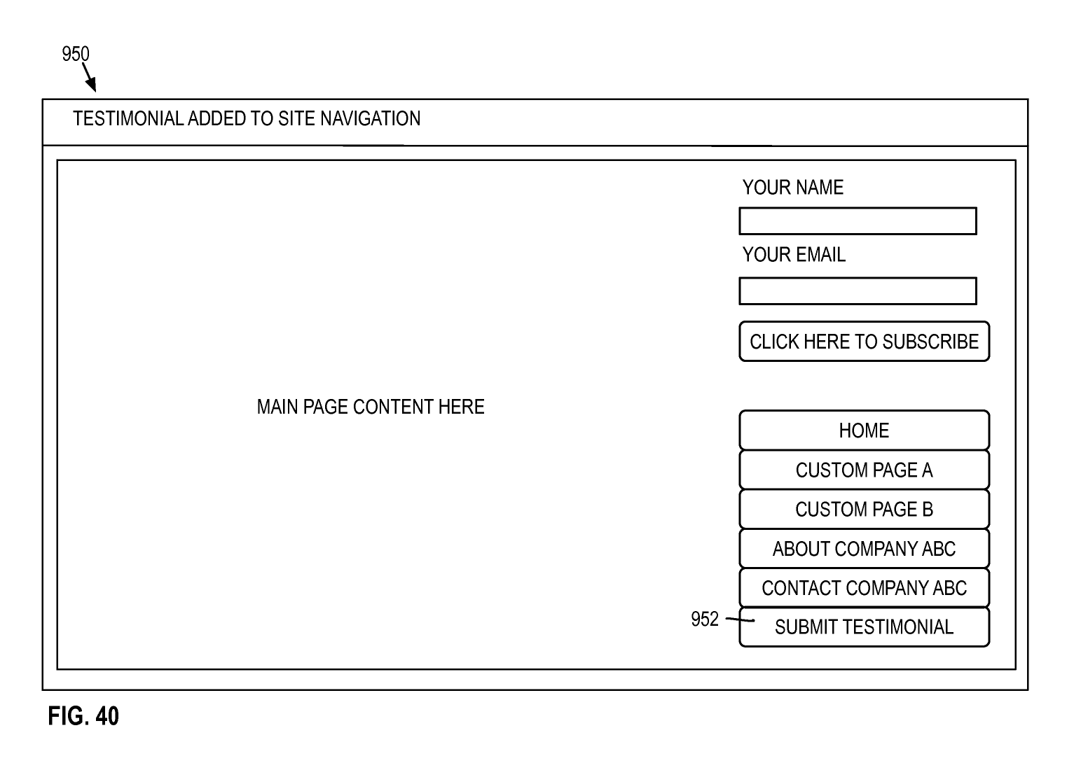

FIG. 40 is a simulated screen 950 for one implementation that illustrates the testimonials page being added to the site navigation 952 of the associated web site. In the example shown, “Testimonials” appeared as another navigation link that could be selected to access the testimonials page.

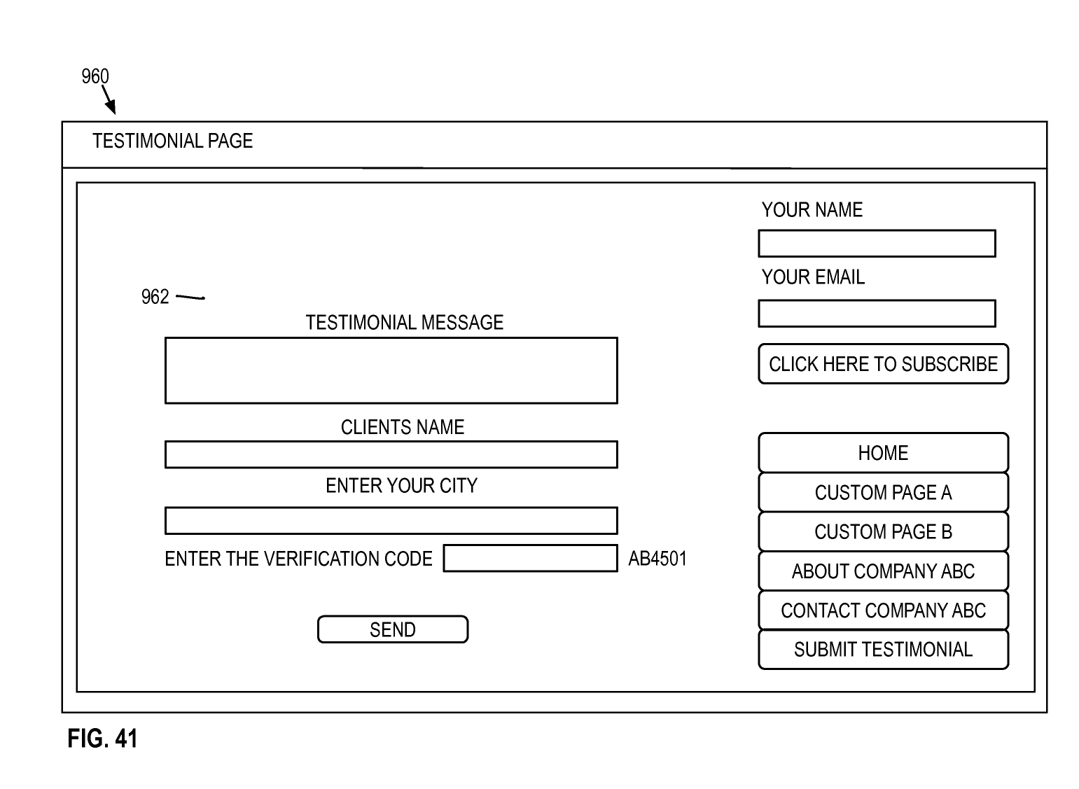

FIG. 41 is a simulated screen 960 for one implementation that illustrates a testimonial submission form that is live on a web site, such as from selecting site navigation 952 on FIG. 40. Visitors to the web site can enter the testimonial message 962, and the testimonial message 962 will be submitted and tracked by content management system 10 for later viewing by administrative users.

FIG. 42 is a process flow diagram 970 for one implementation that illustrates the stages involved in managing photos and photo albums for a web site. A selection is received from a user to create a new photo album (stage 972). The user selects options to add and/or remove photos from the selected album (stage 974). The photo album is stored in a data store (stage 976). The photo album(s) is/are made available from other areas of the content management system (stage 978), such as for insertion into articles, business pages, and/or other content areas for the web site.

FIG. 43 is a simulated screen 980 for one implementation that illustrates creating and managing a photo album. The album name 982 and description 984 are provided. Upon selecting the create album option 986, the album is created and displayed 988.

FIG. 44 is a process flow diagram 990 for one implementation that illustrates the stages involved in managing videos that are available for use a web site. A selection is received from a user to upload a video (stage 992). The user adds and/or removes videos (stage 994). The video data is stored in a data store (996). The video(s) is/are made available to other areas of the content management system (stage 998), such as for insertion into articles, business pages, and/or other content areas for the web site.

FIG. 45 is a simulated screen 1000 for one implementation that illustrates uploading and managing videos that are available for use with a web site. The video title 1010 and video file 1012 can be specified and uploaded 1014 into the video library that is integrated within content management system 10. The list of videos that have been uploaded are also displayed 1016.

FIG. 46 is a process flow diagram 1030 for one implementation that illustrates the stages involved in interacting with third party video sites. Login credentials can be specified for third party video site(s) (stage 1032). An option is selected to upload the video(s) to the third party video site(s) (stage 1034). The videos that have been uploaded to the third party video sites are made tracked and made available to other parts of the content management system (stage 1036), such as for insertion into articles, business pages, and/or other content areas for the web site.

FIG. 47 is a simulated screen 1050 for one implementation that illustrates uploading videos to a third party video site. The user name 1052 and password 1054 for the video site can be specified. Then, the user can select a video to upload to the selected video site by selecting the browse button 1056, choosing a video, and providing the title 1058 and description information 1060 and selecting upload 1062. A list of the videos 1064 that were submitted to the third party site that are being tracked by the content management system 10 are also displayed.

FIG. 48 is a process flow diagram 1080 for one implementation that illustrates the stages involved in managing products for a web site. Products can be created and/or edited by users (stage 1082). Product options such as shipping, tax, payments, etc. can be edited (stage 1084). One or more pages are updated for the web site to include the product page(s) (stage 1086). The products are stored in a data store for later editing (stage 1088).

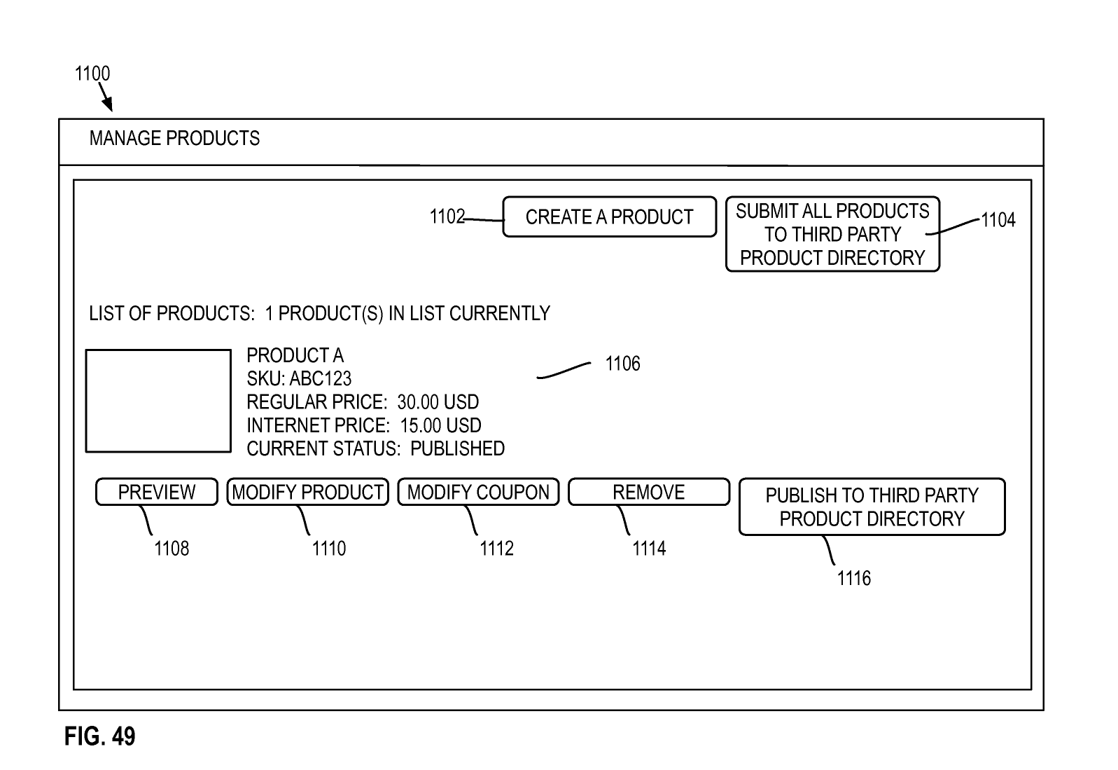

FIG. 49 is a simulated screen 1100 for one implementation that illustrates viewing and managing products that can be sold from a web site. An option is provided to create a new product 1102, as well as to submit all products to a third party product directory 1104 (such as Google Products). Product details 1106 are also displayed, and various actions can be performed on a selected product, such as preview 1108, modify product 1110, modify coupon associated with the product 1112, remove product 1114, and publish the selected product to a third party product directory 1116.

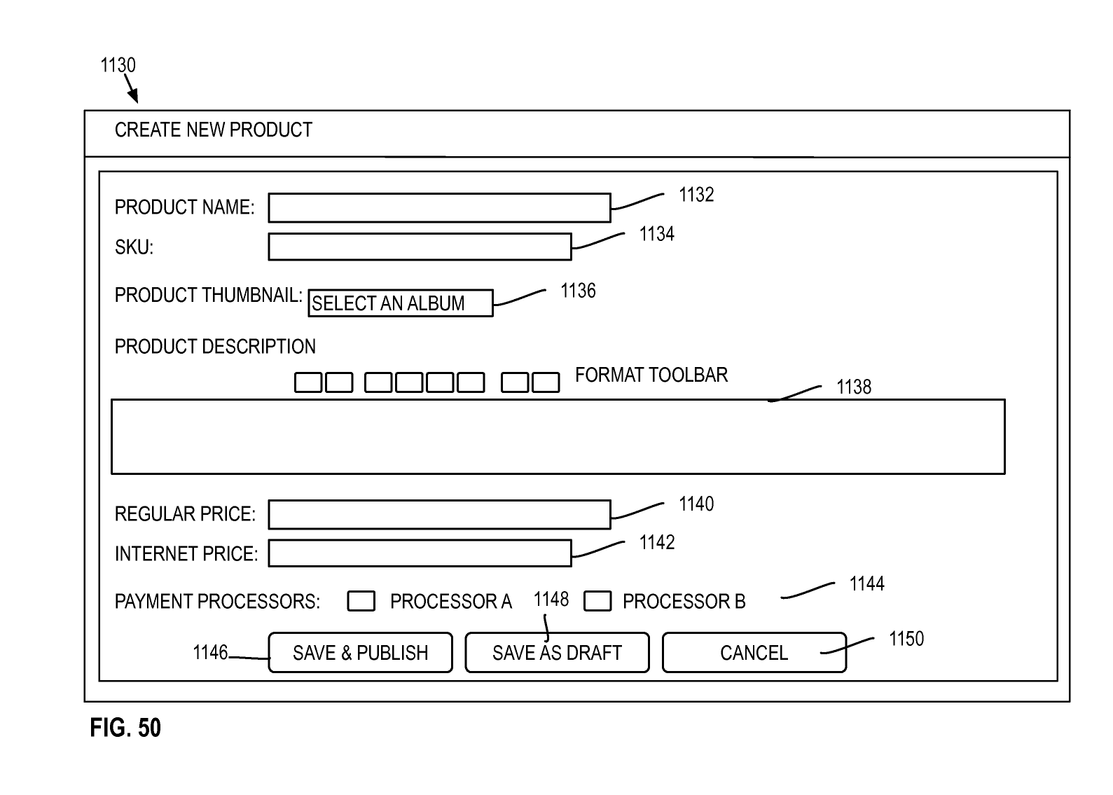

FIG. 50 is a simulated screen 1130 for one implementation that illustrates creating a new product. Various product details can be specified, such as product name 1132, SKU 1134, product thumbnail 1136, product description 1138, regular price 1140, internet price 1142, and payment processor(s) to use 1144. In one implementation, the product can then be saved and published 1146, saved as a draft 1148, or canceled 1150.

FIG. 51 is a simulated screen 1160 for one implementation that illustrates setting product pricing options. A regular price 1162 and an internet price 1164 can be specified and saved 1166.

FIG. 52 is a simulated screen 1180 for one implementation that illustrates managing orders. Order details 1182 are displayed. The order details 1182 can be reviewed and/or used for such purposes as obtaining the needed information to ship the product to the customer.

FIG. 53 is a process flow diagram 1200 for one implementation that illustrates the stages involved in adding a coupon generator to a web site. A selection is received from a user to create and/or modify a coupon to be displayed on a web site (stage 1202). The coupon details are entered by the user and received by the system (stage 1204), such as the amount of discount to be offered, and/or other promotion details. A downloadable coupon is optionally generated based upon the specified details (stage 1206). One or more pages of the web site are updated to include the coupon(s) (stage 1208).

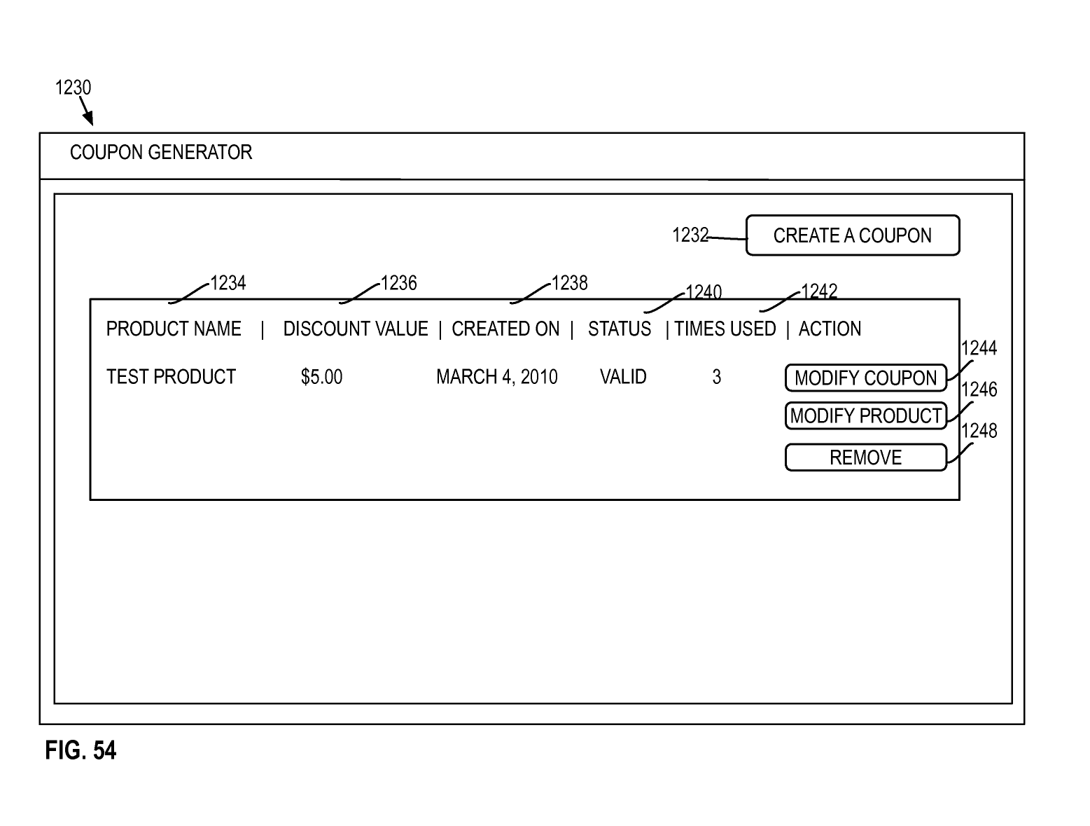

FIG. 54 is a simulated screen 1230 for one implementation that illustrates managing coupons produced by a coupon generator. The product that the coupon applies to 1234 is shown, along with any discount value 1236, the coupon creation date 1238, the status of the coupon 1240, and the number of times that coupon has been used by visitors 1242. Options are also available to create a new coupon 1232, modify a selected coupon 1244, modify the product 1256, and remove the coupon 1248.

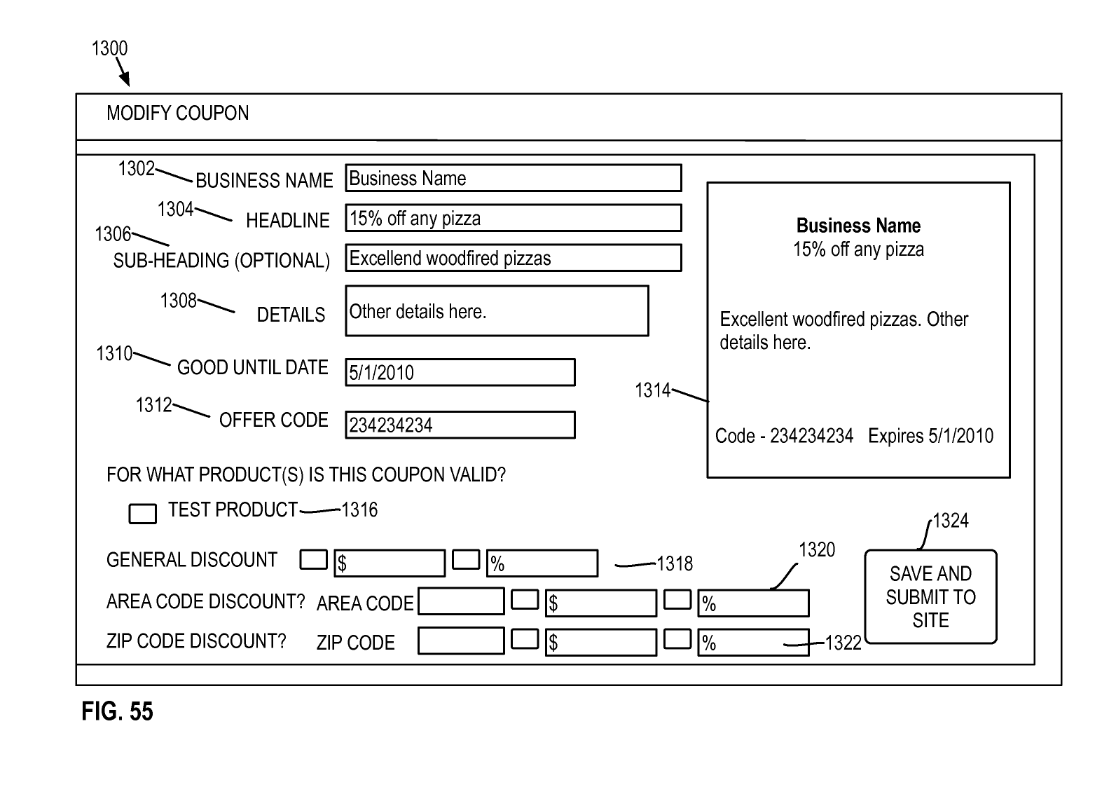

FIG. 55 is a simulated screen 1300 for one implementation that illustrates modifying a selected coupon. Coupon details such as business name 1302, headline 1304, sub-heading 1306, coupon details 1308, coupon valid until date 1310, and offer code 1312 can be specified. The product or product(s) that this coupon is/are associated with 1316 can also be selected. A coupon preview 1314 is displayed to visually indicate how the coupon looks with the entered information.

Discounts can also be specified for the coupon, such as a general discount 1318, an area code discount 1320, and/or a zip code discount 1322 to allow visitors in certain areas to get other coupon incentives. Upon selecting the save and submit to site option 1324, the coupon is generated and made available to visitors of the web site.

FIG. 56 is a simulated screen 1400 for one implementation that illustrates managing shipping options for the products. Details such as shipping method 1402, shipping rate 1404, delivery speed 1406 can be specified. Modify and/or remove actions 1408 can also be performed on a selected shipping method.

FIG. 57 is a simulated screen 1440 for one implementation that illustrates managing tax options 1442 for the products, such as the sales tax that needs to be collected from the sale.

FIG. 58 is a simulated screen 1480 for one implementation that illustrates setting up payment processor details to be used for collecting payments for the products. Merchant account settings 1482 can be specified (such as for Authorize.NET merchant accounts). Other payment processors can alternatively or additional be specified (1484 and/or 1486), such as Google Products and/or Paypal.

FIG. 59 is a process flow diagram 1500 for one implementation that illustrates the stages involved in collecting and managing site information to help the web site rank higher in one or more search engines. Information is received from the user to describe the site (stage 1502). The information is saved in the data store and included in the proper tags (header tags, etc.) in the web pages (stage 1504). The information is submitted to the search engines and/or is otherwise made available to the search engines upon reading the page, thereby assisting with search engine appearance and/or rankings (stage 1506).

FIG. 60 is a simulated screen 1520 for one implementation that illustrates specifying certain web site details that will be submitted to and/or read by the search engines. For example, the copyright owner 1522 can be specified, along with a short description 1524, longer description 1526, and key words 1528.

FIG. 61 is a process flow diagram 1550 for one implementation that illustrates the stages involved in submitting details about a web site to a search engine maps feature. Business location information is entered by a user and received by the system (stage 1552). The business location information is submitted to one or more search engines (stage 1554), such as Google Maps. In one implementation, once the business appears on the search engine map, that map appearing on the search engine is linked to and used on the web site so visitors can easily locate the business (stage 1556).

FIG. 62 is a simulated screen 1580 for one implementation that illustrates completing various details that can be submitted to a search engine maps feature. Details such as headline 1582, company name 1584, address 1586, city 1588, and state 1590 can be specified. Upon clicking the search option 1592, the company's current record can be accessed on one or more search engines to see if it needs updated with more recent information, and/or created for the first time.

FIG. 63 is a process flow diagram 1600 for one implementation that illustrates the stages involved in creating a search engine local business listing, such as those that appear in search results when someone types a geographic-specific search (city, state, etc.) into a search engine. Company local listing information is entered by a user and received by the system (stage 1602). A request is received from the user to submit the local listing to one or more search engines (stage 1604). The local listing information is submitted to the selected search engine (such as programmatically or manually), along with any payment, if required (stage 1606).

FIG. 64 is a simulated screen 1620 for one implementation that illustrates submitting local business details 1622 about a web site to a search engine local business listing (such as Google Local). Local business details can be submitted upon selecting the submit to search engine option 1624.

FIG. 65 is a process flow diagram 1640 for one implementation that illustrates the stages involved in setting up details for interactions with third party social media sites. Login details can be specified for third party social media sites, and the details are received by the system (stage 1642). A selection is made by the user to indicate what social media sites to display data from and/or which social media sites to send data to (stage 1644). The web site and/or administration module then interact with the social media sites as specified in the settings (stage 1646).

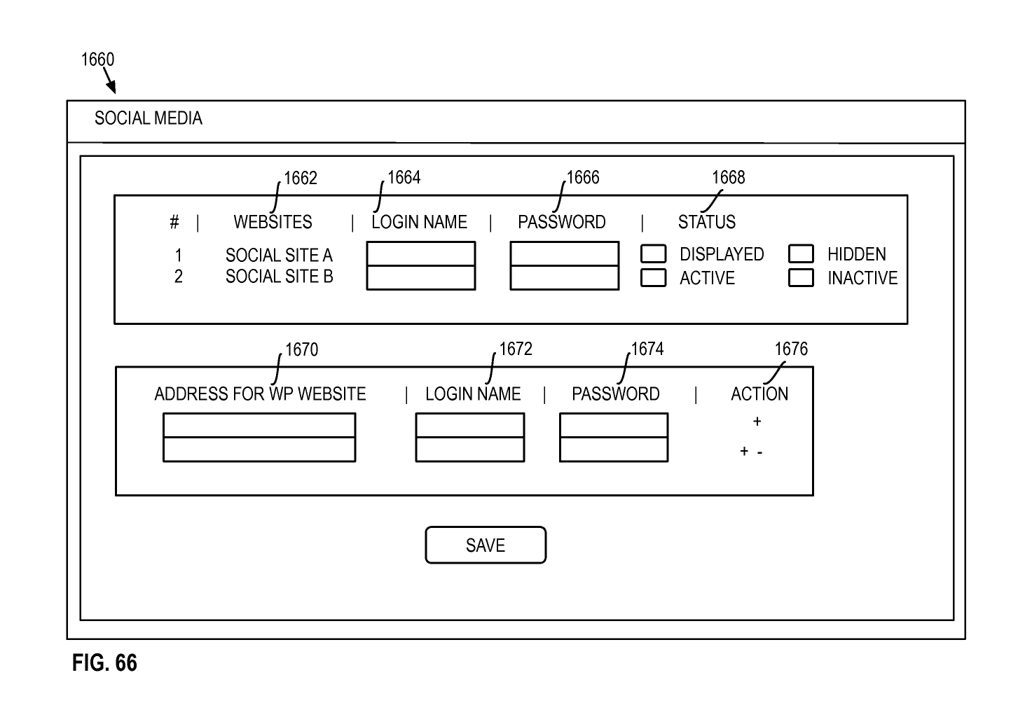

FIG. 66 is a simulated screen 1660 for one implementation that illustrates specifying social media login details and other options that are used to interact with the respective social media sites. For example, user names and passwords 1664 and 1666 can be specified for certain social media web sites 1662, as well as a status 1668 that specifies how and/or whether or not to use that service. Details can also be specified for another web site (such as a WordPress blog) that content should be posted to automatically as it is posted to the current web site. The address 1670, login name 1672, password 1676 can be specified for the other site(s) to use for cross-posting content. Add and remove actions 1676 can be specified for those sites too.

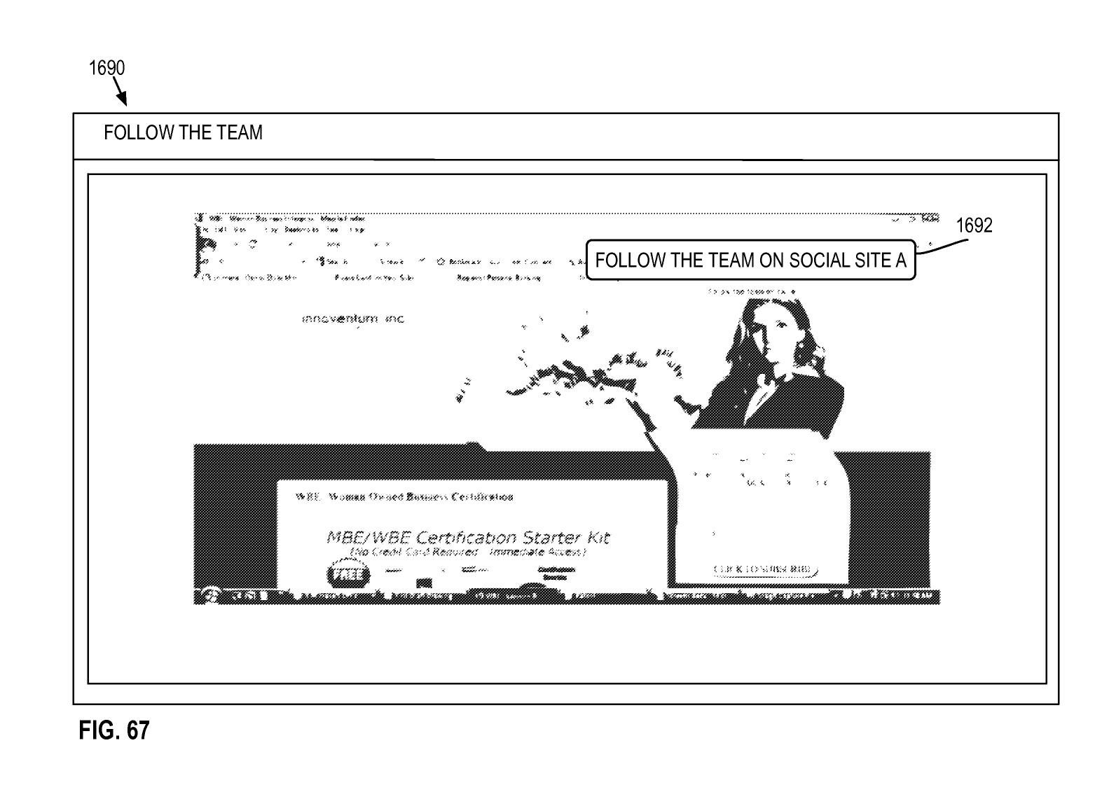

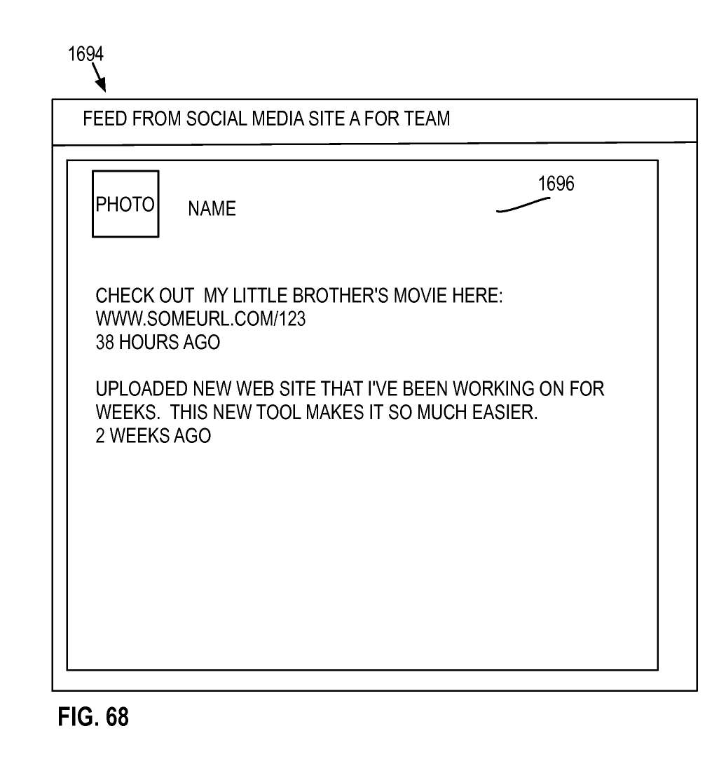

FIG. 67 is a simulated screen 1690 for one implementation that illustrates displaying a social media interaction feature 1692 on a web site. In the example shown, when the social media interaction feature 1692 is selected, details for the company/person are then retrieved from the selected social media site and displayed on the current web site. An example of this is shown in FIG. 68.

FIG. 68 is a simulated screen 1694 for one implementation that illustrates viewing a news feed 1696 from the social media site (such as Twitter) directly from within a web site.

FIG. 69 is a simulated screen 1700 for one implementation that illustrates customizing settings for a live chat custom message. Chat window details 1702 for what visitors to the web site will see when launching the chat can be customized. A chat window preview 1704 is shown for what the chat window will look like.

FIG. 70 is a simulated screen 1710 for one implementation that illustrates viewing live chat offline messages 1712. The live chat offline messages feature allows a user to see a record of the chat messages that were submitted when the support representative(s) were not online.

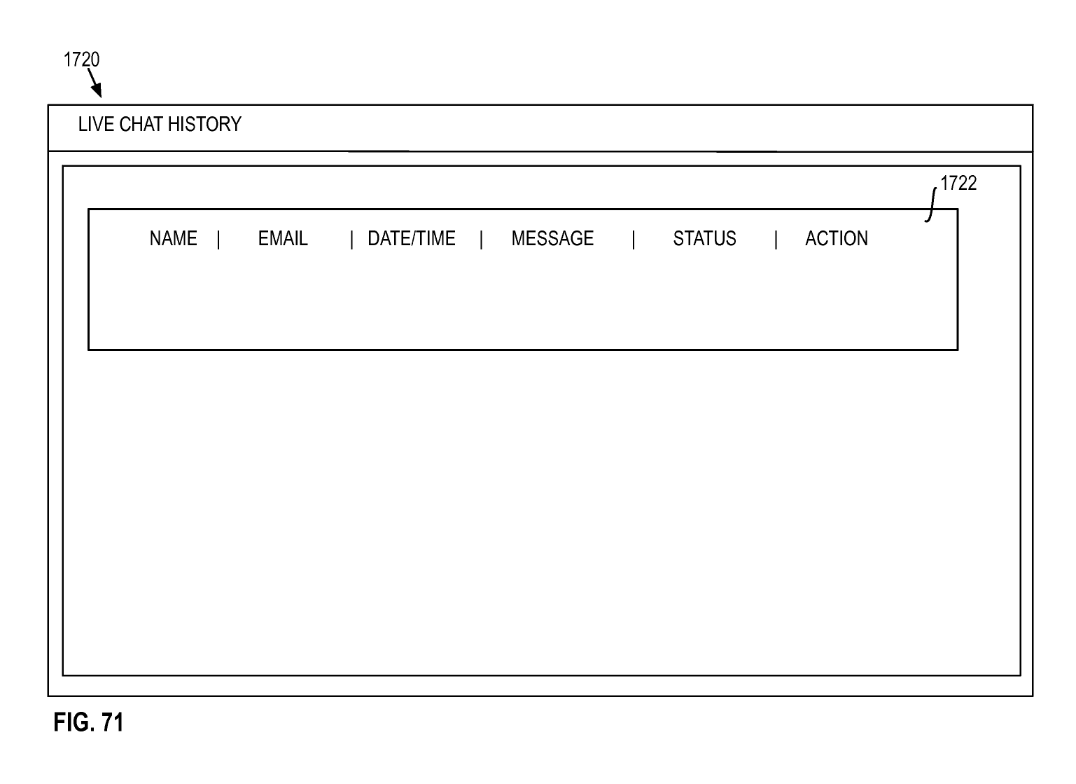

FIG. 71 is a simulated screen 1720 for one implementation that illustrates viewing a live chat history 1722. The live chat history allows a user to see a record of the chat interactions that took place from the web site.

FIG. 72 is a process flow diagram 1730 for one implementation that illustrates the stages involved in customizing an opt-in box that appears on a web site. Opt-in box customization settings are entered by a user and received by the system (stage 1732). Autoresponder settings are received from the user to specify what autoresponder to use to send messages to those who opt-in on the web site (stage 1734). One or more of the web pages are regenerated and republished with the opt-in box customizations that are made (stage 1736).

FIG. 73 is a simulated screen 1750 for one implementation that illustrates modifying opt-in box settings for a web site. Details that can be customized for the opt-in box are displayed 1752 for customization by the user. A preview is also shown of a sample opt-in box 1754.

FIG. 74 is a process flow diagram 1770 for one implementation that illustrates the stages involved in modifying autoresponder settings for a web site. The current autoresponder settings are displayed (stage 1772). The user enters a selection of whether to use a built-in autoresponder or to use a third party autoresponder (stage 1774). The third party autoresponder details are entered and received, when applicable (stage 1776).

FIG. 75 is a simulated screen 1790 for one implementation that illustrates creating an autoresponder message that gets sent to subscribers who opt-in from a web site through its opt-in box. Various message details 1792 can be specified for the follow-up email message that gets sent to someone once they opt-in to receive information.

FIG. 76 is a simulated screen 1800 for one implementation that illustrates viewing and managing the email addresses of those who have opted in from a web site through its opt-in box. Various details are tracked for the person who opted-in, including the identifier 1804, name 1806, IP address 1808, email address 1810, opt-in date 1812. The actions 1814 that can be performed on the selected subscriber are also displayed. The subscriber list can be exported to a spreadsheet upon selecting export to spreadsheet option 1802. In other implementations, the subscriber list can be exported to other formats.

FIG. 77 is a simulated screen 1820 for one implementation that illustrates creating a bulk email message to be sent to subscribers. Various details about the bulk email can be specified 1822 (such as sender name, subject message, etc.). Upon selecting the send emails to subscribers option 1824, a separate screen is then displayed to allow the subscribers to be selected who should receive the message.

FIG. 78 is a simulated screen 1830 for one implementation that illustrates sending the bulk email message to selected subscribers. The desired recipients 1834 of the bulk email message can be selected, and then sent upon selecting the next option 1832.

FIG. 79 is a process flow diagram 1840 for one implementation that illustrates the stages involved in viewing and modifying user permission settings. Changes are made to users and/or user permissions, and the changes are received by the system (stage 1842). The changes are saved (stage 1844), and only authorized users are allowed to access the administration module according to the specified permissions (stage 1846).

FIG. 80 is a simulated screen 1850 for one implementation that illustrates viewing and modifying the permissions of the web site contributors. The permission details 1856 are displayed for existing users. New users can be added upon selecting the add contributor option 1852, and existing users can be removed upon selecting the remove contributor option 1854.

FIG. 81 is a simulated screen 1860 for one implementation that illustrates changing the password that is used to access the administration features of a web site. The new password 1862 can be entered and saved.

FIG. 82 is a simulated screen 1870 for one implementation that illustrates storing various login details for later reference and/or use by the content management system. Login details for internal accounts 1872 can be specified, along with social network services accounts 1874.

FIG. 83 is a simulated screen 1880 for one implementation that illustrates creating a new emailbox. Various details about the new email account 1882 can be specified, and then created upon selecting the create emailbox option 1884. Existing emailboxes can be managed upon selecting the manage emailboxes option 1886. Once created, email can be sent to and from the specified mailbox through another email client, and/or from within the content management system 10.

FIG. 84 is a simulated screen 1890 for one implementation that illustrates customizing details on how articles are displayed on a web site. The maximum number of articles 1892 that should be shown on a web page can be specified, along with the maximum number of articles that should be shown on the home page 1894.

FIG. 85 is a process flow diagram 1900 for one implementation that illustrates the stages involved in creating and using tracking sub-id's to track certain activities that take place on a web site. The user selects an option to generate a tracking sub-id for a particular web page or video overlay (stage 1902). The tracking sub-id is generated with a unique tracking URL (stage 1904). Clicks are tracked for that URL or video overlay for later display, so the performance of a particular campaign or activity can be assessed (stage 1906).

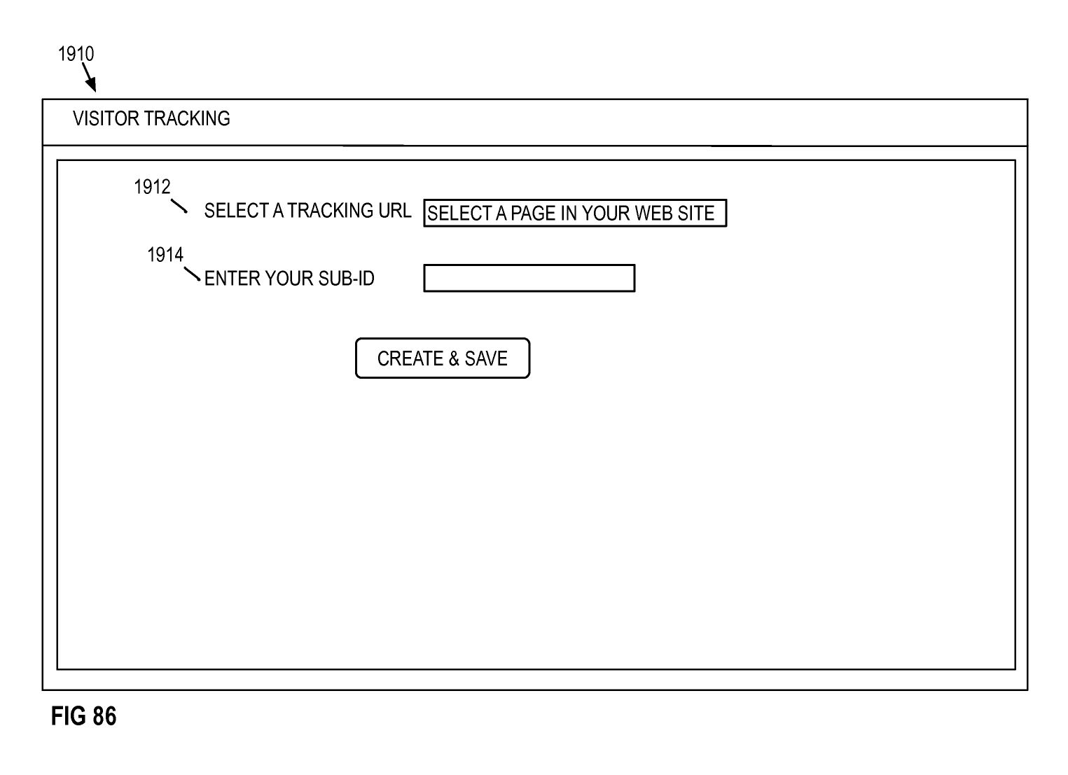

FIG. 86 is a simulated screen 1910 for one implementation that illustrates creating a new sub-id to be used for tracking different types of traffic that comes to the site. The user can select a tracking URL and/or overlay video for tracking 1912, and then give the sub-id a name 1914.

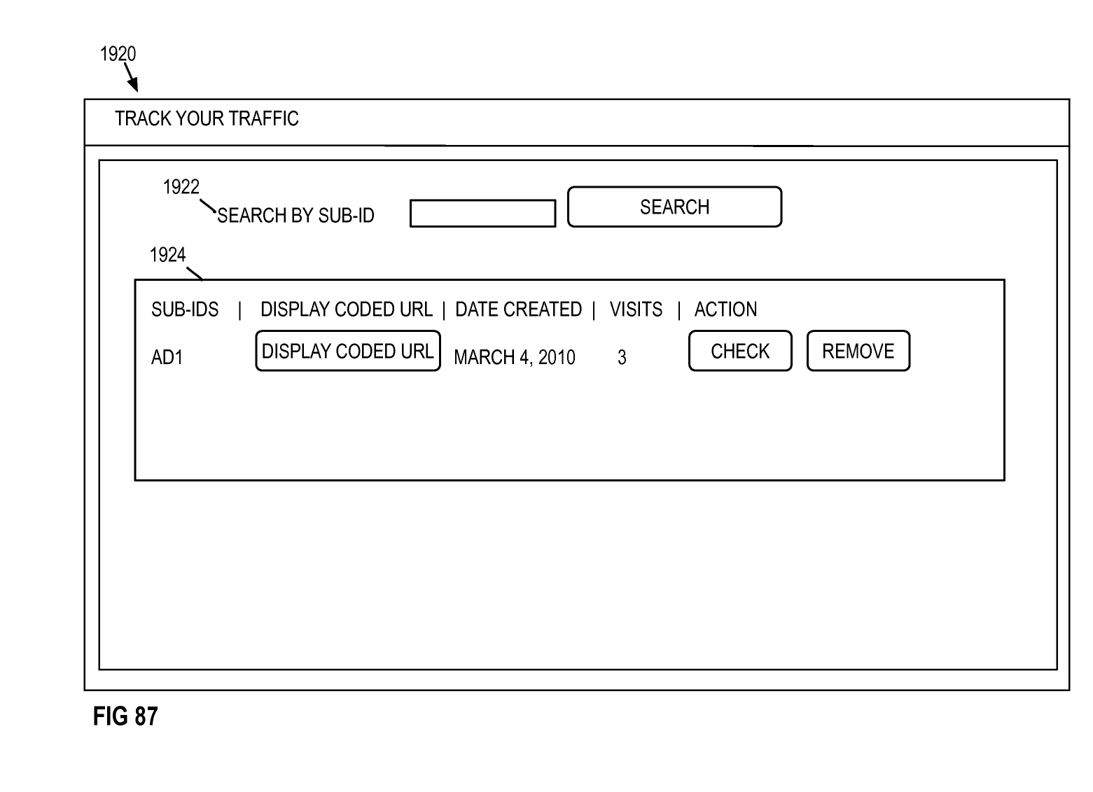

FIG. 87 is a simulated screen 1920 for one implementation that illustrates viewing tracking details regarding traffic that came to the site through one or more sub-ids. To filter the search results, sub-id search criteria 1922 can be specified. The various sub-id's that are being used for the web site are displayed in the sub-id list 1924. This list allows the user to view the coded URL that is unique for that sub-id, as well as to check the status and/or remove a selected sub-id.

FIG. 88 is a simulated screen 1930 for one implementation that illustrates viewing heat map data 1932 to show how visitors interacted with pages on a web site. Upon selecting a particular web page from the list and choosing the check option 1934, a heat map is displayed, such as one similar to FIG. 89.

FIG. 89 is a simulated screen 1950 for one implementation that illustrates a heat map 1956 showing the areas visitors clicked 1958 on a certain page for the specified time frame 1952. Upon changing the specified time frame 1952 and then selecting update heat map 1954, the heat map 1956 is refreshed to display the data for the updated time frame.

As shown in FIG. 90, an exemplary computer system to use for implementing one or more parts of the system includes a computing device, such as computing device 2000. In its most basic configuration, computing device 2000 typically includes at least one processing unit 2002 and memory 2004. Depending on the exact configuration and type of computing device, memory 2004 may be volatile (such as RAM), non-volatile (such as ROM, flash memory, etc.) or some combination of the two. This most basic configuration is illustrated in FIG. 90 by dashed line 2006.

Additionally, device 2000 may also have additional features/functionality. For example, device 2000 may also include additional storage (removable and/or non-removable) including, but not limited to, magnetic or optical disks or tape. Such additional storage is illustrated in FIG. 90 by removable storage 2008 and non-removable storage 2010. Computer storage media includes volatile and nonvolatile, removable and non-removable media implemented in any method or technology for storage of information such as computer readable instructions, data structures, program modules or other data. Memory 2004, removable storage 2008 and non-removable storage 2010 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 2000. Any such computer storage media may be part of device 2000.

Computing device 2000 includes one or more communication connections 2014 that allow computing device 2000 to communicate with other computers/applications 2015. Device 2000 may also have input device(s) 2012 such as keyboard, mouse, pen, voice input device, touch input device, etc. Output device(s) 2011 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A content management system comprising:
an administration module that is accessible by at least one user through a web browser to specify web site content and settings to be used in generating a web site for the user, the web site content and settings being stored in a data store separately from a published version of the web site so the web site can be regenerated and republished with additional changes at a later time, the administration module further comprising:
a skins module that is operable to allow a look and feel to be selected for the web site;
a languages module that is operable to allow at least one language to be selected for the web site;
a contents module that is operable to allow articles to be specified that will appear on the web site;
a business pages module that is operable to allow content to be entered for standard business pages appearing on the web site that are common across multiple web sites; and
a newsletter module that is operable to allow settings to be modified for an opt-in box that can be displayed on the web site; and
a page generator module that is operable to generate web pages for the web site, the web pages being generated and published to the web site whenever changes that impact the web site are made to the web site content and settings through the administration module.

2. The content management system of claim 1, further comprising:
a third party submission module that is operable to generate and publish a current sitemap to the web site any time changes are made to the web site that affect a structure of the web site.

3. The content management system of claim 2, wherein the third party submission module is further operable to submit the current sitemap to at least one search engine to facilitate faster indexing of the web site from the at least one search engine.

4. The content management system of claim 2, wherein the current sitemap is produced as an XML sitemap.

5. The content management system of claim 1, further comprising:
a third party submission module that is operable to generate an RSS feed for the web site, and is further operable to submit the RSS feed to at least one RSS feed aggregator site.

6. The content management system of claim 1, wherein the administration module further comprises an ecommerce module that is operable to manage products that can be sold on the web site.

7. The content management system of claim 1, wherein the administration module further comprises a web presence module that is operable to submit a local business listing for the web site to at least one search engine.

8. The content management system of claim 1, wherein the administration module further comprises a web presence module that is operable to submit a maps listing to at least one search engine.

9. The content management system of claim 1, further comprising:
a video overlay module that is operable to generate a video that is displayed on top of the web site on a specified page of the web site.

10. A computer-readable medium having computer-executable instructions for causing a computer to perform steps comprising:
enable a look and feel to be selected for a web site;
enable at least one language to be selected for the web site;
enable articles to be specified that will appear on the web site;
enable content to be entered for standard business pages appearing on the web site that are common across multiple web sites;
enable settings to be modified for an opt-in box that can be displayed on the web site;
enable products to be managed that can be sold on the web site;
enable site information that is submitted to third party web sites to be managed; and
enable web pages to be generated for the web site in both a regular version and a mobile version, the web pages being generated and published to the web site whenever changes that impact the web site are made.

11. The computer-readable medium of claim 10, wherein when a plurality of languages are specified, additional options appear to allow content and settings to be specified for each of the plurality of languages.

12. The computer-readable medium of claim 10, further having computer-executable instructions for causing a computer to perform steps comprising:
enable live chat settings to be specified for the web site.

13. The computer-readable medium of claim 10, further having computer-executable instructions for causing a computer to perform steps comprising:
enable heat map data to be accessed and displayed over a corresponding page on the web site to indicate what regions on the web site are being clicked by visitors.

14. The computer-readable medium of claim 10, further having computer-executable instructions for causing a computer to perform steps comprising:
enable a video to be generated for later display on top of a specified page of the web site being accessed by a visitor.

15. The computer-readable medium of claim 10, further having computer-executable instructions for causing a computer to perform steps comprising
enable coupons to be generated for the products being sold on the web site.

16. The computer-readable medium of claim 10, wherein when the web site is accessed by a mobile device, the mobile version of the web site is automatically sent to the mobile device.

17. The computer-readable medium of claim 10, wherein emails can be sent to visitors who subscribed to the newsletter.

18. The computer-readable medium of claim 10, further having computer-executable instructions for causing a computer to perform steps comprising:
enable emails to be sent to and received from at least one email address created on the domain on which the web site is hosted.

19. The computer-readable medium of claim 10, further having computer-executable instructions for causing a computer to perform steps comprising:
enable surveys and polls to be added to the web site.

20. A content management system comprising:
a skins module that is operable to allow a look and feel to be selected for a web site;
a languages module that is operable to allow at least one language to be selected for the web site;
a contents module that is operable to allow articles to be specified that will appear on the web site;
a business pages module that is operable to allow content to be entered for standard business pages appearing on the web site that are common across multiple web sites;
a newsletter module that is operable to allow settings to be modified for an opt-in box that can be displayed on the web site;
an ecommerce module that is operable to manage products that can be sold on the web site;
a web presence module that is operable to manage site information about the web site that is submitted to third party web sites;
an email module that is operable to allow emails to be sent to and received from at least one email address created on the domain on which the web site is hosted;
a heat map module that is operable to graphically display heat map data over a corresponding page on the web site to indicate what regions on the web site are being clicked by visitors;
a live chat module that is operable to manage live chat settings for the web site; and
a page generator module that is operable to generate web pages for the web site in both a regular version and a mobile version, the web pages being generated and published to the web site automatically whenever changes that impact the web site are made.
